(19) United States
(12) Patent Application Publication
(10) Pub. No.: US 2026/0230383 A1
(43) Pub. Date: Aug. 6, 2026

(54) SYSTEMS, METHODS, AND APPARATUSES FOR INTELLIGENT NETWORK AUTOMATION

(71) Applicant: NetBrain Technologies Inc., Burlington, MA (US)

(72) Inventors: Lingping Gao, Lexington, MA (US); Peng Zhao, Westford, MA (US); Yawei Wang, Markham (CA); Chaoxiang Cheng, Acton, MA (US); Guangdong Liao, Concord, MA (US)

(21) Appl. No.: 19/635,023

(22) Filed: Mar. 31, 2026

Related U.S. Application Data
(63) Continuation-in-part of application No. PCT/US2025/055601, filed on Nov. 14, 2025.
(60) Provisional application No. 63/721,088, filed on Nov. 15, 2024.
(60) Provisional application No. 63/780,969, filed on Mar. 31, 2025.

(51) Int. Cl. H04L 41/0866; H04L 41/12

(52) U.S. Cl. CPC H04L 41/0866; H04L 41/12

(57) ABSTRACT

Embodiments of the current disclosure provide for a method for managing a network. The method includes: defining an assessment feature; identifying, based at least in part on the assessment feature, a reference cluster comprising a plurality of member devices; selecting a representative device from the plurality of member devices; and determining a golden configuration based at least in part on the representative device. The method further includes comparing a target configuration, of at least one member device of the plurality other than the representative device, to the golden configuration; determining a drift value representative of an amount of change between the target configuration and the golden configuration; and transmitting the drift value.

### CROSS-REFERENCES TO RELATED APPLICATIONS

This application claims priority to and the benefit of U.S. provisional patent application No. 67/780,969 (Attorney Docket No. NETB-0002-P01), filed on Mar. 31, 2025, and entitled “SYSTEMS, METHODS, AND APPARATUSES FOR INTELLIGENT NETWORK AUTOMATION”.

This application also claims priority to and is a continuation-in-part of International Patent Application No. PCT/US2025/055601 (Attorney Docket No. NETB-0001-WO), filed on Nov. 14, 2025 and entitled “SYSTEMS, METHODS, AND APPARATUSES FOR INTELLIGENT NETWORK AUTOMATION”.

International Patent Application No. PCT/US25/55601 claims priority to and the benefit of U.S. provisional patent application No. 63/721,088 (Attorney Docket No. NETB-0001-P01), filed on Nov. 15, 2024, and entitled “SYSTEMS, METHODS, AND APPARATUSES FOR INTELLIGENT NETWORK AUTOMATION”.

The foregoing patent applications are incorporated herein by reference in their entirety for all purposes.

### BACKGROUND

Modern computer networks have become increasingly complex in both scale and architecture. A typical enterprise or service provider network may include a wide variety of interconnected devices such as routers, switches, firewalls, servers, load balancers, and end-user devices. These devices often originate from different vendors and may operate using distinct communication protocols, management interfaces, and configuration standards. As a result, the overall network environment is highly heterogeneous and dynamic.

In practice, documentation regarding the architecture and configuration of such networks is frequently incomplete, outdated, or entirely absent. The documentation problem is exacerbated by turnover among network engineering staff, where the departure of experienced personnel often results in the loss of critical institutional knowledge. Without accurate and up-to-date documentation, understanding the topology, dependencies, and operational characteristics of a given network becomes difficult.

The lack of reliable network architecture documentation presents significant challenges when troubleshooting network issues. Outages, degraded performance, dropped connections, and non-functional services can arise from a wide range of causes, including misconfigurations, hardware failures, or protocol incompatibilities. In the absence of clear architectural visibility, diagnosing and resolving such issues often requires substantial time and effort, leading to prolonged service disruptions and increased operational costs.

Moreover, the expertise required to efficiently troubleshoot complex networks is typically acquired through years of hands-on experience. Senior network engineers often develop an intuitive understanding of network behavior and failure modes that is difficult to capture in written form. Transferring this knowledge to junior engineers is a time-consuming process, and the lack of systematic tools or documentation further hinders the development of troubleshooting proficiency among less experienced personnel.

### SUMMARY

Disclosed herein are systems, apparatuses, and methods thereof for intelligent network automation. Embodiments of the current disclosure provide for the discovery, identification, and/or generation of golden configurations, golden parameters, golden intents, and/or golden features, which further provide for the identification of network configurations and mitigation of network drift, e.g., the tendency for network device configuration to alter/change over time away from a desired standard, e.g., a golden configuration. Aspects of the current disclosure provide for the discovery of a network's current golden configuration through use of intelligent artificial models, command discovery processes, and credential databases, which, in turn, eases and/or simplifies the workload on network engineers and/or maintainers. Embodiments of the current disclosure are useful for managing networks with a high maintainer churn rate and/or networks having poor documentation, e.g., a lack of network maps, device property settings, and/or the like.

For example, embodiments of the current disclosure provide for a method for managing a network. The method includes: defining an assessment feature; identifying, based at least in part on the assessment feature, a reference cluster that includes a plurality of member devices; selecting a representative device from the plurality of member devices; and determining a golden configuration based at least in part on the representative device. The method further includes comparing a target configuration, of at least one member device of the plurality other than the representative device, to the golden configuration; determining a drift value representative of an amount of change between the target configuration and the golden configuration; and transmitting the drift value.

Additional embodiments of the current disclosure provide for an apparatus for managing a network. The apparatus includes: an assessment feature management circuit, a clustering circuit, a representative device circuit, a golden engineering circuit, a drift circuit, and a drift provisioning circuit. The assessment feature management circuit is structured to define an assessment feature; the clustering circuit is structured to identify, based at least in part on the assessment feature, a reference cluster that includes a plurality of member devices; and the representative device circuit is structured to select a representative device from the plurality of member devices. The golden engineering circuit is structured to determine a golden configuration based at least in part on the representative device; and the drift circuit structured to: compare a target configuration, of at least one member device of the plurality other than the representative device, to the golden configuration; and determine a drift value representative of an amount of change between the target configuration and the golden configuration. The drift provisioning circuit is structured to transmit the drift value.

Further embodiments of the current disclosure provide for a non-transitory computer-readable medium storing instructions that, when loaded into at least one processor, causes the at least one processor to: define an assessment feature; identify, based at least in part on the assessment feature, a reference cluster that includes a plurality of member devices; select a representative device from the plurality of member devices; and determine a golden configuration based at least in part on the representative device. The stored computer-readable instructions further cause the at least one processor to: compare a target configuration, of at least one member device of the plurality other than the representative device, to the golden configuration; determine a drift value representative of an amount of change between the target configuration and the golden configuration; and transmit the drift value.

Still yet further embodiments of the current disclosure provide for a method for managing a network. The method includes: receiving, via a natural-language interface, a query regarding a network issue associated with the network; identifying, via a neural-network-based model and based at least in part on the query, current network data and one or more automation results to be used in addressing the network issue, wherein the neural-network-based model is trained on golden intent data corresponding to a test network; and obtaining the current network data and the one or more automation results. The method further includes: determining, based at least in part on the current network data and the one or more automation results, whether the network deviates from a network intent for the network; generating, via the neural-network-based model, a remediation plan for the network issue, wherein the remediation plan includes a plurality of processes to address the network issue; and transmitting the remediation plan.

Still yet further embodiments of the current disclosure provide for an apparatus for managing a network. The apparatus includes: a query processing circuit; a resource procurement circuit; a query processing circuit structured to receive, via a natural-language interface, a query regarding a network issue associated with the network; a drift detection circuit; a remediation circuit; and a plan provisioning circuit. The resource procurement circuit is structured to: identify, via a neural-network-based model and based at least in part on the query, current network data and one or more automation results to be used in addressing the network issue. The neural-network-based model is trained on golden intent data corresponding to a test network. The resource procurement circuit is further structured to obtain the current network data and the one or more automation results. The drift detection circuit is structured to determine, based at least in part on the current network data and the one or more automation results, whether the network deviates from a network intent for the network. The remediation circuit is structured to generate, via the neural-network-based model, a remediation plan for the network issue, wherein the remediation plan includes a plurality of processes to address the network issue; and the plan provisioning circuit is structured to transmit the remediation plan.

Still yet further embodiments of the current disclosure provide for a non-transitory computer-readable medium storing instructions that, when loaded into at least one processor, cause the at least one processor to: receive, via a natural-language interface, a query regarding a network issue associated with the network; and identify, via a neural-network-based model and based at least in part on the query, current network data and one or more automation results to be used in addressing the network issue, wherein the neural-network-based model is trained on golden intent data corresponding to a test network. The stored computer-readable instructions further cause the at least one processor to: obtain the current network data and the one or more automation results; determine, based at least in part on the current network data and the one or more automation results, whether the network deviates from a network intent for the network; generate, via the neural-network-based model, a remediation plan for the network issue, wherein the remediation plan includes a plurality of processes to address the network issue; and transmit the remediation plan.

Still yet further embodiments of the current disclosure provide for a method for training a neural-network-based model to assist in managing a network. The method includes: obtaining a training record that includes: a test query regarding a test network issue associated with a test network, reference current network data for the test network, one or more reference automation results; a reference determination of whether the test network deviates from a network intent, and a reference remediation plan for the test network issue. The method further includes: inputting the test query to the neural-network-based model; and predicting, via the neural-network-based model: current network data for the test network, one or more automation results, whether the test network deviates from the network intent, and a remediation plan for the test network issue that includes a plurality of processes to address the test network issue. The method further includes comparing: the current network data for the test network to the reference current network data; the one or more automation results to the one or more reference automation results; the determination of whether the test network deviates from the network intent to the reference determination; and the remediation plan for the test network issue to the reference remediation plan. The method further includes adjusting one or more parameters of the neural-network-based model based at least in part on the comparing.

Yet still further embodiments of the current disclosure provide for an apparatus for training a neural-network-based model to assist in managing a network. The apparatus includes: a memory device storing the neural-network-based model; and a record procurement circuit structured to obtain a training record that includes: a test query regarding a test network issue associated with a test network, reference current network data for the test network, one or more reference automation results, a reference determination of whether the test network deviates from a network intent; and a reference remediation plan for the test network issue. The experiment circuit is structured to: input the test query to the neural-network-based model; and predict, via the neural-network-based model: current network data for the test network; one or more automation results; a determination of whether the test network deviates from the network intent; and a remediation plan for the test network issue that includes a plurality of processes to address the test network issue. The comparison circuit is structured to compare: the current network data for the test network to the reference current network data; the one or more automation results to the one or more reference automation results; the determination of whether the test network deviates from the network intent to the reference determination; and the remediation plan for the test network issue to the reference remediation plan. The adjustment circuit is structured to adjust one or more parameters of the neural-network-based model based at least in part on the comparison.

Still yet further embodiments of the current disclosure provide for a non-transitory computer-readable medium storing instructions that, when loaded into at least one processor, cause the at least one processor to: obtain a training record that includes: a test query regarding a test network issue associated with a test network; reference current network data for the test network; one or more reference automation results; a reference determination of whether the test network deviates from a network intent; and a reference remediation plan for the test network issue. The stored instructions further cause the at least one processor to: input the test query to a neural-network-based model; predict, via the neural-network-based model: current network data for the test network, one or more automation results, a determination of whether the test network deviates from the network intent, and a remediation plan for the test network issue that includes a plurality of processes to address the test network issue. The stored instructions further cause the at least one processor to: compare: the current network data for the test network to the reference current network data; the one or more automation results to the one or more reference automation results; the determination of whether the test network deviates from the network intent to the reference determination; and the remediation plan for the test network issue to the reference remediation plan. The stored instructions further cause the at least one processor to adjust one or more parameters of the neural-network-based model based at least in part on the comparison.

These and other systems, apparatuses, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a schematic diagram of a network environment incorporating a system for intelligent network automation, in accordance with embodiments of the current disclosure;

FIG. 2 depicts an apparatus for intelligent network automation, in accordance with embodiments of the current disclosure;

FIG. 3 depicts a block diagram of an apparatus for intelligent network automation, in accordance with embodiments of the current disclosure;

FIG. 4 depicts a block diagram of a circuit of an apparatus for intelligent network automation, in accordance with embodiments of the current disclosure;

FIG. 5 depicts a block diagram of a circuit of an apparatus for intelligent network automation, in accordance with embodiments of the current disclosure;

FIG. 6 depicts a graphical user interface (GUI) for intelligent network automation, in accordance with embodiments of the current disclosure;

FIG. 7 depicts a block diagram of a circuit of an apparatus for intelligent network automation, in accordance with embodiments of the current disclosure;

FIG. 8 depicts a block diagram of a circuit of an apparatus for intelligent network automation, in accordance with embodiments of the current disclosure;

FIG. 9 depicts a block diagram of a system for intelligent network automation, in accordance with embodiments of the current disclosure;

FIG. 10 depicts a GUI for intelligent network automation, in accordance with embodiments of the current disclosure;

FIG. 11 depicts a GUI for intelligent network automation, in accordance with embodiments of the current disclosure;

FIG. 12 depicts a GUI for intelligent network automation, in accordance with embodiments of the current disclosure;

FIG. 13 depicts a GUI for intelligent network automation, in accordance with embodiments of the current disclosure;

FIG. 14 depicts a GUI for intelligent network automation, in accordance with embodiments of the current disclosure;

FIG. 15 depicts a GUI for intelligent network automation, in accordance with embodiments of the current disclosure;

FIG. 16 depicts a GUI for intelligent network automation, in accordance with embodiments of the current disclosure;

FIG. 17 depicts a GUI for intelligent network automation, in accordance with embodiments of the current disclosure;

FIG. 18 depicts a GUI for intelligent network automation, in accordance with embodiments of the current disclosure;

FIG. 19 depicts a block diagram of a circuit of an apparatus for intelligent network automation, in accordance with embodiments of the current disclosure;

FIG. 20 depicts a block diagram of data structures for intelligent network automation, in accordance with embodiments of the current disclosure;

FIG. 21 depicts a GUI for intelligent network automation, in accordance with embodiments of the current disclosure;

FIG. 22 depicts a GUI for intelligent network automation, in accordance with embodiments of the current disclosure;

FIG. 23 depicts a GUI for intelligent network automation, in accordance with embodiments of the current disclosure;

FIG. 24 depicts a GUI for intelligent network automation, in accordance with embodiments of the current disclosure;

FIG. 25 depicts a GUI for intelligent network automation, in accordance with embodiments of the current disclosure;

FIG. 26 depicts a GUI for intelligent network automation, in accordance with embodiments of the current disclosure;

FIG. 27 depicts a GUI for intelligent network automation, in accordance with embodiments of the current disclosure;

FIG. 28 depicts a GUI for intelligent network automation, in accordance with embodiments of the current disclosure;

FIG. 29 depicts a GUI for intelligent network automation, in accordance with embodiments of the current disclosure;

FIG. 30 depicts a GUI for intelligent network automation, in accordance with embodiments of the current disclosure;

FIG. 31 depicts a GUI for intelligent network automation, in accordance with embodiments of the current disclosure;

FIG. 32 depicts a GUI for intelligent network automation, in accordance with embodiments of the current disclosure;

FIG. 33 depicts a GUI for intelligent network automation, in accordance with embodiments of the current disclosure;

FIG. 34 depicts a GUI for intelligent network automation, in accordance with embodiments of the current disclosure;

FIG. 35 depicts a GUI for intelligent network automation, in accordance with embodiments of the current disclosure;

FIG. 36 depicts a block diagram of a data structure for intelligent network automation, in accordance with embodiments of the current disclosure;

FIG. 37 depicts a GUI for intelligent network automation, in accordance with embodiments of the current disclosure;

FIG. 38 depicts a GUI for intelligent network automation, in accordance with embodiments of the current disclosure;

FIG. 39 depicts a GUI for intelligent network automation, in accordance with embodiments of the current disclosure;

FIG. 40 depicts a GUI for intelligent network automation, in accordance with embodiments of the current disclosure;

FIG. 41 depicts a GUI for intelligent network automation, in accordance with embodiments of the current disclosure;

FIG. 42 depicts a GUI for intelligent network automation, in accordance with embodiments of the current disclosure;

FIG. 43 depicts a GUI for intelligent network automation, in accordance with embodiments of the current disclosure;

FIG. 44 depicts a GUI for intelligent network automation, in accordance with embodiments of the current disclosure;

FIG. 45 depicts a GUI for intelligent network automation, in accordance with embodiments of the current disclosure;

FIG. 46 depicts a GUI for intelligent network automation, in accordance with embodiments of the current disclosure;

FIG. 47 depicts a GUI for intelligent network automation, in accordance with embodiments of the current disclosure;

FIG. 48 depicts a GUI for intelligent network automation, in accordance with embodiments of the current disclosure;

FIG. 49 depicts a GUI for intelligent network automation, in accordance with embodiments of the current disclosure;

FIG. 50 is a GUI for intelligent network automation, in accordance with embodiments of the current disclosure;

FIG. 51 depicts aspects of a workflow for a GUI for intelligent network automation, in accordance with embodiments of the current disclosure;

FIG. 52 depicts aspects of a workflow for a GUI for intelligent network automation, in accordance with embodiments of the current disclosure;

FIG. 53 depicts a GUI for intelligent network automation, in accordance with embodiments of the current disclosure;

FIG. 54 depicts a GUI for intelligent network automation, in accordance with embodiments of the current disclosure;

FIG. 55 depicts a GUI for intelligent network automation, in accordance with embodiments of the current disclosure;

FIG. 56 depicts a GUI for intelligent network automation, in accordance with embodiments of the current disclosure;

FIG. 57 depicts a GUI for intelligent network automation, in accordance with embodiments of the current disclosure;

FIG. 58 depicts a GUI for intelligent network automation, in accordance with embodiments of the current disclosure;

FIG. 59 depicts a GUI for intelligent network automation, in accordance with embodiments of the current disclosure;

FIG. 60 depicts a GUI for intelligent network automation, in accordance with embodiments of the current disclosure;

FIG. 61 depicts a GUI for intelligent network automation, in accordance with embodiments of the current disclosure;

FIG. 62 depicts a process flow for a GUI for intelligent network automation, in accordance with embodiments of the current disclosure;

FIG. 63 depicts aspects of a workflow for a GUI for intelligent network automation, in accordance with embodiments of the current disclosure;

FIG. 64 depicts aspects of a workflow for a GUI for intelligent network automation, in accordance with embodiments of the current disclosure;

FIG. 65 depicts aspects of a workflow for a GUI for intelligent network automation, in accordance with embodiments of the current disclosure;

FIG. 66 depicts aspects of a workflow for a GUI for intelligent network automations, in accordance with embodiments of the current disclosure;

FIG. 67 depicts aspects of a workflow for a GUI for intelligent network automation, in accordance with embodiments of the current disclosure;

FIG. 68 depicts aspects of a workflow for a GUI for intelligent network automation, in accordance with embodiments of the current disclosure;

FIG. 69 depicts aspects of a workflow for a GUI for intelligent network automation, in accordance with embodiments of the current disclosure;

FIG. 70 depicts aspects of a workflow for a GUI for intelligent network automation, in accordance with embodiments of the current disclosure;

FIG. 71 depicts aspects of a workflow for a GUI for intelligent network automation, in accordance with embodiments of the current disclosure;

FIG. 72 depicts aspects of a workflow for a GUI for intelligent network automation, in accordance with embodiments of the current disclosure;

FIG. 73 depicts aspects of a workflow for a GUI for intelligent network automation, in accordance with embodiments of the current disclosure;

FIG. 74 depicts aspects of a workflow for a GUI for intelligent network automation, in accordance with embodiments of the current disclosure;

FIG. 75 depicts aspects of a workflow for a GUI for intelligent network automation, in accordance with embodiments of the current disclosure;

FIG. 76 depicts aspects of a workflow for a GUI for intelligent network automation, in accordance with embodiments of the current disclosure;

FIG. 77 depicts aspects of a workflow for a GUI for intelligent network automation, in accordance with embodiments of the current disclosure;

FIG. 78 depicts aspects of a workflow for a GUI for intelligent network automation, in accordance with embodiments of the current disclosure;

FIG. 79 depicts aspects of a workflow for a GUI for intelligent network automation, in accordance with embodiments of the current disclosure;

FIG. 80 depicts aspects of a workflow for a GUI for intelligent network automation, in accordance with embodiments of the current disclosure;

FIG. 81 depicts aspects of a workflow for a GUI for intelligent network automation, in accordance with embodiments of the current disclosure;

FIG. 82 depicts aspects of a workflow for a GUI for intelligent network automation, in accordance with embodiments of the current disclosure;

FIG. 83 depicts aspects of a workflow for a GUI for intelligent network automation, in accordance with embodiments of the current disclosure;

FIG. 84 depicts aspects of a workflow for a GUI for intelligent network automation, in accordance with embodiments of the current disclosure;

FIG. 85 depicts aspects of a workflow for a GUI for intelligent network automation, in accordance with embodiments of the current disclosure;

FIG. 86 depicts aspects of a workflow for a GUI for intelligent network automation, in accordance with embodiments of the current disclosure;

FIG. 87 depicts aspects of a workflow for a GUI for intelligent network automation, in accordance with embodiments of the current disclosure;

FIG. 88 depicts aspects of a workflow for a GUI for intelligent network automation, in accordance with embodiments of the current disclosure;

FIG. 89 depicts aspects of a workflow for a GUI for intelligent network automation, in accordance with embodiments of the current disclosure;

FIG. 90 depicts aspects of a workflow for a GUI for intelligent network automation, in accordance with embodiments of the current disclosure;

FIG. 91 depicts aspects of a workflow for a GUI for intelligent network automation, in accordance with embodiments of the current disclosure;

FIG. 92 depicts aspects of a workflow for a GUI for intelligent network automation, in accordance with embodiments of the current disclosure;

FIG. 93 depicts aspects of a workflow for a GUI for intelligent network automation, in accordance with embodiments of the current disclosure;

FIG. 94 depicts aspects of a workflow for a GUI for intelligent network automation, in accordance with embodiments of the current disclosure;

FIG. 95 depicts aspects of a workflow for a GUI for intelligent network automation, in accordance with embodiments of the current disclosure;

FIG. 96 depicts aspects of a workflow for a GUI for intelligent network automation, in accordance with embodiments of the current disclosure;

FIG. 97 depicts aspects of a workflow for a GUI for intelligent network automation, in accordance with embodiments of the current disclosure;

FIG. 98 depicts aspects of a workflow for a GUI for intelligent network automation, in accordance with embodiments of the current disclosure;

FIG. 99 depicts aspects of a workflow for a GUI for intelligent network automation, in accordance with embodiments of the current disclosure;

FIG. 100 depicts aspects of a workflow for a GUI for intelligent network automation, in accordance with embodiments of the current disclosure;

FIG. 101 depicts aspects of a workflow for a GUI for intelligent network automation, in accordance with embodiments of the current disclosure;

FIG. 102 depicts aspects of a workflow for a GUI for intelligent network automation, in accordance with embodiments of the current disclosure;

FIG. 103 depicts aspects of a workflow for a GUI for intelligent network automation, in accordance with embodiments of the current disclosure;

FIG. 104 is a flowchart depicting a method for managing a network, in accordance with embodiments of the current disclosure;

FIG. 105 is a flowchart depicting further aspects of the method of FIG. 104, in accordance with embodiments of the current disclosure;

FIG. 106 is a flowchart depicting further aspects of the method of FIG. 104, in accordance with embodiments of the current disclosure;

FIG. 107 is a flowchart depicting further aspects of the method of FIG. 104, in accordance with embodiments of the current disclosure;

FIG. 108 is a flowchart depicting further aspects of the method of FIG. 104, in accordance with embodiments of the current disclosure;

FIG. 109 is a flowchart depicting further aspects of the method of FIG. 104, in accordance with embodiments of the current disclosure;

FIG. 110 is a flowchart depicting further aspects of the method of FIG. 104, in accordance with embodiments of the current disclosure;

FIG. 111 is a schematic diagram of an apparatus for managing a network, in accordance with embodiments of the current disclosure;

FIG. 112 is a schematic diagram depicting further aspects of the apparatus of FIG. 111, in accordance with embodiments of the current disclosure;

FIG. 113 is a schematic diagram depicting further aspects of the apparatus of FIG. 111, in accordance with embodiments of the current disclosure;

FIG. 114 is a schematic diagram of a system for managing a network, in accordance with embodiments of the current disclosure;

FIG. 115 is another schematic diagram of a system for managing a network, in accordance with embodiments of the current disclosure;

FIG. 116 depicts aspects of a workflow for a GUI for intelligent network automation, in accordance with embodiments of the current disclosure;

FIG. 117 depicts aspects of a workflow for a GUI for intelligent network automation, in accordance with embodiments of the current disclosure;

FIG. 118 depicts aspects of a workflow for a GUI for intelligent network automation, in accordance with embodiments of the current disclosure;

FIG. 119 depicts aspects of a workflow for a GUI for intelligent network automation, in accordance with embodiments of the current disclosure;

FIG. 120 depicts aspects of a workflow for a GUI for intelligent network automation, in accordance with embodiments of the current disclosure;

FIG. 121 depicts aspects of a workflow for a GUI for intelligent network automation, in accordance with embodiments of the current disclosure;

FIG. 122 is a flowchart depicting a method for training an artificial intelligence model to assist in managing a network, in accordance with embodiments of the current disclosure;

FIG. 123 is a flowchart depicting further aspects of the method of FIG. 122, in accordance with embodiments of the current disclosure;

FIG. 124 is a flowchart depicting further aspects of the method of FIG. 122, in accordance with embodiments of the current disclosure;

FIG. 125 is a flowchart depicting further aspects of the method of FIG. 122, in accordance with embodiments of the current disclosure;

FIG. 126 is a flowchart depicting further aspects of the method of FIG. 122, in accordance with embodiments of the current disclosure;

FIG. 127 is a flowchart depicting further aspects of the method of FIG. 122, in accordance with embodiments of the current disclosure;

FIG. 128 is a flowchart depicting further aspects of the method of FIG. 122, in accordance with embodiments of the current disclosure; and

FIG. 129 is a schematic diagram of an apparatus for training an artificial intelligence model to assist in managing a network, in accordance with embodiments of the current disclosure.

### DETAILED DESCRIPTION

Many businesses rely on computer networks to function properly. Managing and troubleshooting computer networks are often complex tasks. For example, a typical corporate network will often contain different device types, e.g., switches, firewalls, routers, traffic shapers, virtual private network gateways, and/or the like, made by different vendors and/or running different operating systems. Many networks will often include complex communication links spanning continents and/or across the globe traversing complex physical and/or virtual network topologies.

Accordingly, it is typical for configuring and/or troubleshooting computer networks to involve knowledge of hundreds and/or thousands of different devices, operating systems, shell scripts, and/or applications. It is often the case, however, that documentation (device commands, network maps, troubleshooting solutions/processes, etc.) available to network managers is of limited and/or poorly documented quality. Thus, troubleshooting a network outage on a corporate or other network can be overwhelming for network engineers.

Many network engineers learn troubleshooting through reading a manufacturer's manual or a company's internal documentation. However, the effectiveness of such documentation varies. For instance, the troubleshooting knowledge captured in a document is usually only helpful if the information is accurate and the user correctly identifies the problem. As such, many companies conduct extensive training for network engineers which is time-consuming and/or expensive.

Moreover, the conventional way of network troubleshooting requires a network professional to manually run a set of standard commands and processes for each device that may potentially be involved with the network issue. However, it often takes years of practice to become familiar with those commands, along with each of their parameters. Additionally, complicated troubleshooting methodologies are often hard to share and transfer. Therefore, even though a similar network problem may happen repeatedly, each troubleshooting instance may still start from scratch. Moreover, networks are continuing to grow in complexity and, as such, it is increasingly difficult to manage computer networks efficiently with traditional methods and tools. This increasing complexity often results in increased network outages and/or difficulty in troubleshooting a given network outage. Network outages, however, can be costly to a company in terms of employee downtime, sales downtime, and/or the company's reputation.

Disclosed herein are systems, methods, and apparatuses for automating network management and troubleshooting. For example, some embodiments of the current disclosure provide for a user with limited knowledge of devices and/or command line interfaces to generate a series of commands structured to identify a common configuration, also referred to and described herein in further detail, as a golden configuration, for one or more network devices in instances where the common configuration is unknown.

For example, embodiments of the current disclosure provide for an improved human-machine interface for querying the configuration state and/or the network state (e.g., the running memory state of devices at all layers of the Open Systems Interconnection (OSI) model and/or the TCP/IP stack equivalent layers).

Embodiments of the current disclosure also provide for a system for network management. The system includes an interface configured to receive natural language input; an orchestration agent; a context management system; and an execution engine. The orchestration agent may be implemented using a large language model and be configured to: receive the natural language input and session context, identify requested network management operations, and generate text representations of API calls to perform the operations. The context management system may be configured to provide at least one of: information about available network management commands, current session state including network maps and devices, or a command line interface dictionary including vendor-specific commands and descriptions. The execution engine may be configured to validate and execute the API calls and return results to the interface.

In certain aspects, the context management system maintains a vector database storing command templates and calculates similarity between natural language input and stored command descriptions to identify appropriate commands. In certain aspects, the orchestration agent is configured to process stored action plans including predefined sequences of network operations described in natural language. In certain aspects, the command line interface dictionary includes: vendor-specific commands for different device types, natural language descriptions of the commands' purposes, and sample command outputs for parsing results. In certain aspects, the orchestration agent is configured to maintain conversation context within a session while enforcing token limits. In certain aspects, the system is configured to schedule repeated execution of identified network management operations and display results in automatically updating dashboards. In certain aspects, the orchestration agent generates sequences of API calls for multi-step operations while maintaining dependencies between operations.

Additional embodiments of the current disclosure also provide for a method for network management. The method includes: receiving natural language input through an interface; and providing the natural language input and session context to an orchestration agent implemented using a large language model. The context includes at least one of: information about available network management commands, current session state, or a command line interface dictionary including vendor-specific commands and descriptions. The method further includes identifying, by the orchestration agent, requested network management operations; generating, by the orchestration agent, text representations of API calls to perform the operations; validating and executing the API calls; and returning results to the interface.

Yet further embodiments of the current disclosure provide for a system for network management. The system includes at least one processor and a memory device. The memory device stores computer-readable instructions (e.g., an application) that, when loaded into the at least one processor, causes the at least one processor to: interpret a first user command; in response to the first user command, display a portion of a configuration file of a network computing device; interpret a second user command; in response to the second user command, select a configuration setting within the portion of the configuration file; interpret a third user command; in response to the third user command, identify one or more groups of network computing devices based at least in part on the selected configuration setting; interpret a fourth user command; in response to the fourth user command, select a common configuration setting of one of the one or more groups of network computing devices as a golden configuration; and at least one of transmit the golden configuration or store the golden configuration in a database.

Yet further embodiments of the current disclosure provide for a method for managing a network. The method includes: defining an assessment feature; identifying, based at least in part on the assessment feature, one or more reference clusters each including at least one corresponding member device; and selecting, for each of the one or more reference clusters, a reference device from the at least one corresponding member device.

In certain aspects, the method includes comparing the at least one corresponding member device to the corresponding reference device; and based at least in part on the comparison, determining a drift value representative of an amount of change between a configuration of the at least one corresponding device from the corresponding reference device. In certain aspects, the method further includes: comparing the at least one corresponding member device to a golden configuration; and based at least in part on the comparison, determining a drift value representative of an amount of change between a configuration of the at least one corresponding device from the golden configuration.

Yet still further embodiments of the current disclosure provide for a method for managing a network. The method includes: training a neural-network-based model on golden intent data; receiving a query regarding an issue regarding a network corresponding to the golden intent data generating, in response to the query and based at least in part on the neural-network-based model, a response to the query; and transmitting the query.

In certain aspects, the response to the query includes a plurality of steps to be executed on the network.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

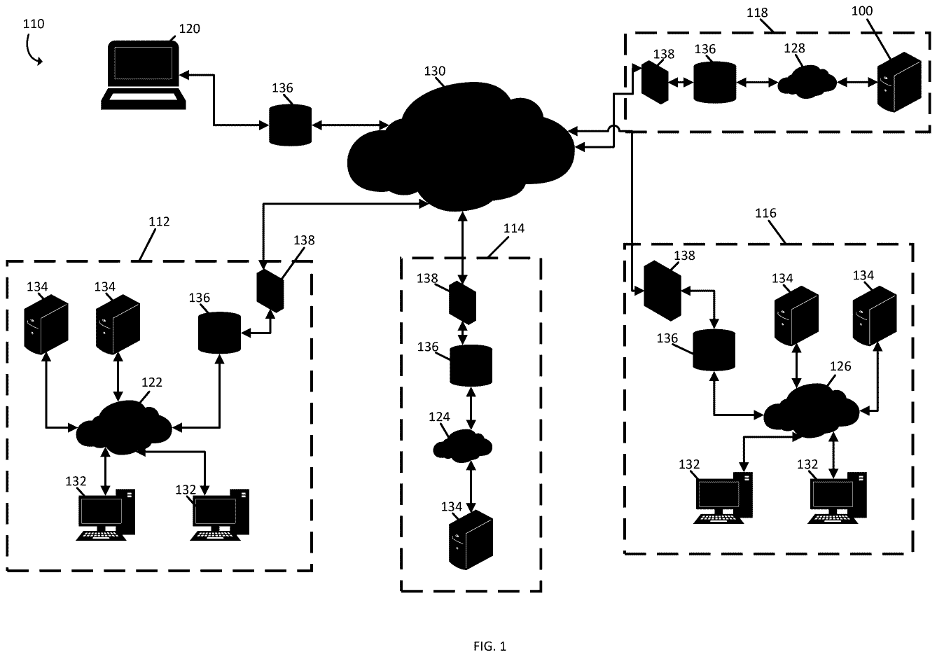

Accordingly, referring to FIG. 1, a system 100 for intelligent network automation is shown in the context of a computer network environment 110. The computer network environment 110 may include one or more network sites 112, 114, 116, 118, remote devices 120, and/or any other sub-computer network environments having one or more networkable computing devices (also referred to herein as “computing devices”, “network devices”, “computing network devices”, “devices”, and/or the like) that can electronically communicate with each other via a computer network (also referred to herein as simply a “network”). A computer network may include one or more local area networks (LANS) 122, 124, 126, and 128, connected via one or more wide area networks (WANS) 130, e.g., the Internet. Nonlimiting examples of computing devices include workstations 132, servers 134, routers 136, and/or firewalls 138. Further nonlimiting examples of network devices may include switches, wireless access points, network bridges, gateways, load balancers, network hubs, network controllers, virtualized network appliances, edge devices, network-attached storage (NAS) units, IoT devices, and network monitoring tools. These devices may operate individually or in combination to facilitate data transmission, routing, security enforcement, traffic optimization, and connectivity within the computer network environment 110.

In embodiments, the network sites 112, 114, 116, and/or 118 may correspond to distinct physical and/or logical locations within and/or across organizations. Nonlimiting examples include multiple offices of a single business, regional branches, government departments, educational institutions, and/or data centers. In some aspects, the network sites 112, 114, 116, and/or 118 may represent networks owned by separate entities but managed by a common contractor and/or service provider, and/or collaborative environments where independent organizations share infrastructure under a unified management framework. Additionally, the network sites 112, 114, 116, and/or 118 may include cloud-hosted environments, virtual private networks (VPNs), hybrid networks combining on-premises and cloud resources, and temporary or project-based networks established for specific initiatives.

Non-limiting industry-specific examples of network sites may include healthcare networks connecting hospitals and clinics, financial institution networks linking banking branches and trading platforms, manufacturing plant networks integrating operational technology (OT) and IT systems, retail networks spanning point-of-sale systems and inventory management, and energy sector networks managing distributed power generation and smart grids. Each network site 112, 114, 116, and/or 118 may operate autonomously while maintaining secure connectivity and interoperability with other sites through the computer network environment 110.

As shown in FIG. 1, in embodiments, the system 100 for intelligent network automation may be formed from one or more computing devices which may be physical and/or virtualized. Embodiments of the system 100 may be disposed in a single network site, e.g., 118, and/or distributed across multiple network sites.

In embodiments, the system 100 may provide a wide range of network management functions to one or more network sites 112, 114, 116, and/or 118. Nonlimiting examples of such functions may include generating and/or maintaining accurate network topology maps, computing device configuration settings, setting and/or verifying permissions and/or network credentials, and/or automating device provisioning and/or deprovisioning. Additional functions may include monitoring and/or analyzing network traffic, detecting and/or mitigating security threats, applying and/or updating firmware and/or software patches, managing and/or optimizing bandwidth allocation, enforcing and/or auditing compliance policies, and/or orchestrating failover and/or disaster recovery procedures.

In some aspects, the system 100 may also perform centralized logging and/or event correlation, alerting and/or reporting on performance metrics, automating backup and/or restore operations, and/or integrating with third-party management platforms and/or cloud services. These functions may be executed dynamically and/or adaptively to maintain optimal network performance, security, and reliability across the computer network environment 110.

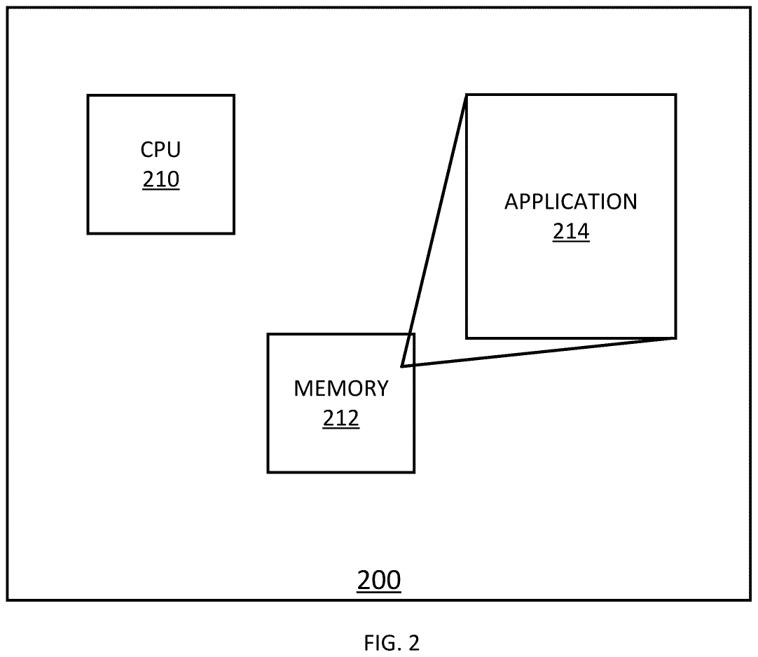

FIG. 2 depicts a non-limiting embodiment of a computing device 200 of the network environment 110 (FIG. 1) and/or the system 100 for intelligent network automation, disclosed herein. The apparatus 200 may include at least one processor 210, and at least one memory device 212 that stores computer-readable instructions 214, e.g., an application, script file, and/or the like, that, when loaded into the at least one processor 210, causes the at least one processor 210 to perform one of more of the methods and/or processes disclosed herein. Embodiments of the apparatus 200 may form part of a single computing device and/or be distributed across multiple computing devices which, in turn, may be disposed at a single site 112, 114, 116, 118, and/or 120, and/or disposed across multiple sites 112, 114, 116, 118, and/or 120. Embodiments of the apparatus 200 may also be virtualized.

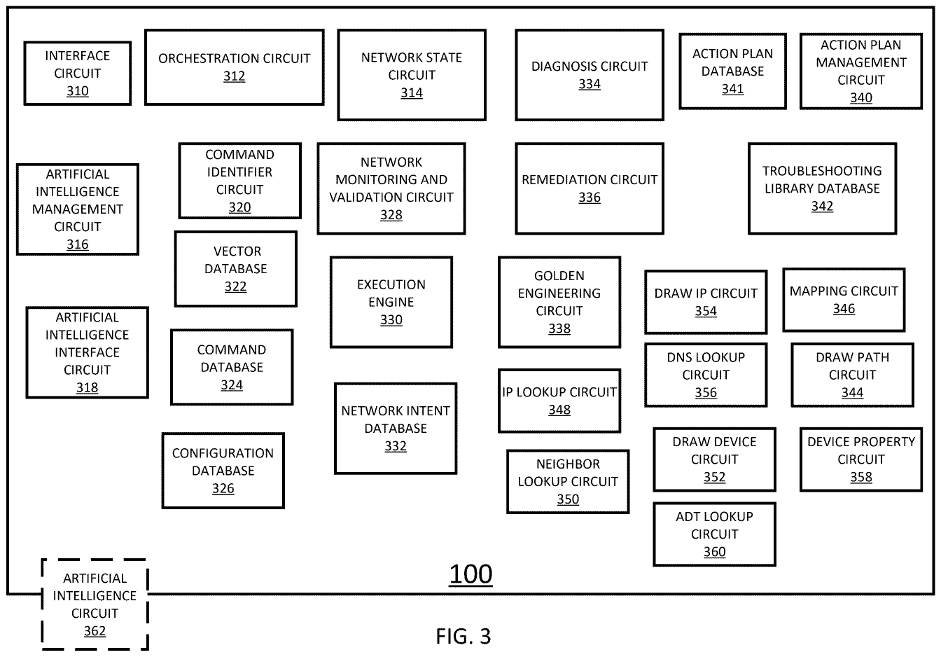

FIG. 3 depicts a schematic diagram of the system 100 for intelligent network automation, in accordance with embodiments of the current disclosure. As explained in greater detail herein, embodiments of the system 100 may provide for a management application executing on a management computing device inside of a computer network. The management application may have administrative rights to one or more known network computing devices on the computer network, such as a gateway device. The management application may make remote calls, e.g., via secure shell SSH, to the gateway device to retrieve a routing table, e.g., a container database (CDB) table. The management application may parse the routing table to discover one or more additional network computing devices within the computer network. The management application may then make further remote calls to the one or more additional computing network devices to retrieve more routing tables which it may parse to discover yet further network computing devices within the network, where the foregoing process is repeated until no new network computing devices are discovered.

Accordingly, as shown in FIG. 3, embodiments of the apparatus 100 may include: an interface circuit 310, an orchestration circuit 312, a network state circuit 314, an artificial intelligence management circuit 316, an artificial intelligence interface circuit 318, a command identifier circuit 320, a vector database 322, a command database 324, a configuration database 326, a network monitoring and validation circuit 328, an execution engine 330, a network intent database 332, a diagnosis circuit 334, a remediation circuit 336, a golden engineering circuit 338, an action plan management circuit 340, an action plan database 341, a troubleshooting library database 342, a draw path circuit 344, and/or a mapping circuit 346, an IP lookup circuit 348, a neighbor lookup circuit 350, a draw device circuit 352, a draw IP circuit 354, a DNS lookup circuit 356, a device property circuit 358, an automation data table (ADT) lookup circuit 360, and/or other types of specialized circuits structured to perform the processes and/or method disclosed herein.

The IP lookup circuit 348 is structured to obtain the IP address of one or more computing devices based at least in part on one or more computing device properties. Non-limiting examples of computing device properties include: name (domain and/or device), role (e.g., firewall, switch, router, mail server, NTP server, etc.), manufacturer, location, and/or any other type of property that can be used to identify a computing device and/or group of computing devices. In one non-limiting example, the system 100 may include a One-IP Table, e.g., a data structure that serves as a single source of truth for all IP-related information across a network. In such an example, the IP lookup circuit 348 may be structured to return L3 and L2 gateway devices when provided an IP listed as an end system on the One-IP Table but does not have a configured device interface (e.g., a network interface). Further nonlimiting examples of a One-IP Table include a data structure that is dynamically generated and/or continuously updated within a network management system, configured to consolidate and/or correlate information pertaining to individual IP addresses across a multi-layered network topology. Embodiments of the One-IP Table may provide a unified repository that maps each IP address (of a network) to its associated network attributes, including but not limited to: MAC address, switch port, VLAN identifier, device interface, DNS name, vendor information, data source origin, and/or the like. The One-IP Table may be constructed through automated network discovery processes and/or parsing of device configuration and/or operational data, enabling real-time (or near real-time) resolution of IP-to-device relationships across physical, virtual, and/or cloud-based infrastructures.

The neighbor lookup circuit 350 is structured to identify one or more computing devices that are within a certain number of network hops (e.g., 1, 2, 3, 4, etc.) from a provided computing device. In a nonlimiting example, the neighbor lookup circuit 350 may retrieve a list of neighboring computing devices for a given device, including connected interfaces and neighbor types. Embodiments of the network lookup circuit may be used in conjunction with and/or incorporated into one or more of the other various circuits herein, e.g., the draw IP circuit 354, draw path circuit 344, and/or other circuits that perform functions based at least in part on computing devices related by network and/or physical location.

The draw device circuit 352 is structured to depict a computing device along with its various properties, e.g., interfaces, neighbors, and/or the like. For example, one or more of the mapping and/or topology features disclosed herein may utilize aspects of the draw device circuit 352 to show computing devices on a graphical user interface.

The draw IP circuit 354 is structured to identify and visually represent devices that are associated with a specific network address (e.g., an IP address) on one or more graphical user interfaces. These interfaces may include various types of network maps or topological diagrams as disclosed herein. The circuit operates by retrieving device information rendering corresponding graphical elements (e.g., nodes, icons, or labels) on the selected map or topology, thereby enabling users to visualize the spatial or logical arrangement of networked devices.

The DNS lookup circuit 356 is structured to translate hostname to IP address (and/or vice-versa) using DNS services (e.g., local and/or external).

The device property circuit 358 is structured to access and retrieve a computing device's properties from a database (e.g., the configuration database 326). In embodiments, the device property circuit may get the properties for one or more devices (and/or visible interfaces) depicted on a map shown in a graphical user interface (e.g., embodiments of the device property circuit 358 may provide for a user to retrieve a device's information by clicking on a representation of the device on a network map).

The ADT lookup circuit 360 is structured to translate data across/between fields inside an ADT. In embodiments, the ADT lookup circuit 360 extracts data from an ADT table to answer a user's queries.

The draw path circuit 344 is structured to draw a map/topology of a network path between two computing devices on a graphical user interface. In embodiments, the draw path circuit 344 may show every node/hop along the path and/or may only show certain types of nodes/hops based on defined criteria (e.g., show only firewalls, show only routes, show all L2 and L3 switches inside external gateways, etc.). In some instances, the draw path circuit 344 may abstract or combine nodes into one simplified graphical representation.

The mapping circuit 346 is structured to facilitate mapping of a specified portion of a network (which can include the full network). For example, in a nonlimiting embodiment, the mapping circuit 346 may take in a list of computing devices and associated network routes and/or path information and draw a graphical representation (e.g., a topology map) of the computing devices and their connection paths. Embodiments of the mapping circuit 346 may use aspects of the draw path circuit 344.

Embodiments of the disclosure may also interact with an artificial intelligence model which may be provided via an artificial intelligence circuit 362. The artificial intelligence circuit 362 is depicted in FIG. 3 in dashed lines to represent that the artificial intelligence circuit 362 may be disposed apart from or incorporated into the system 100. A nonlimiting example of the artificial intelligence circuit 362 being disposed apart from the system 100 may be a scenario where the artificial intelligence model is owned and/or operated by an entity other than an entity that owns and/or operates the system 100. A nonlimiting example of the artificial intelligence circuit 362 being incorporated into the system 100 may be a scenario where the artificial intelligence model and system 100 are owned and/or operated by a same entity.

In embodiments, the artificial intelligence circuit 362 includes a neural network (e.g., a large language model (LLM)). In embodiments, the artificial intelligence circuit 362 may include any suitable model and may include multimodal models capable of processing and integrating heterogeneous data types such as natural language, structured metadata, graphical representations, and topological layouts. These models may be trained to correlate textual inputs (e.g., device identifiers, configuration data, or diagnostic logs) with visual or spatial representations of network environments, enabling more context-aware reasoning, visualization, and interaction. The interface circuit 310 is structured to provide for machine-to-human and human-to-machine communications. For example, the interface circuit 310 may be leveraged by one or more of the other circuits disclosed herein to: display (and/or provide data to be displayed on) a graphical user interface, play (and/or provide data to play) one or more sounds on an auditory device (e.g., a speaker), and/or to capture/record/convert sounds into machine-readable form (e.g., a sound capture from a microphone). In embodiments, the interface circuit 310 may provide for the user to configure one or more settings of the system 100, to include settings for the various circuits disclosed herein. It is to be understood, however, that embodiments of the circuits disclosed herein may not need configuration prior to use.

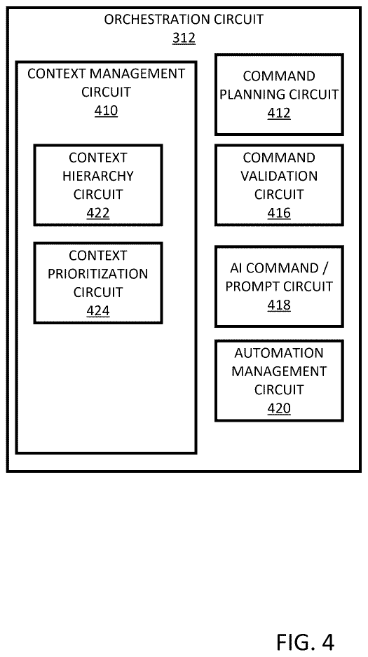

Referring to FIG. 4, the orchestration circuit 312 is structured to coordinate the actions and/or processes performed by one or more of the other circuits disclosed herein to achieve an objective, e.g., determining a golden configuration when the state and/or topology of a scoped network (which may include LAN and/or WAN components/sectors) is unknown. For example, the orchestration circuit 312 may interact with the artificial intelligence circuit 362 (e.g., via the artificial intelligence management circuit 316) to discover network devices and/or topologies and generate corresponding golden configurations. In embodiments, the orchestration circuit 312 may include a context management circuit 410, a command planning circuit 412, a command validation circuit 416, an artificial intelligence command/prompt circuit 418, and/or an automation management circuit 420.

In embodiments, the orchestration circuit 312 may delegate tasks (e.g., user queries, requests, and/or other instructions) to one or more of the other various circuits disclosed herein. For example, the orchestration circuit 312 may delegate mapping functions to the draw device circuit 352, draw IP circuit 354, and/or the like. The orchestration circuit 312 may also request additional information from users when user input is insufficient.

The orchestration circuit 312 may orchestrate/coordinate automations (as disclosed herein) by leveraging various tools and/or circuits to answer a user's questions. As will be appreciated, the orchestration circuit 312 may provide one or more of the following functions: answer a user question based on a pre-defined flow based on an action plan (as disclosed herein); perform reasoning/analysis on results returned from one or more of the various circuits disclosed herein, to include the artificial intelligence circuit 362, and determining a next step for a particular problem, e.g., network troubleshooting; integration of results from different circuits, which may be formatted and returned to a user in Markdown format for a conversational user interface (e.g., a chat dialogue box and/or a voice communication interface); and/or tracking and/or analysis of user inputs, which may be across multiple users and/or instances of an embodiment of the system 100 (e.g., collective analysis).

The context management circuit 410 may include a context hierarchy circuit 422 and/or a context prioritization circuit 424. Embodiments of the context management circuit 410 may maintain several distinct categories of context data/information. A command context provides the artificial intelligence circuit 362 with information about available network operations, including CLI commands, their purposes, and their expected outputs. This context may include detailed command descriptions in natural language format that enable the artificial intelligence circuit 362 to match user requests with appropriate operations. For example, a command context entry might specify that “show interface errors” is used to “display error statistics for network interfaces including input errors, output errors, and other error conditions,” along with sample command output demonstrating the expected format and key data fields.

Context data may include data structured to track the current state of network devices relevant to the user's session. This includes information about device types, their capabilities, and their current configuration state. The device context enables the artificial intelligence circuit 362 to understand which commands are applicable to specific devices and how commands should be modified based on device vendor or type. For example, when a user references a device, the orchestration circuit 312 may provide the artificial intelligence circuit 362 with context about that device's vendor, model, and supported command set.

Context data may include session context concerning the current state of the user's interaction, including any active network maps, recently executed commands, and relevant results. This enables the artificial intelligence circuit 362 to understand references to previous operations and maintain continuity across multiple related requests. For example, if a user requests information about “this interface” after examining interface statistics, the session context enables the artificial intelligence circuit 362 to understand which specific interface is being referenced.

In embodiments, the context hierarchy circuit 422 and/or context prioritization circuit 424 may implement context prioritization mechanisms (e.g., to manage the total amount of context provided to the language model while staying within token limits).

The context hierarchy circuit 422 may also maintain a context hierarchy that enables efficient context updates and modifications. For example, when new commands and/or capabilities are added to the system 100, they can be integrated into the appropriate context categories without requiring changes to other parts of the system 100.

The automation management circuit 420 may be structured to execute pre-defined automation tasks, optionally with unique descriptions. A user may run an automation task on demand and/or schedule the task by specifying one or more preference in an input to the system 100. In embodiments, the automation management circuit 420 may use task results as a data source for generating a review dashboard on a graphical user interface.

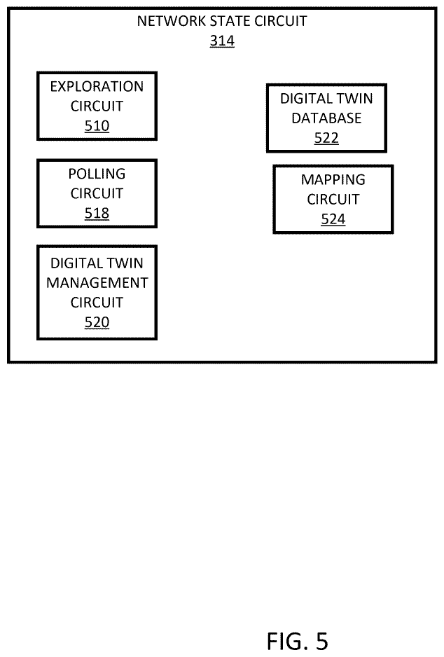

Referring to FIG. 5, the network state circuit 314 is structured to obtain the current state of a network and/or its corresponding computing devices. For example, the network state circuit 314 may include an exploration circuit 510, a polling circuit 518, a digital twin management circuit 520 that accesses a digital twin database 522, and/or a mapping circuit 524.

The digital twin management circuit 520 may access digital twins of the computing devices of a network stored in the digital twin database 522. In embodiments, the digital twin management circuit 520 may pull configuration files from the one or more network computing devices and generate digital twins, which may be stored in the database 522 for future reference. Digital twins may include the configuration settings for a network computing device and/or data capturing the local topology of the network computing device, e.g., which of its interfaces are connected to which other network computing devices.

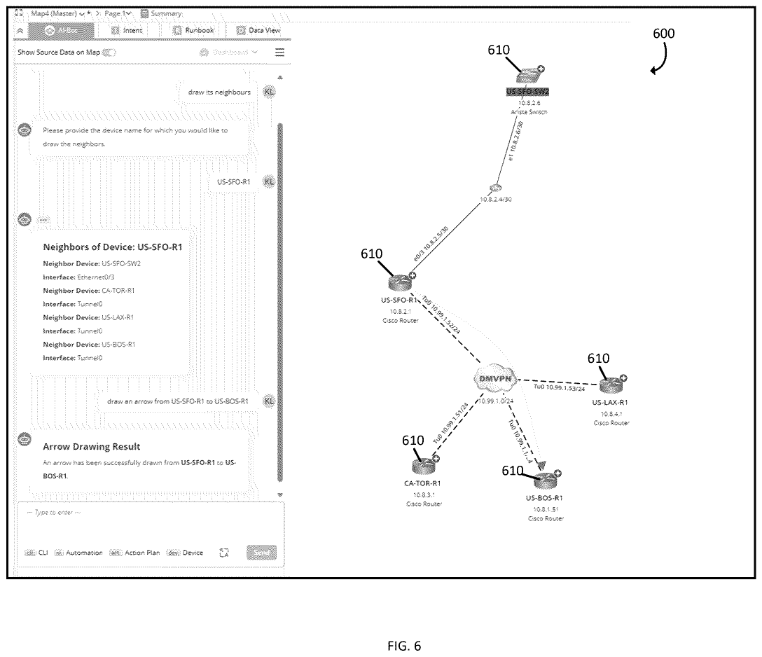

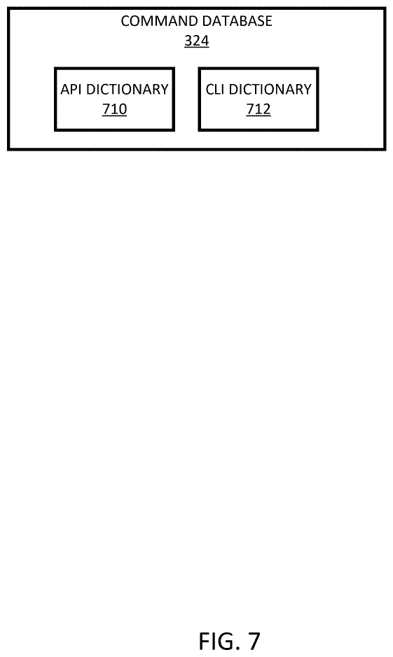

As illustrated in FIG. 6 embodiments of the current disclosure may provide for the ability to map a network and/or to generate a visual and/or text description of the network map 600. The map 600 may show one or more nodes 610 (e.g., computing devices). The map 600 may be generated via the draw IP circuit 354, draw device circuit 352, mapping circuit 524, and/or any other circuit disclosed herein as providing mapping capabilities, which may utilize an application programming interface (API) dictionary 710 and/or a command line interface (CLI) dictionary 712 (FIG. 7) provided by the command database 324. Maps may include arrow and/or other symbols to show directional communications. Boxes and/or other container type object may be used to show related devices (e.g., golden features). In embodiments, a map may show one or more paths corresponding to one or more network services provided by the network and/or its computing devices.

Referring back to FIG. 3, the artificial intelligence management circuit 316 is structured to manage one or more parameters governing interactions with the artificial intelligence circuit 362. For example, in embodiments, the artificial intelligence management circuit 316 may provide for a user to specify an input type (e.g., comma-separated values (CSV) file, image file, xml file, and/or the like) for the artificial intelligence circuit 362 to improve the artificial intelligent circuit's 362 ability to reason and/or respond more precisely to prompts from a user, the orchestration circuit 312, and/or any other circuit disclosed herein. For example, if a user knows what action and/or objective they want to do and/or achieve, and/or what automation they want to execute, the artificial intelligence management circuit may provide for the user (or circuit) to tag prompts to the artificial intelligence circuit 362 with a type. Embodiments of the artificial intelligence management circuit 316 may provide for a graphical user interface that provides a rich text feature for a user to enter a multi-step prompt and/or to provide for better organization of complex user input to the system 100.

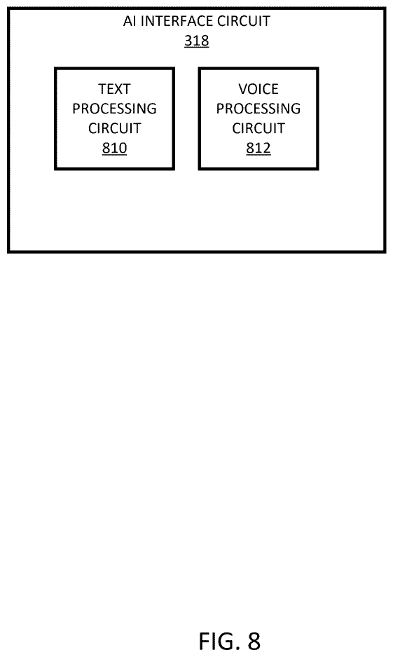

Referring to FIG. 8, the artificial intelligence interface circuit 318 is structured to facilitate electronic communications between the artificial intelligence circuit/model 362 (FIG. 3) and one or more of the other circuits disclosed herein. For example, the artificial intelligence interface circuit 318 may include a text processing circuit 810 structured to convert and/or condition data received from the orchestration circuit 312 into a form understood and/or processable by the artificial intelligence circuit 362 or vice-versa. In embodiments, the text processing circuit 810 may convert text received via the interface circuit 310 into a form understood and/or processable by the artificial intelligence circuit 362 and/or vice-versa. The artificial intelligence interface circuit 318 may include a voice processing circuit 812 structured to convert data received from the artificial intelligence circuit 362 and/or the orchestration circuit 312 into sounds understood by a human user.

In embodiments, the artificial intelligence interface circuit 318 may provide a conversational interface (e.g., a chat dialogue box) for a user to ask natural language questions of the artificial intelligence circuit. As will be appreciated, in embodiments, conversational interface may use one or more features on the interface circuit 310, text processing circuit 810, voice processing circuit 812, orchestration circuit 312, and/or any other circuit disclosed herein. For example, a user's text input (a question and/or command) may enter the system 100 via the interface circuit 310, be sent to the text processing circuit 810, then passed to the orchestration circuit 312. The orchestration circuit 312 may then coordinate one or more of the other various circuits disclosed herein to interact with the artificial intelligence circuit 362 via prompting the artificial intelligence interface circuit 362 to respond to the user's text input or in some cases, input in other modalities such as images, network topology descriptions, graphs, etc. The response(s) from the artificial intelligence circuit 362 to the prompts may be received by the artificial intelligence interface circuit 318, passed to the orchestration circuit 312 for processing, where results of the orchestration circuit's processing 312 may be transmitted to the user via the interface circuit 310.

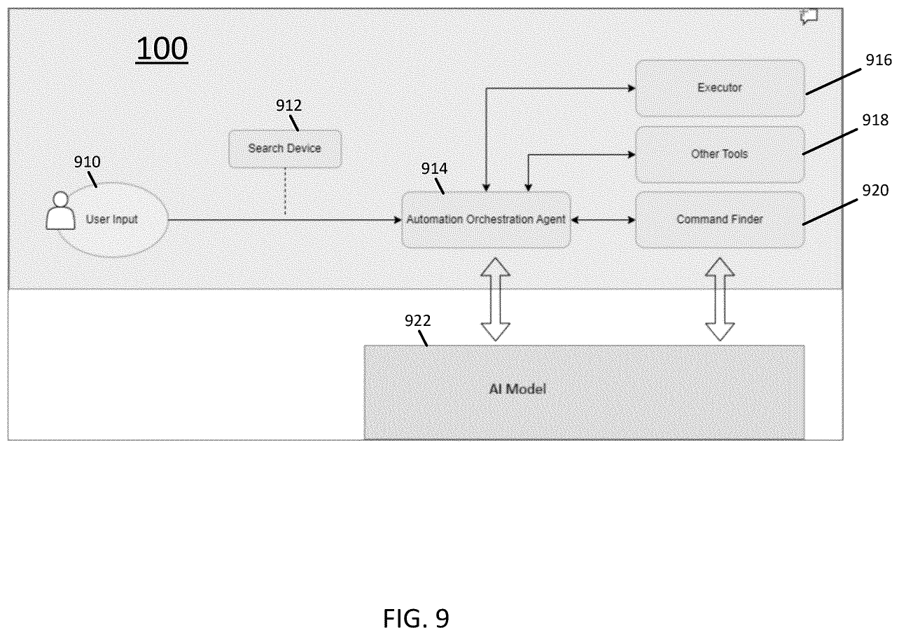

FIG. 9 depicts a functional block diagram of the features of an embodiment of the system 100 provided by, at least in part, one or more of the interface circuit 310, artificial intelligence management circuit 316, artificial intelligence interface circuit 318, artificial intelligence circuit 362, and/or orchestration circuit 312. It is to be appreciated that one or more of the features depicted in FIG. 9 may also be provided by one or more of the other circuits disclosed herein, e.g., the mapping circuit 524, polling circuit 518, draw device circuit 352, etc.

As shown in FIG. 9, the example system 100 provides for user input 910, searching/querying 912, an automation orchestration agent 914 (also referred to herein as “orchestration agent”), an executor 916, other tools 918, a command finder 920, and an artificial intelligence model 922. The user input 910 may take the form of natural language text and/or voice questions and/or comments. The user input 910 may be acquired/obtained via a graphical user interface, which may have one or more input prompts. Searching 912 may provide for the system to identify computing devices relevant to the user input and/or to a task performed by the orchestration agent 914 and/or artificial intelligence model 922. The executor 916 may provide for the execution of one or more commands, which may be directly invoked by the user input, the artificial intelligence model 922, and/or the orchestration agent 914. The commands may be executed against a network and/or against one or more computing devices on the network. The other tools 918 may include mapping functionality, DNS resolution, device property retrieval, automation generation guides, software version updating and tacking tools, and/or the like. The command finder 920 may provide for the identification and presentation of available network and computing device commands. The artificial intelligence model 922 provides for deep learning and/or processing of prompts generated by the user input 910 and/or the orchestration agent 914. The orchestration agent 914 may coordinate the user's interaction with the other depicted functional blocks, e.g., searching 912, the executor 916, the other tools 918, the command finder 920, and/or the artificial intelligence model 922. In embodiments, the orchestration agent 914 may form part of and/or be embodied by the orchestration circuit 312; and/or the artificial intelligence model 922 may form part of and/or be embodied by the artificial intelligence circuit 362. In embodiments, the orchestration circuit 312 implements prompt engineering techniques that guide the artificial intelligence circuit 362 in processing network management requests. These prompts provide the model with structured frameworks for breaking down complex operations, selecting appropriate tools, and formatting responses. These prompts are designed to work with any artificial intelligence model 922 that meets basic capability requirements, allowing the system 100 to adapt to new or improved models as they become available.

As will be appreciated, embodiments of the current disclosure may provide for an improved human-machine interface for querying the status of one or more network computing devices and/or for troubleshooting network outages. For example, embodiments of the orchestration circuit 312 may provide for users to ask questions in natural language for intuitive problem resolution. The orchestration circuit 312 can orchestrate automations, chaining different actions together through reasoning. Embodiments may also return diagnosis results in natural language and/or other preferred formats, such as a table or dashboard.

Embodiments of the system 100 provide a natural language interface for executing network operations through an AI-powered chatbot interface (e.g., artificial intelligence interface circuit 318, orchestration circuit 312, artificial intelligence circuit 362, etc.). Embodiments of the natural language interface may provide for a user to have a natural language conversation, issuing interactive commands to the model.

In operation, according to an embodiment of the current disclosure, when a user submits a natural language request, the system 100 enriches (e.g., appends text, expands parts, injects additional info, etc.) the request with relevant context (e.g., context data) before sending it to the artificial intelligence model 922. This context may include information about available network management tools, current network state, device information, and operational constraints. For example, when processing a request to “show interface errors,” the system 100 may provide the artificial intelligence model 922 with context about the current network map, available CLI commands, and output parsing capabilities, enabling the model to formulate an appropriate response despite having no specific network management training.

Thus, and as will be appreciated, embodiments of the interface enable network operators to perform complex network tasks using conversational language rather than requiring knowledge of specific command syntax or system interfaces.

The interface may support progressive disclosure of information, allowing users to start with high-level queries and drill down into specific details through natural conversation. For instance, after displaying interface statistics, users can ask follow-up questions about specific metrics, request historical comparisons, or initiate automated monitoring of identified issues. The system 100 may also maintain appropriate context (e.g., context data) throughout these interactions while enforcing security policies and access controls.

Results may be presented in multiple formats depending on the nature of the query and the type of data being displayed. As explained in greater detail herein, the system 100 may generate tabular displays of command outputs, visual network maps, comparison dashboards, and natural language summaries of findings. Users can interact with these displays through continued natural language conversation, requesting additional details or initiating related operations.

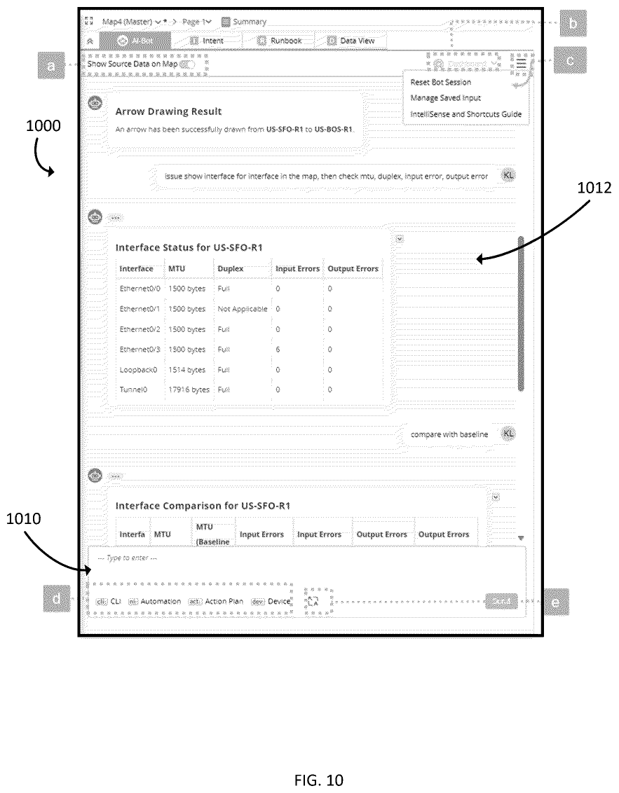

Accordingly, FIG. 10 shows an embodiment in which the orchestration agent 914 presents as a conversational chatbot via a conversational user interface 1000 with a text input box 1010 and conversational stream window/panel/dialogue box 1012. The chatbot interface processes and executes multi-step network operations through natural conversation. For example, when a user requests to “draw a device with IP address 192.168.1.1 and show its neighbors,” the system interprets this as a series of operations: first locating the device, then creating a network map visualization, and finally expanding the map to show connected devices. Embodiments of the system 100 may retain this context throughout a session, enabling follow-up queries about the displayed devices without requiring explicit reference to previously established context.

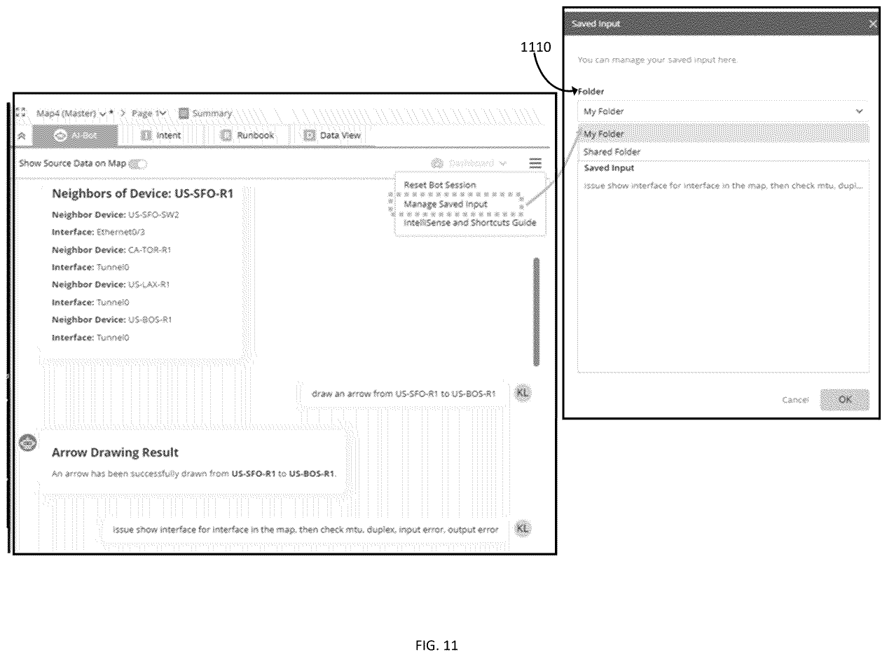

Non-limiting examples of user input to the chatbot interface include: “show source data on map”, which may cause the orchestration agent 914 to display CLI commands and/or parser results as a data view and/or the status code of a network intent result on the map; “dashboard”, which may cause the orchestration agent 914 to show and/or provide access to a map dashboard; “hamburger menu”, which renders the user interface in hamburger menu form (e.g., a type of GUI structured for user on a mobile device that has sliding panels that selectively show and hide various menu items and/or objects); “reset bot session”, which may clear the current chat session with the orchestration agent 914; “manage saved input”, which may provide for a user to save their input(s) in a private or shared location (e.g., a folder 1110) (as shown in FIG. 11). The chatbot interface, as disclosed herein, may support various categories of network operations, including but not limited to: topology mapping operations, where users can request network visualizations using natural language descriptions; data retrieval operations, where users can request specific information about network devices or configurations; comparison operations, where users can compare current network state against baseline configurations; and automated assessment operations, where users can initiate predefined network analysis procedures, and the like.

In operation, when a user inputs a natural language query (e.g., a natural language command), the system passes the query to an orchestration agent. The orchestration agent may be implemented using a large language model. This agent analyzes the query along with relevant context. In embodiments, the content may include the current network map state, device information, conversation history, and the like. The agent then determines the appropriate sequence of operations needed to fulfill the request. For example, if a user asks “show me interface errors on Device A and compare with baseline,” the system recognizes this as a command execution operation followed by a comparison operation.

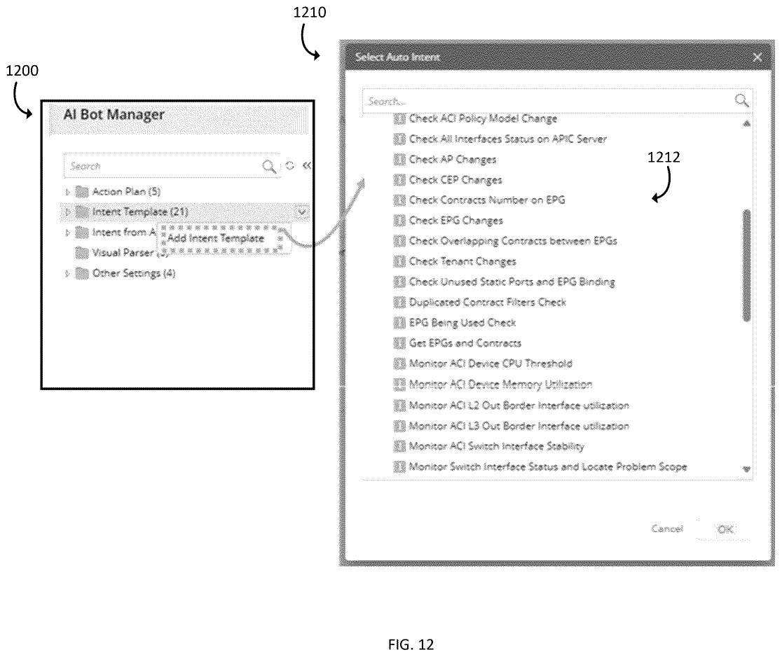

As illustrated in FIG. 12, embodiments of the orchestration agent 914 may provide graphical user interface(s) 1200 and 1210 for management of network intents (disclosed in greater detail elsewhere herein) and/or templates 1212 thereof. In embodiments, a user's query may be handled using a network intent template, wherein a seed network intent will be replicated based on an input computing device, a macro variable, and/or a task variable. The replicated network intent may then retrieve data by accessing the input device and return a status code after execution. In embodiments, the generation and/or application of network intents may be automated. In embodiments, a user must generate and/or add a network intent (or template) to the network intent database 332 for the orchestration agent 914 to have access to the network intent (or template). In embodiments, a user may need to specify, via the artificial intelligence management circuit 316, which network intents and/or templates the orchestration agent 914 has access to.

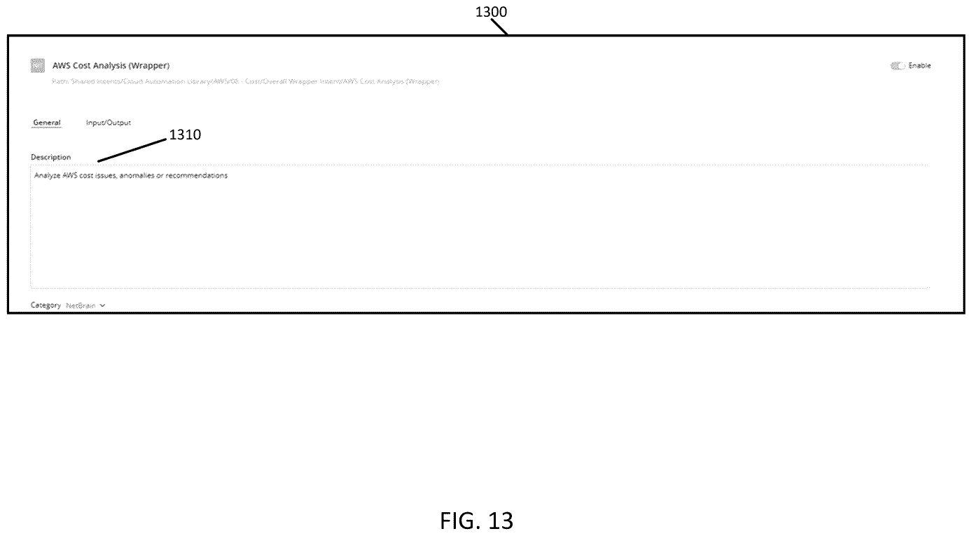

Embodiments of the current disclosure may also provide an interface (e.g., GUI 1300 in FIG. 13) for a user to define a description 1310 of a network intent (NIT) for the artificial intelligence circuit 362 to understand the NIT's purposes and/or category.

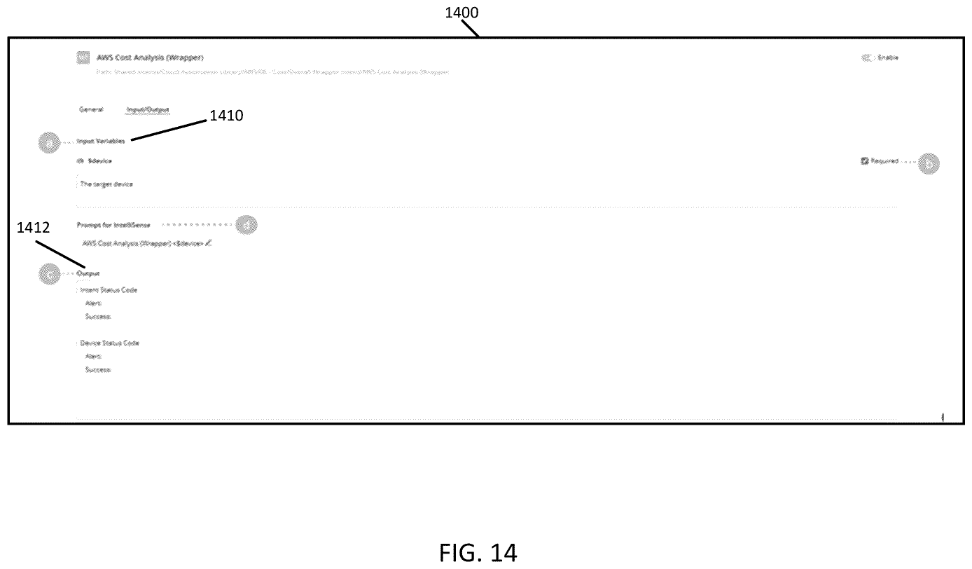

Embodiments of the current disclosure may also provide an interface (e.g., GUI 1400 in FIG. 14) for a user to define a description for input variables 1410 (macro variable or/and task variable), an output sample 1412 for artificial intelligence circuit 362 to understand its purpose, and/or prompt for IntelliSense.

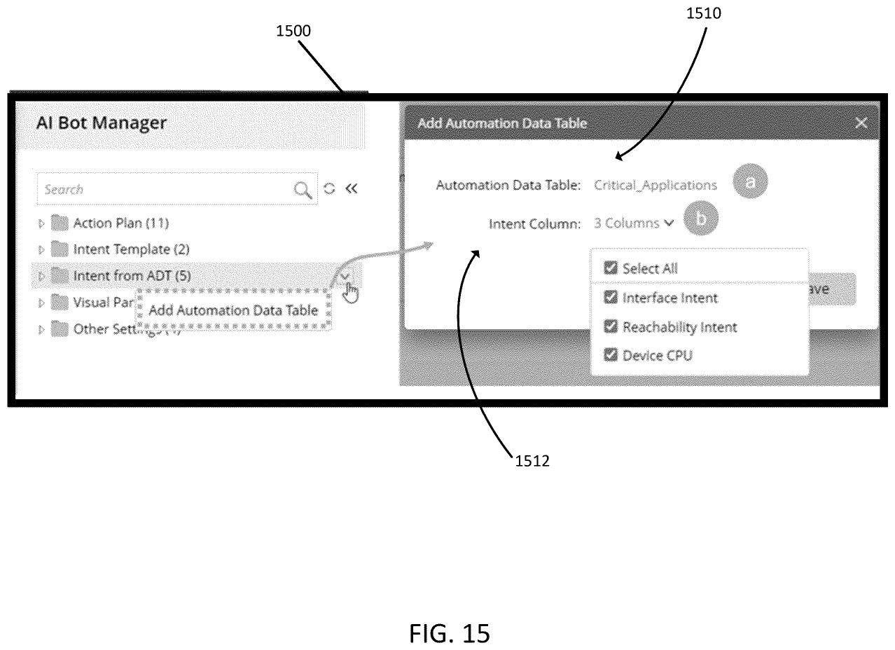

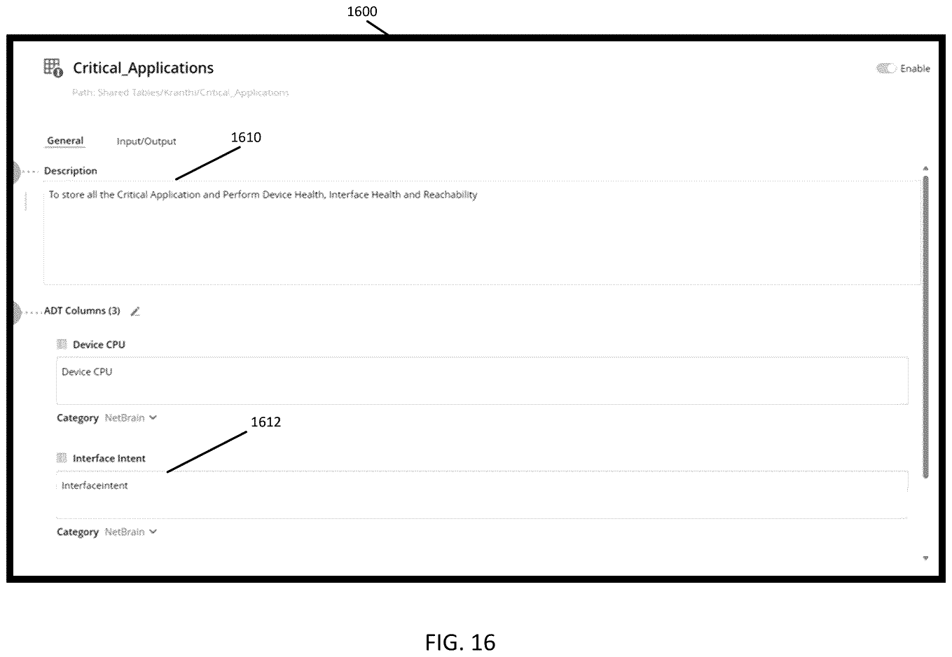

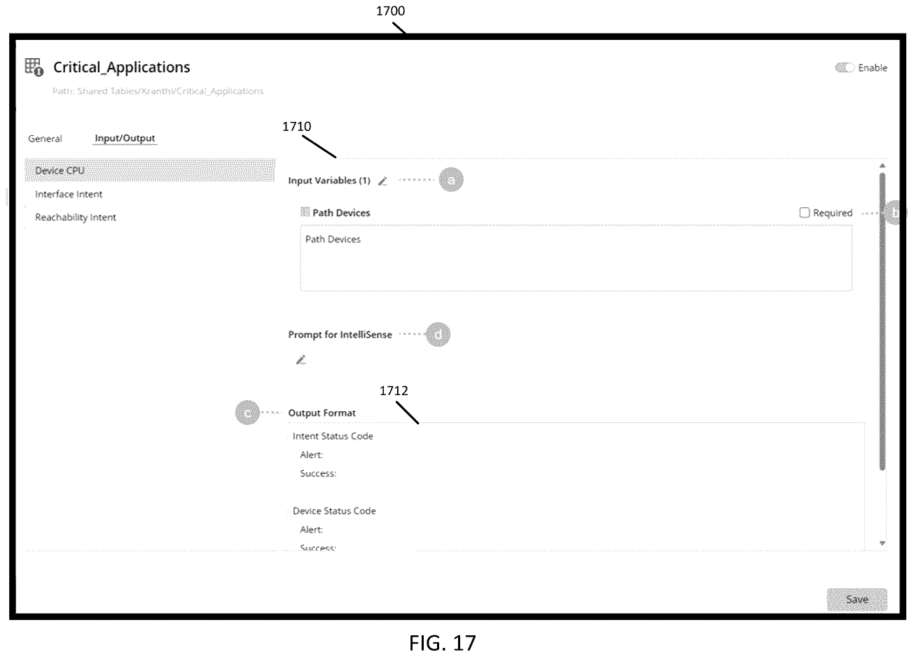

As shown in FIG. 15, the artificial intelligence management circuit 316 may provide for an interface (e.g., 1500 in FIG. 15) to an ADT 1510 for a user to specify an intent column 1512 (listing network intents) as an automation tool. In such embodiments, when a user's question/query/command can be addressed by an intent column, the orchestration agent 914 will search the intent column for an appropriate network intent. Embodiments of the system may also provide an interface (e.g., 1600 in FIG. 16) for defining descriptions 1610 of an ADT and the intent column 1612 for the artificial intelligence circuit 362 to understand their purposes and, optionally, select a category to store the ADT. An interface (e.g., GUI 1700 in FIG. 17) may provide for a user to define description(s) for input variables 1710, an output sample 1712 for the artificial intelligence circuit 362 to understand its purpose, and/or prompt for IntelliSense.

Referring back to FIG. 3, the command identifier circuit 320 may be structured to identify one or more commands available for execution on a network and/or on one or more computing devices on a network. As such the command identifier 320 may access (e.g., query) the command database 324 which may include the API dictionary 710 (FIG. 7) and/or the CLI dictionary 712 (FIG. 7) and/or the vector database 322.

The API dictionary 710 maintains a library of API templates (and/or other commands) that the orchestration circuit 312 and/or artificial intelligence circuit 362 can reference when generating call representations. These templates may define required parameters and format(s) for different types of network and/or device operations. The artificial intelligence circuit 362 can use these templates, combined with an understanding of the user's request (e.g., via provided context data), to generate appropriate API call (and/or other command) representations. The templates may specify the required fields for each type of operation, including operation type, target devices, commands to execute, parsing requirements, and any additional parameters needed for the operation.

For multi-step operations, the orchestration circuit 312 and/or the artificial intelligence circuit 362 can generate sequences of API calls (and/or other commands) that work together to accomplish the desired task. Each call in the sequence may include the necessary parameters and dependencies from previous operations. Embodiments of the system 100 may track these dependencies to ensure proper execution order and/or data flow between operations. For example, when comparing current data with baseline data, the system 100 may generate separate calls for retrieving each dataset and a subsequent call for performing the comparison, with appropriate references to the results of previous operations.

The CLI dictionary 712 implements a specialized dictionary architecture for managing CLI operations across multiple network device vendors. This dictionary system may interact with and/or include the vector database 322 (FIG. 3) which stores vendor-specific command templates, command descriptions, and expected output formats. When processing user requests, the system 100 can leverage CLI dictionary 712 to determine and/or execute the appropriate vendor-specific commands.

Embodiments of the CLI dictionary 712 maintain entries for each device type, where each entry includes the command syntax, a natural language description of the command's purpose, and sample command output data. This structure enables the orchestration circuit 312 and/or artificial intelligence circuit 362 to match natural language queries to appropriate vendor-specific commands. For example, when a user requests information about Border Gateway Protocol (BGP) neighbors, the orchestration circuit 312 and/or artificial intelligence circuit 362 may consult the CLI dictionary 712 to identify the correct command syntax for each vendor's implementation (e.g., using different commands for Cisco devices versus Palo Alto firewalls or other network devices).

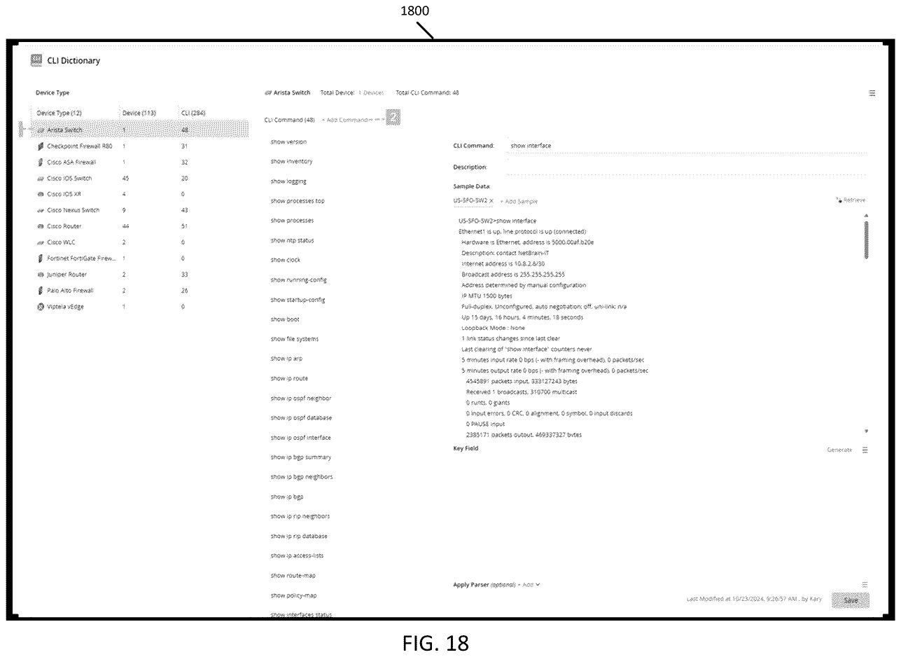

FIG. 18 depicts a non-limiting example of the CLI dictionary 712 shown in a GUI 1800. The CLI dictionary 712 may be dynamically searchable for a related CLI command based on a user's input. CLI commands may be sorted by device type in the CLI dictionary 712. To answer a query regarding computing devices made by different vendors, embodiments of the system 100 may issue, select, and/or execute appropriate commands for/to each device based on the CLI dictionary 712, which, in turn, may ensure the correct commands are issued to each vendor's device. Embodiments of the system 100 may provide for users to add CLI commands and/or parsers into the CLI dictionary 712. In certain aspects, during a system discovery task, the system 100 pre-defines CLI commands and generates key fields for major vendors in the CLI dictionary 712. The CLI dictionary can be updated via one or more servers external to the system 100.

In a nonlimiting scenario, the artificial intelligence circuit 362 may detect that a user wants to analyze a section of a config file (for a computing device), the command identifier circuit 320 searches a configuration parser in the config dictionary 712. If no configuration parser is applied in the dictionary 712, the orchestration agent 914 will retrieve raw data (e.g., raw configuration file data). If a configuration parser is found, the artificial intelligence circuit 362 will parse the value and retrieve the raw data.

Embodiments of the current disclosure may employ a similarity matching algorithm to calculate the relationship between user requests and command descriptions stored in the command database 324. For example, when a user submits a query, the artificial intelligence circuit 362 may analyze the request and match it against the command descriptions in the vector database 322. The orchestration circuit 312 and/or the artificial intelligence circuit 362 may then select the most appropriate command based on the device type and the nature of the request. For example, if a user asks to “show routing table” for a specific device, the orchestration circuit 312 and/or the artificial intelligence circuit 362 identifies the device type and retrieves the corresponding vendor-specific command from the dictionary appropriate dictionary/database.

To facilitate accurate command selection, embodiments of the system 100 may maintain sample output data for each command. This sample data serves multiple purposes: 1) it helps the system understand the expected output format, 2) enables the extraction of relevant information from command results, and 3) assists in generating field definitions for parsing command outputs. The artificial intelligence circuit 362 may process the sample data to automatically generate these field definitions, eliminating the need for manual parsing rule creation.

When new device types and/or commands need to be supported, the dictionaries and/or databases, disclosed herein, can be expanded by adding new entries with appropriate command syntax, descriptions, and sample outputs. Embodiments of the system 100 may then automatically incorporate these new entries into the orchestration circuit's 312 and/or the artificial intelligence circuit's 362 command selection and/or parsing processes without requiring modifications to the core system architecture.

Through this dictionary-based approach, embodiments of the system 100 provide consistent functionality across diverse network environments while accommodating the specific command syntax and output formats of different vendor implementations. This enables users to interact with multi-vendor networks using natural language queries without needing to know the specific command syntax for each vendor's devices.

Configuration parsers may be sorted by device type in the configuration database 326 (FIG. 3). A configuration parser may have a corresponding description that can be matched against a user's input. As will be appreciated, embodiments of the current disclosure provide for a user to add, remove, and/or modify configuration parsers from the configuration database 326.

The vector database 322 may include command templates, descriptions, and expected outputs for one or more network and/or device commands and may serve as an external knowledge base for the artificial intelligence model 922. In embodiments, the vector database 322 may include and/or otherwise be integrated with the command database 324. Rather than encoding this information into the artificial intelligence model 922 itself, the embodiments of the system 100 provide data from the vector database 322 as context during query processing/prompting. As will be appreciated, this approach allows embodiments of the system 100 to update network management capabilities (e.g., such as adding support for new vendor commands and/or management functions) without requiring any changes to the underlying artificial intelligence model 922.

The configuration database 326 may store configuration data for one or more computing devices. Non-limiting examples of configuration data include XML files, Linux-style configuration files, proprietary configuration file formats, comma-separated values files, database records, and/or any other suitable data objects for storing configuration data. Non-limiting examples of configuration data include: network interface settings, DNS settings, user interface parameters, application and/or role specific parameters (e.g., firewall rules, routing tables, etc.), and/or any other type of setting for an application that is typically not set programmatically at compile-time (e.g., variables that are read-in during an application's loading and/or during execution).

The network monitoring and validation circuit 328 is structured to provide for one or more features for monitoring for device configuration changes, and/or for verifying device configuration settings. For example, embodiments of the network monitoring and validation circuit 328 may provide for the application of network intents that validate a golden feature against a golden configuration, as disclosed in greater detail elsewhere herein. A verification and/or validation of a golden intent, golden configuration rule, a golden configuration, and/or a device may involve retrieving a device's current configuration and comparing it to a golden configuration. As will be appreciated, this concept can be expanded to golden features where the one or more devices in the golden feature can be compared to one or more golden rules.

In embodiments, the network monitoring and validation circuit 328 may also implement/perform validation checks on generated API call representations before execution, including syntax validation to ensure proper formatting, parameter validation to ensure all required fields are present, permission validation to ensure the requested operations are allowed, and resource validation to ensure the operations can be executed.

The execution engine 330 is structured to execute one or more command values (e.g., network command and/or computing device commands), such as those stored in the command database 324. In embodiments, the execution engine 330 may be directed by the orchestration circuit 312 (e.g., the orchestration circuit 312 may pass a list of commands for the execution engine 330 to execute against one or more computing devices and/or a network, and/or the execution engine 330 may pass the results of the one or more commands back to the orchestration circuit 312). The execution engine 330 may execute the commands in order of priority (e.g., the commands may be associated with a priority level).

The network intent database 332 stores network intents (and/or templates thereof), as disclosed in greater detail elsewhere herein. Network intents may represent predefined automated procedures that perform specific network management functions, such as monitoring interface errors or assessing security compliance.

The diagnosis circuit 334 may be structured to receive network context data (e.g., device states, configurations, command results) and determine one or more possible (and/or actual) computing device and/or network issues. In embodiments, the diagnosis circuit 334 may be directed by the orchestration circuit 312, and/or interact with the artificial intelligence model 922 (and/or the artificial intelligence circuit 362) via the artificial intelligence interface circuit 318.

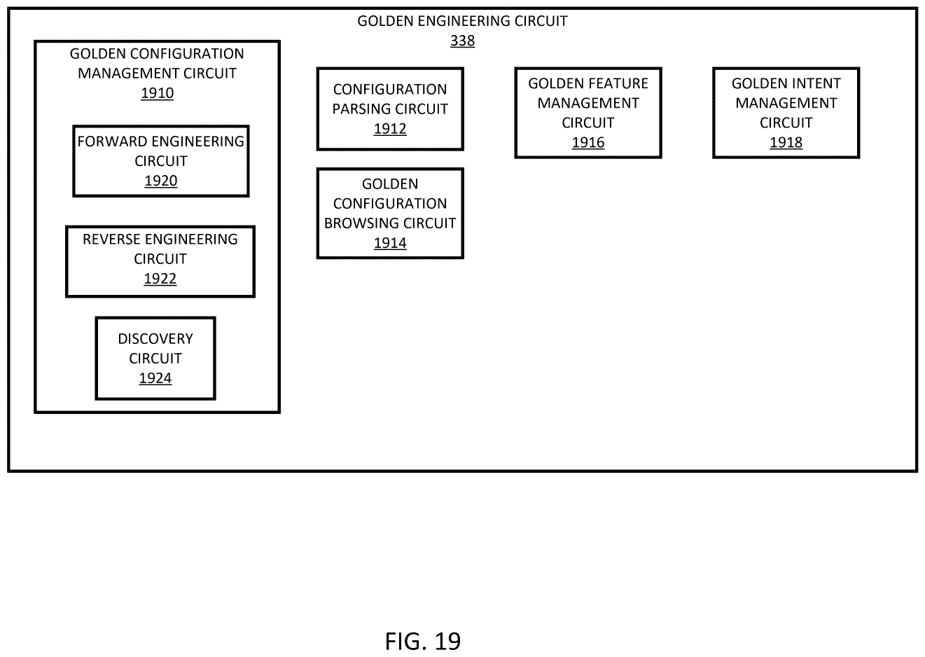

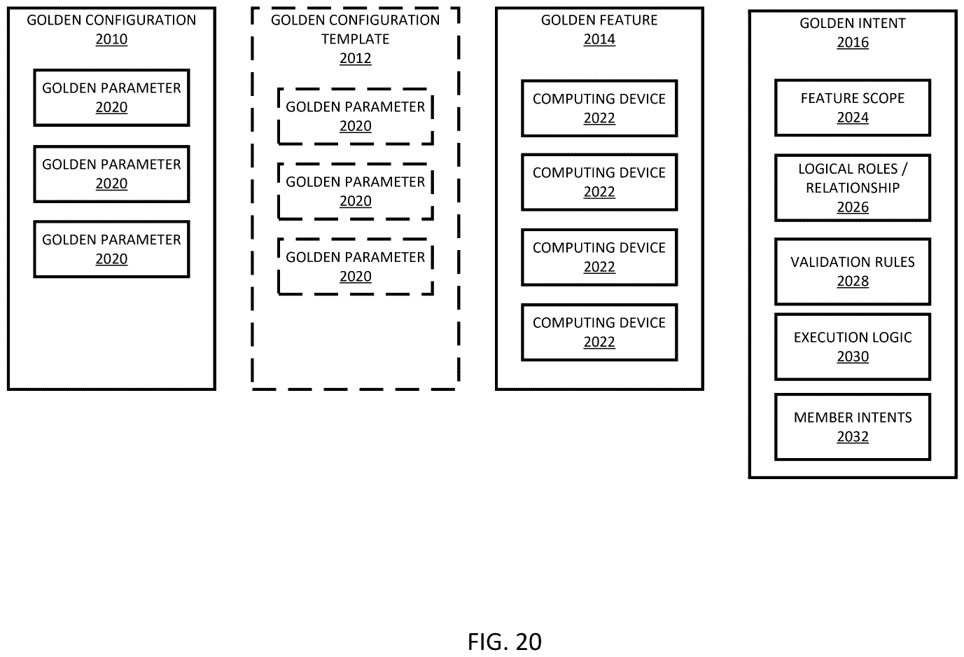

Referring to FIGS. 19 and 20, the golden engineering circuit 338 is structured to facilitate the defining, generation, identification, management of golden configurations 2010, golden configuration templates 2012, golden features 2014, and/or golden intents 2016. Embodiments of the golden engineering circuit 338 may include a golden configuration management circuit 1910, a configuration parsing circuit 1912, a golden configuration browsing circuit 1914, a golden feature management circuit 1916, and/or a golden intent management circuit 1918.

Non-limiting examples of golden configurations 2010, as disclosed herein, include data objects that include/group one or more golden parameters 2020 (e.g., device and/or network configuration settings common and/or shared between two or more network computing devices, e.g., routers, switches, firewalls, and/or the like). In other words, a golden configuration 2010 may represent a common configuration between two or more computing devices. A golden configuration 2010 may be common between similar devices (e.g., a routing table for a group of backbone routers made by the same provider and/or running the same operating system, etc.), and/or common between disparate network computing devices (e.g., a default TCP/IP gateway and/or DNS server common between a switch and a mail exchanger, etc.). In embodiments, there may be a level of tolerance in variation in the commonalities of configuration files that make up a golden configuration. The level of tolerance may be defined by a user. In embodiments, golden parameters may provide for the level of tolerance (e.g. variance) within a golden configuration, e.g., a range of acceptable NTP servers.

In embodiments, tolerance may be quantitatively and/or qualitatively measured per golden parameter 2020 and/or evaluated against candidate device configurations using one or more comparison schemes. By way of nonlimiting examples: (i) range/interval thresholds may be specified for numeric fields (e.g., CPU utilization ≤80%, NTP time offset within ±200 ms, MTU∈[1500, 9000]); (ii) relative/percentage variance may be applied where absolute values differ across devices (e.g., interface queue depth within ±10% of golden value); (iii) enumerations and allow-lists may define acceptable discrete values (e.g., permitted DNS servers ∈{10.0.0.10, 10.0.0.11}); (iv) pattern/format constraints (e.g., regular expressions for hostname schema, certificate patterns) may allow controlled variability while enforcing structure; (v) set similarity metrics be used for unordered collections such as access-lists, BGP neighbor sets, or enabled services; (vi) string distance (e.g., Hamming distance ≤κ) may be used for near-matching textual fields; (vii) schema-level validation may enforce presence/absence, type, and dependency constraints (e.g., if feature X enabled, parameter Y must be set within [a, b]); and (x) weighted scoring may combine multiple per-parameter tolerances into a composite compliance score, where each golden parameter 2020 includes a weight and tolerance descriptor (e.g., {type: range, min: . . . , max: . . . , weight: . . . }), and compliance is satisfied when the weighted score exceeds a threshold (e.g., ≥0.95).

In further embodiments, tolerance may be derived using statistical baselines computed over a cohort of devices (e.g., golden value=median; tolerance=±one interquartile range or ±two standard deviations), optionally stratified by device class, version, role, etc. Evaluation may be performed by a compliance engine that (a) normalizes candidate configurations, (b) aligns fields to corresponding golden parameters 2020, (c) applies the specified tolerance functions, and (d) emits a per-parameter pass/fail and/or deviation score, along with remediation guidance.

As is to be understood, ensuring that network computing devices adhere to a golden configuration 2010 reduces the likelihood of network and/or device errors. For example, in embodiments, a golden configuration 2010 may not be a pre-defined/documented configuration but rather a capture of the running configurations of several devices, where the running configuration has an acceptable level of network functionality. As will be appreciated, identifying the golden configuration 2010 of an operational network with no prior documentation lowers the risk of causing a network issue (e.g., an outage and/or reduction in service) when modifying the network (e.g., adding, removing, and/or updating network computing devices). For example, ensuring that a new router conforms to a golden configuration prior to becoming operational on the network increases the odds that the router can be added without causing a network outage as the golden configuration is known to be safe (or relatively safe) on the existing routers in the network.

A non-limiting example of a golden configuration template 2012, as disclosed herein, includes a data object that serves as a basis for making a golden configuration 2010. As such, embodiments of the current disclosure may discuss the generation, modification, and/or use of golden configurations 2010 in the context of golden configuration templates 2012. Thus, the features of golden configuration templates 2012 disclosed herein may, in embodiments, be equally applicable to golden configurations 2010, or vice-versa

The golden engineering circuit 338 is structured to facilitate defining, discovering, managing, and/or verifying a network's design and/or topology via golden configurations, golden configuration templates, golden features, and/or golden intents—in other words, the golden engineering circuit 338 provides for the discovery and management of a network's configuration. Thus, embodiments of the golden engineering circuit 338 ensure optimal network operations and enhance security.

The golden configuration management circuit 1910 may provide for a graphical user interface that facilitates maintaining a consistent network design and prevents/mitigates configuration drifts (e.g., the tendency of device configurations to change over time), which, in turn, avoids/mitigates security vulnerabilities, compliance issues, and/or outages across the network. As explained in greater detail elsewhere herein, embodiments of the golden engineering management circuit 1910 provide for the discovery, identification, and/or defining of golden configurations 2010 via a reverse engineering process and/or forward engineering process.

Golden parameters 2020, as disclosed herein, include device and/or network configuration settings common and/or shared between two or more network computing devices (e.g., routers, switches, firewalls, and/or the like). Golden parameters 2020 may be common between similar devices (e.g., a routing table for a group of backbone routers made by the same provider and/or running the same operating system, etc.), and/or common between disparate network computing devices (e.g., a default TCP/IP gateway and/or DNS server common between a switch and a mail exchanger, etc.).

Non-limiting examples of golden parameters 2020 include: network settings: (e.g., IPv4 and IPV6 address settings, subnet mask configuration, default gateway settings, DNS server settings, DHCP lease parameters, VLAN identifiers, static route configurations, firewall rule definitions, NAT mappings, VPN tunnel configurations, proxy server settings, etc.); wireless settings: (e.g., SSID configuration, encryption protocol selection, channel assignment, frequency band settings, transmit power levels, beamforming options, MU-MIMO configuration, roaming aggressiveness settings, MAC address filtering policies, hidden SSID settings, etc.); device performance settings: (e.g., CPU clock speed settings, GPU frequency adjustments, memory allocation parameters, power-saving mode configurations, thermal throttling thresholds, fan speed profiles, battery optimization settings, sleep and hibernate timers, etc.); security settings: (e.g., authentication method selection, encryption key management, access control list configurations, intrusion detection and prevention settings, certificate management policies, secure boot settings, password complexity requirements, biometric authentication options, etc.); application and service settings: (e.g., API endpoint configurations, request timeout parameters, retry interval settings, logging level definitions, caching parameters, load balancing algorithms, session persistence settings, compression options, etc.); Quality of Service (QoS) settings: (e.g., traffic prioritization rules, bandwidth reservation parameters, latency thresholds, jitter control settings, packet loss tolerance levels, traffic shaping policies, policing configurations, etc.); protocol settings: (e.g., TCP window size parameters, UDP buffer size settings, MTU configurations, keep-alive interval settings, retransmission timeout parameters, congestion control algorithm selection, SSL/TLS version settings, HTTP protocol enablement options, etc.); storage settings: (e.g., RAID level configurations, disk partitioning schemes, file system type selection, block size settings, write caching options, snapshot scheduling parameters, replication settings, encryption-at-rest configurations, etc.); display and interface settings: (e.g., screen resolution settings, refresh rate configurations, color depth parameters, brightness and contrast adjustments, UI scaling options, accessibility feature settings, etc.); update and maintenance settings: (e.g., firmware update schedules, patch management policies, rollback options, auto-update enablement, backup frequency settings, restore point configurations, etc.); and/or any other type of device and/or network setting.

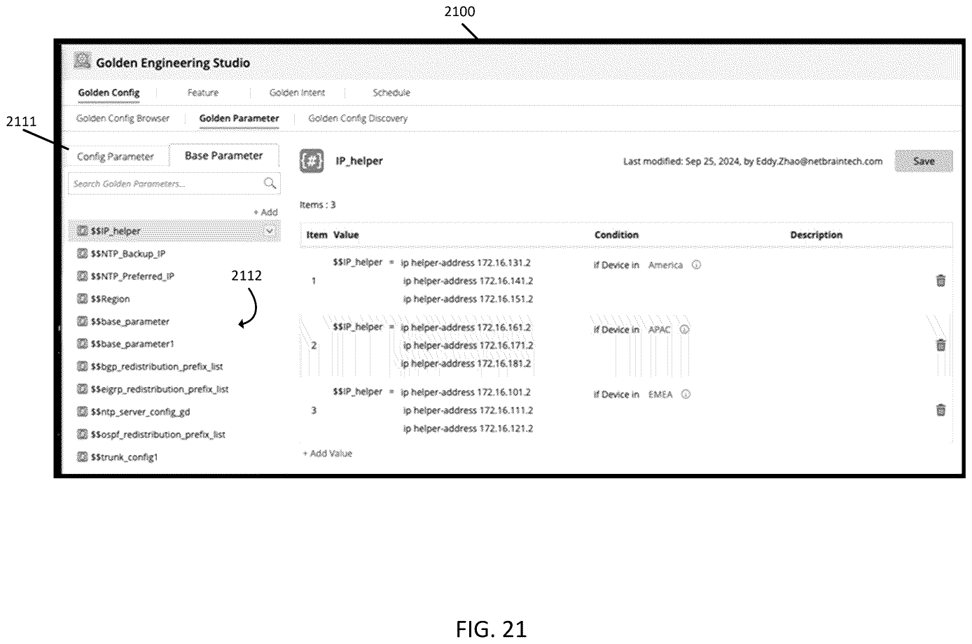

FIG. 21 shows a GUI 2100 for managing golden parameters 2020, in accordance with embodiments of the current disclosure. In embodiments, a user may use the GUI 2100 to define one or more golden parameters 2020 via base parameters 2112, configuration parameters 2111, and/or golden configuration templates 2012. A base parameter 2112, as used herein, refers to a variable whose value is conditionally assigned based on a device grouping, typically basic essential parameters, and/or usually used for key values and device essential attributes, such as region, contact, etc. Use of base parameters may improve the universality/applicability of a golden configuration 2010 (e.g., a golden configuration template based on base parameters may fit a wider variety of devices and/or network scenarios). A configuration parameter, as used herein, refers to a device and/or network parameter that is typically used for configlet standards.

GUI 2100 may provide for a golden parameter 2020 to be defined manually by entering one or more values and/or conditions for each value (e.g., whether a target device belongs to a device group). The golden parameter 2020 may then be incorporated into a golden configuration template 2012.

GUI 2100 may provide for the discovery, identification, and/or generation of golden parameters 2020 via a reverse engineering process. The reverse engineering process may help to discover the different values of a golden parameter 2020, where a user can view and select the different values for inclusion in a golden parameter 2020. Such embodiments may utilize an IP helper function. Non-limiting examples of an IP helper include a software-implemented functions and/or module configured to facilitate operations involving IP addressing within a network management and/or automation system. In some embodiments, an IP helper is operable to perform one or more tasks including, but not limited to, converting IP addresses between different formats (e.g., numeric and string representations), resolving IP addresses to corresponding hostnames, determining subnet information based on an IP address, mapping IP addresses to associated network interfaces, and validating IP address configurations against predefined policies. An IP helper may further support operations such as calculating broadcast addresses, identifying overlapping subnets, and generating IP ranges for allocation or scanning. In certain aspects, an IP helper may be invoked by automation workflows, scripts, or intent-based modules to streamline network troubleshooting, configuration validation, and compliance enforcement. Non-limiting examples of IP helper functionality include IP-to-hostname resolution, subnet mask derivation, IP range generation, interface association, and/or the like.

In embodiments, the IP Helper address can vary depending on the region (e.g., if the device group is “AMERICA region”, the IP Helper address may be set to 172.16.131.2; if the device group is “EMEA region”, the IP Helper address may be set to 172.16.101.2; etc.). As will be appreciated, this base parameter may be useful in scenarios where conditional value assignments are required when building golden configuration templates 2012.

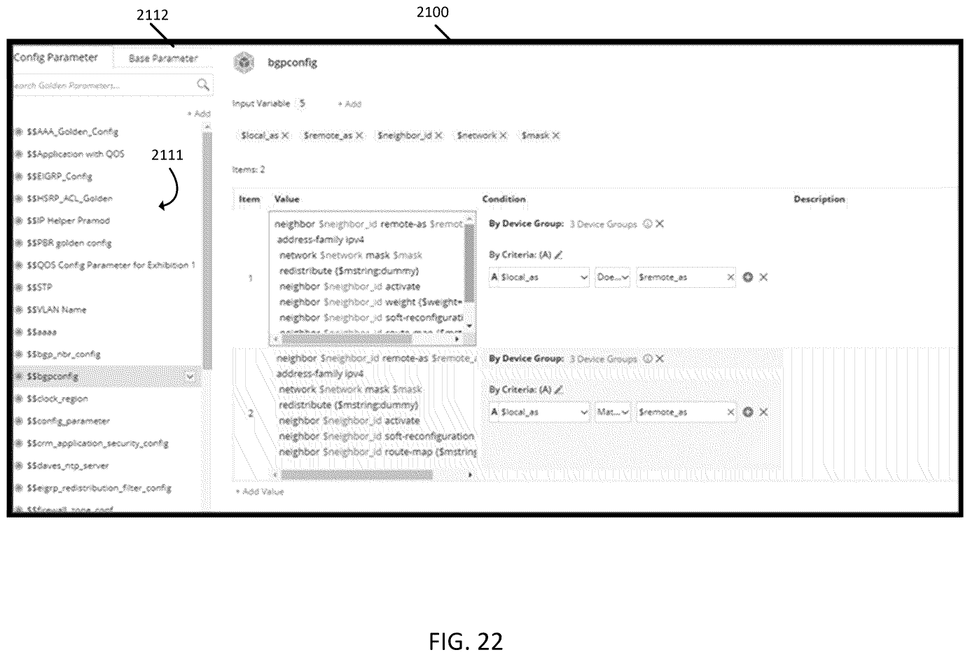

FIG. 22 shows an embodiment of the GUI 2100 where configuration parameters 2111 are used to define, identify, generate, and/or discover golden parameters 2020. The GUI 2100 may provide for input variables to be entered/created where the value can be passed from a parser variable when creating golden config templates 2012. The input variable can be used in value definition and/or when defining a golden parameter 2020 via criteria condition(s).

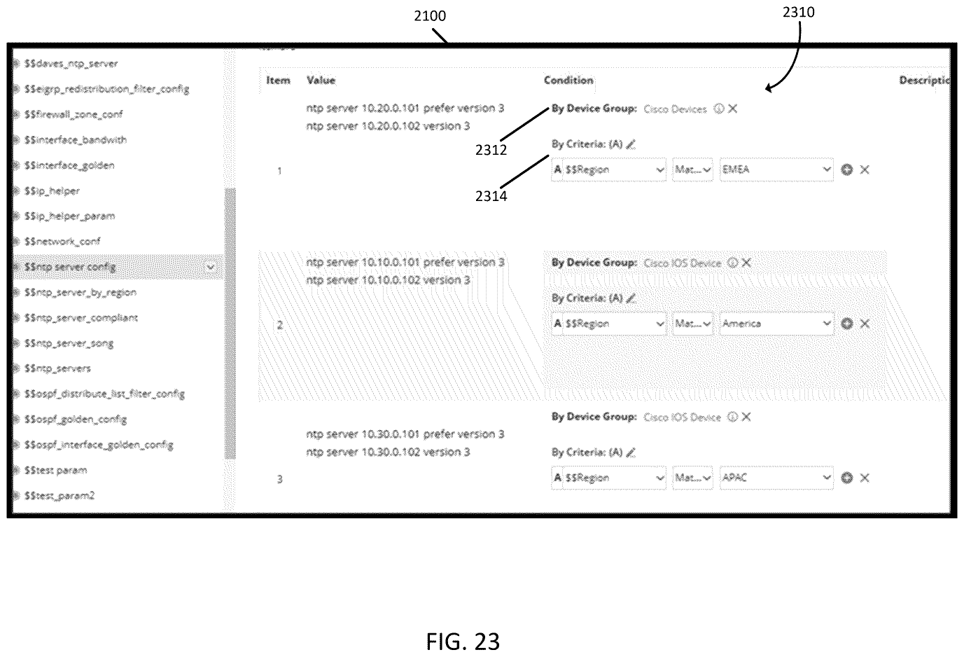

As shown in FIG. 23, GUI 2100 may provide for a condition 2310 to be defined using a device group 2312 and criteria 2314 (which may be defined using base parameter/input variable(s)).

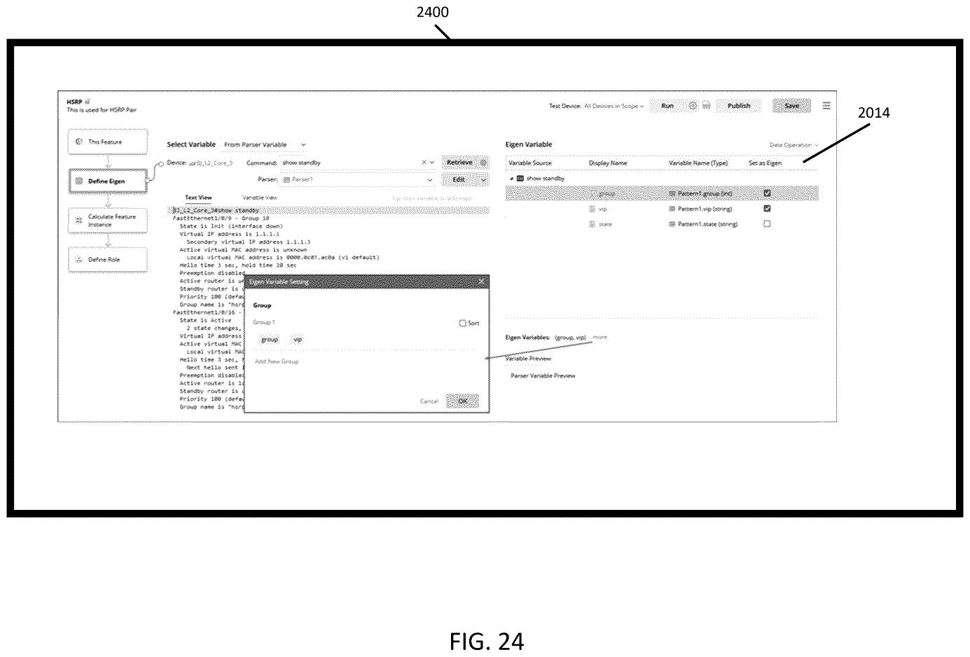

FIG. 24 illustrates a GUI 2400 (which may be generated by the golden feature management circuit 1916) for generating, defining, and/or identifying golden features 2014 for a network. Non-limiting examples of golden features 2014, as disclosed herein, include data objects/constructs that model design assets (often critical ones) for a network, and may be used as the base for building an intent automation (e.g., a golden intent). For example, in embodiments, a golden feature 2014 example of may include one or more computing devices 2022.

The GUI 2400 may provide for a user to define a set of eigen variable-based golden features 2014 according to the network technologies operating within their network, e.g., BGP, HSRP, multicasting, etc. Such golden features may categorize the network's devices based on various technical configuration characteristics and/or generate calculated feature instances to be used by a golden intent 2016. For example, in embodiments, eigen variables can be used to identify a feature instance (including a golden feature instance). Eigen variables, as used herein, include variables and/or network configuration parameters that can be used to group network computing devices together, e.g., pairs of failover devices. Nonlimiting examples of eigen variables include: protocol-specific identifiers (e.g., a group identifier; a virtual internet protocol address, etc.); device attributes (e.g., a host name; a device type; a location, etc.); interface-level attributes (e.g., a local interface name; a neighbor interface name; an interface internet protocol address, etc.); a neighbor relationship attribute (e.g., a neighbor device name; a neighbor device internet protocol address; a layer 2 neighbor; or a layer 3 neighbor, etc.); configuration parameters (e.g., a routing protocol setting; a network time protocol server address; a simple network management protocol community string, any golden parameter disclosed herein, etc.); system data variables (e.g., a region; a role, etc.); and/or the like.

The golden feature management circuit 1916, via one or more GUIs (e.g., GUI 2400) may provide for managing and maintaining golden features 2014 (e.g., defining, executing and/or utilizing, debugging, and publishing of golden features 2014). In a nonlimiting scenario demonstrating the creation, management, and use of a golden feature 2014, the golden management feature circuit 1916 retrieves all values of a defined eigen variable and combines them to form an “eigen value”. The golden feature management circuit 1916 then groups computing devices by their eigen values so that devices with the same eigen value are assigned to the same group (eigen group), which creates one feature instance. As will be understood, one device may have several eigen values, which means one device may belong to several feature instances. For example, one device can have multiple HSRP groups, which can be identified by Group_ID and Virtual_IP as an HRSP feature instance.

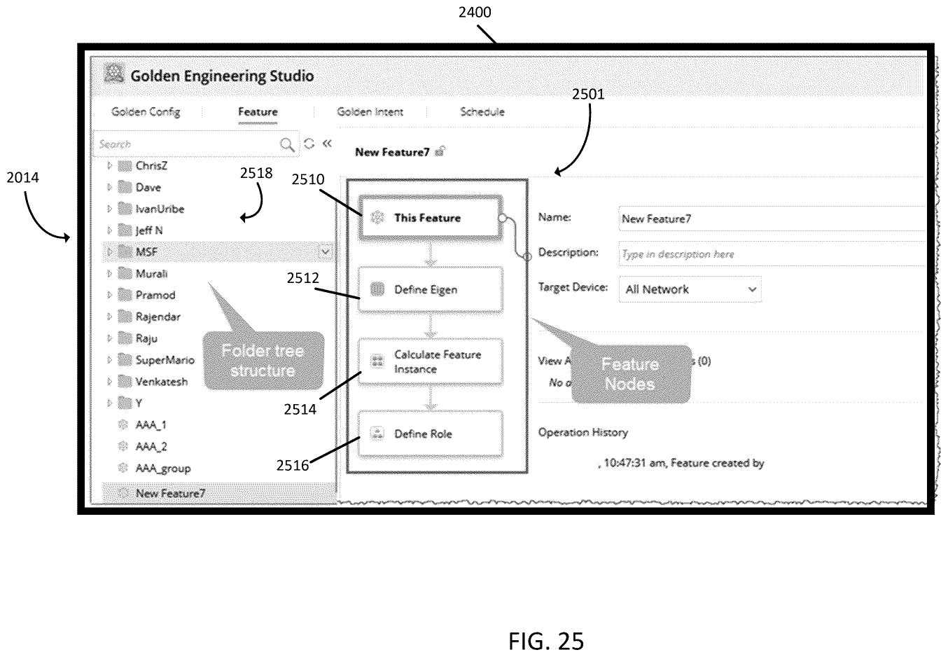

Moving to FIG. 25, after creating a new golden feature, the GUI 2400 may show one or more show nodes 2501 for managing the feature (e.g., “This Feature” 2510, “Defined Eigen” 2512, “Calculate Feature Instance” 2514, and “Define Role” 2516). The GUI 2400 may provide a folder tree structure 2518 to manage all golden features 2014 available to the system 100. The tree structure 2518 may provide for operations such as adding, deleting, modifying, and/or querying available golden features 2014. In embodiments, all available golden features 2014 may be shared (e.g., private golden features 2014 may be prohibited).

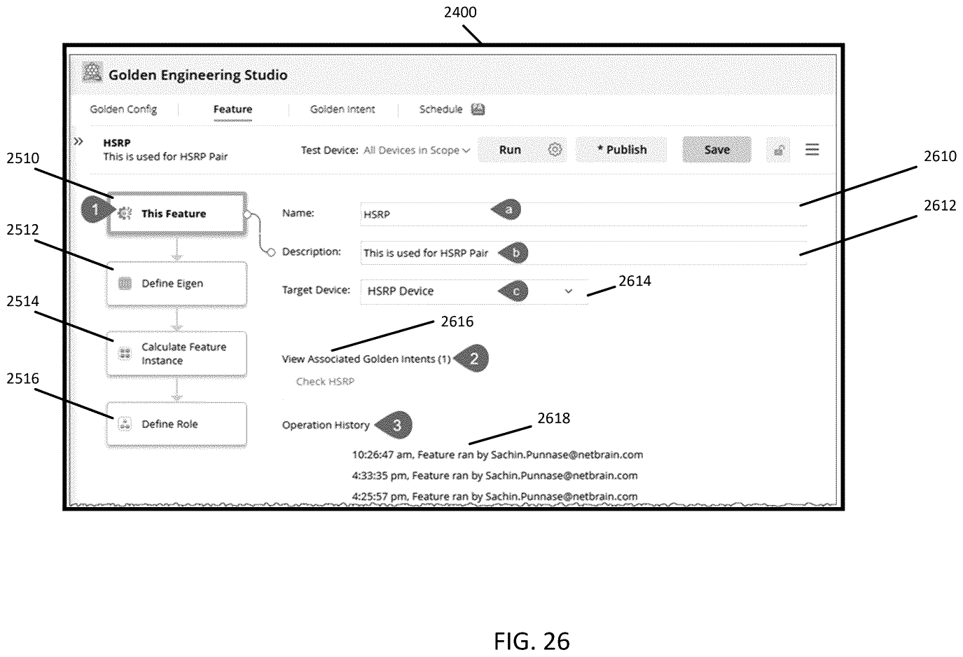

Continuing with the scenario, and turning to FIG. 26, “This Feature” 2510 provides for the creation of a golden feature by specifying a name 2610 and description 2612 and selecting a one or more target devices 2614. “This Feature” 2510 may also provide for viewing associated golden intents 2616 (2016 in FIG. 20) and/or operation history 2618. For the one or more target devices 2614, the GUI 2400 may provide for the selection of a device group and/or all network options from a dropdown, where the option corresponds to the network feature intended to be decoded (e.g., all networks should be selected for network features configured on all devices (e.g., SNMP, Password, Telnet/SSH, etc.); whereas a device group (e.g., HRSP device) should be selected where a network feature is configured on a specific subset of devices). As will be understood, use of a device group often provides easier maintenance and/or better performance. The GUI 2400 may also prevent multiple users from editing a feature simultaneously. As such, the system 100 may enforce controls and provide prompts based on existing user rights (e.g., read, write, edit, etc.) for specific resources.

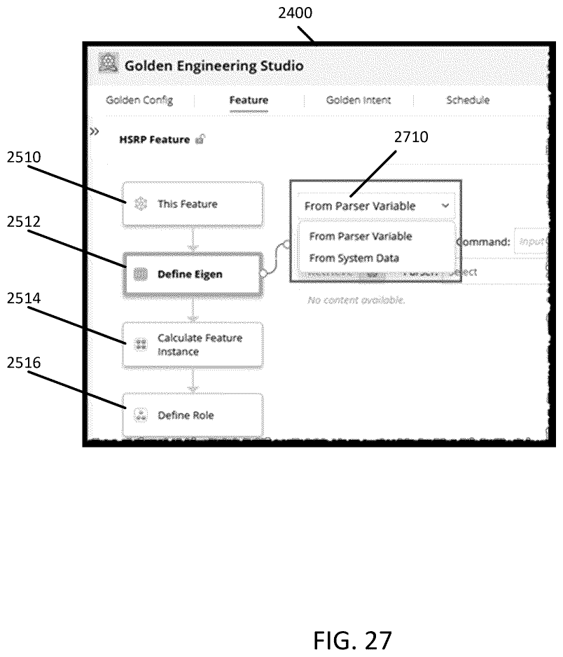

Moving to FIG. 27, “Define Eigen” 2512 provides for the defining of eigen variables (as disclosed herein) variables used for eigen calculations and/or other conditions. Each eigen value may create one (1) feature instance, and each feature instance may be assigned to one or more related devices. Eigen variables may be added via use of: 1) parser variables 2710 from a CLI and/or saved configuration; and/or 2) system data (e.g., a distributed graph repository (GDR)).

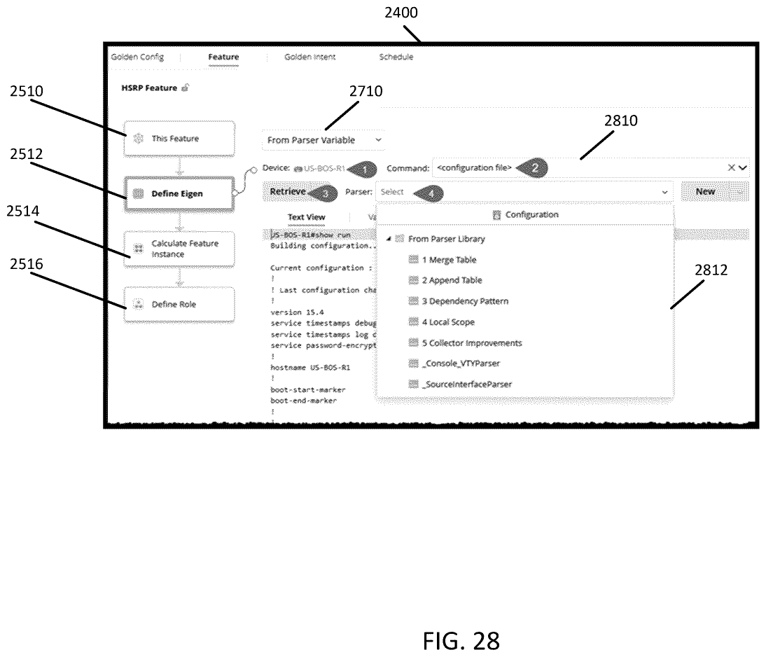

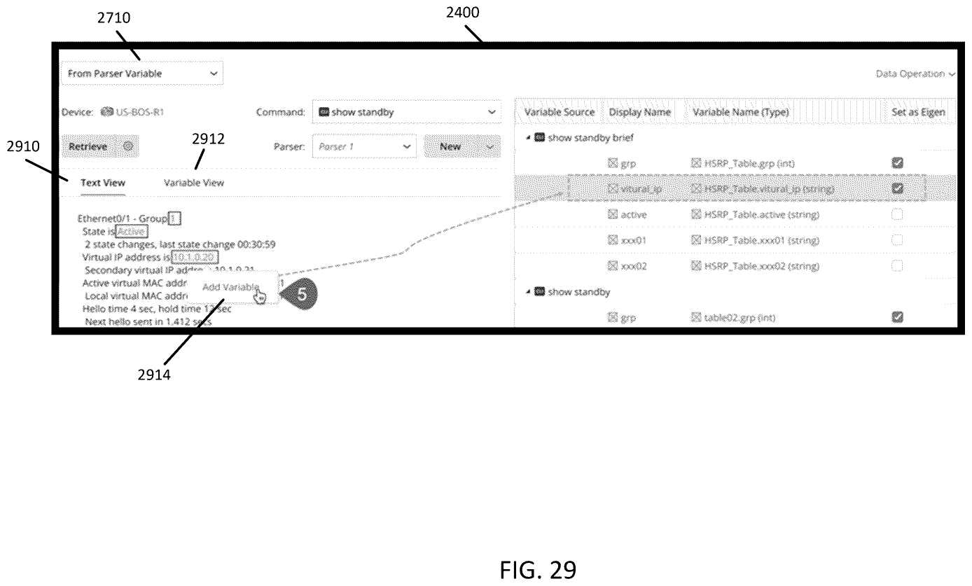

As shown in FIG. 28, when adding eigen variables via parser variables 2710, a user can select a device, enter a CLI command and/or select a configuration 2810, and then retrieve the corresponding device property data. After retrieving the device property data, the user can choose a matched parser from the dropdown menu 2812 or create a new parser. Referring to FIG. 29, users can have a text view 2910 or variable view 2912, and add 2914 a variable to the eigen variables. Embodiments of the system 100 may provide built-in functions to define compound variables to convert predefined variables in terms of variable types, units, values, etc. Thus, users can create compound variables from selected variables.

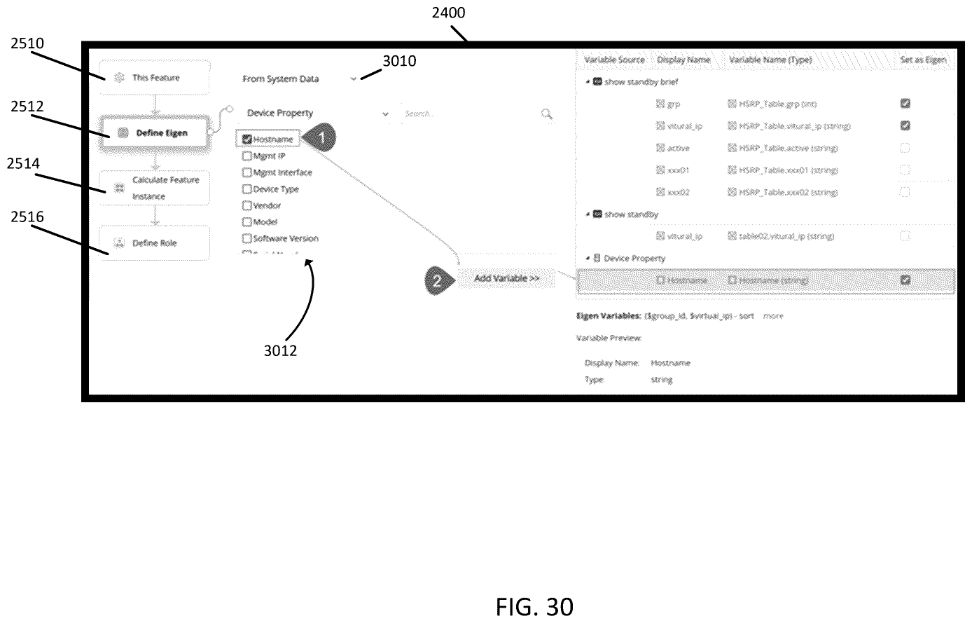

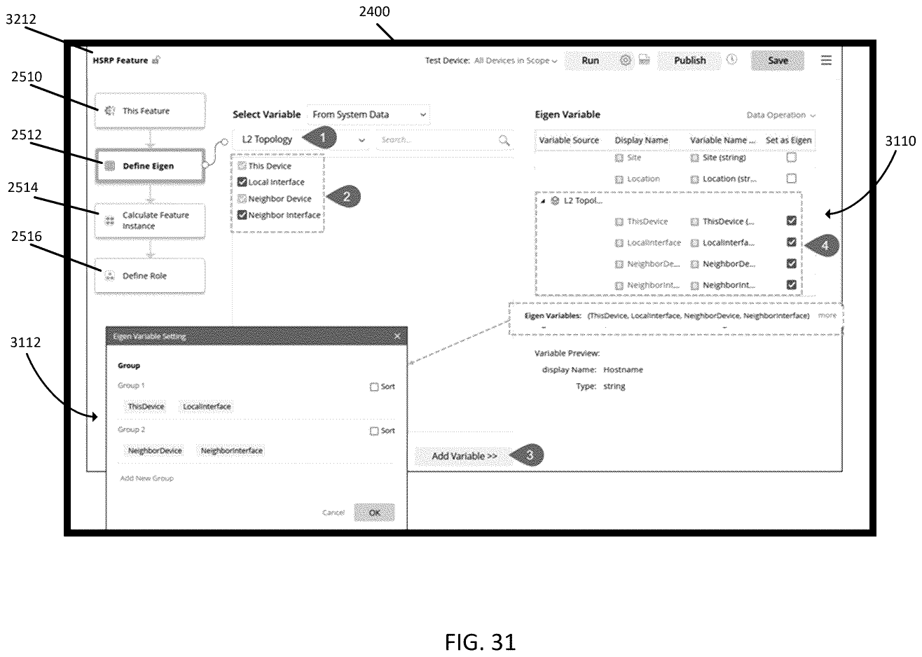

As shown in FIG. 30, when adding eigen variables from system data 3010, a user can select variables based on device properties 3012 (from the system data 3010 such as hostname and site). As shown in FIG. 31, selected eigen variables 3110 can be grouped 3112. As stated elsewhere herein, eigen values can be used to group devices with similar characteristics into a single group 3112. As will be understood, however, a different method may be needed to group a device with its layer-2 neighbors. For example, a layer-2 group may need to be defined via the following variables/properties: “this device”, “local interface”, “neighbor device”, and/or “neighbor interface”.

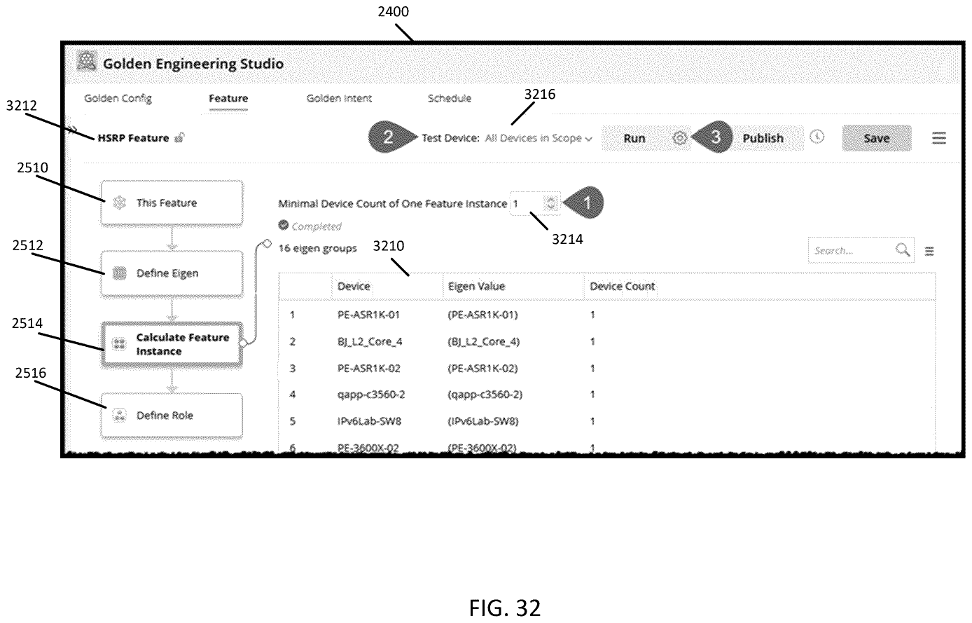

Referring to FIG. 32, “Calculate Feature Instance” 2514 provides for selection of a subset of test devices 3210 for computing and debugging the feature instance (e.g., “HSRP Feature” 3212). This process may be based at least in part on one or more of the eigen variable 3110 and/settings configured in “Define Eigen” 2512. By choosing a small set of test devices 3210, a user can focus on testing and refining the feature instance, thereby ensuring its accuracy before applying it across the network. The GUI 2400 may further provide for the setting of a minimal device count 3214 that controls the minimum number of devices required for each feature instance. In embodiments, the range for the minimal device count 3214 may be between about one (1) to about a thousand (1000), and/or the default value may be one (1). In embodiments, a feature instance will only be generated if it contains more than the minimal device count 3214. The GUI 2400 may further provide for the selection of test device(s) 3216, which may (optionally) have a default value of “All Devices in Scope”, which includes all the devices specified in the target device setting 2614 of “This Feature” 2510. Embodiments of the current disclosure may calculate the feature instance using live network data or from a selected data source.

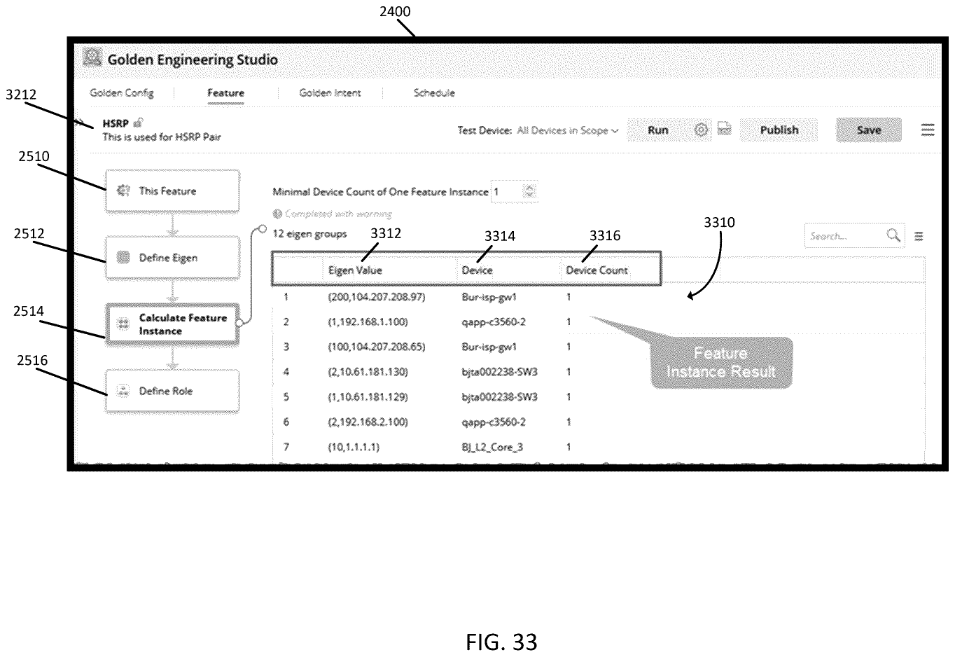

As shown in FIG. 33, the results 3310 may be displayed with three fixed columns: “Device” 3312, “Eigen Value” 3314, and “Device Count” 3316. Each row may represent a feature instance, each unique eigen value may generate a row, and devices with the same eigen values may be grouped into the same row.

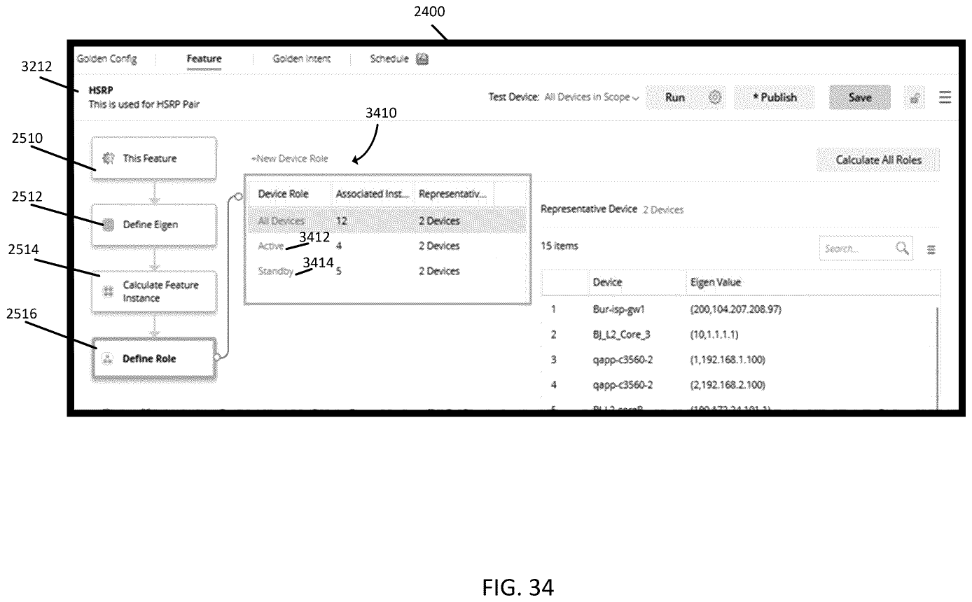

Referring to FIG. 34, under “Define Role” 2516, one or more roles 3410 can be defined for devices in a feature instance. For example, for the HRSP feature 3212, users can define two roles: “Active Device” 3412 and “Standby Device” 3414. In embodiments, the “All Devices” 3412 may be the default role, which includes all the devices associated with the feature instances calculated under “Calculate Feature Instance” 2514. Embodiments of the system 100 may also select a first device (in a device type) as a representative device.

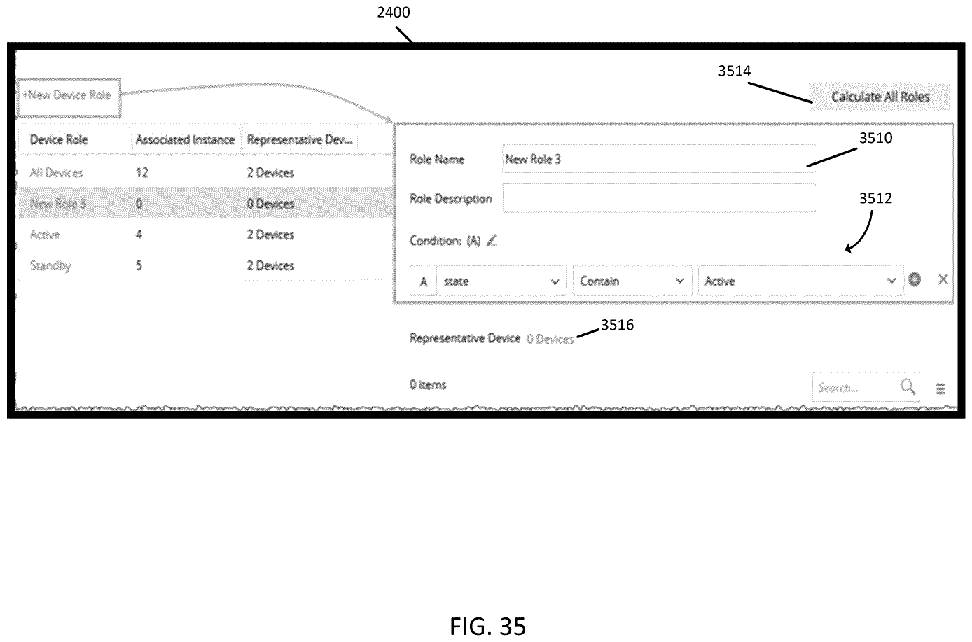

FIG. 35 shows the adding of a new role via the GUI 2400, in which a user can enter a name 3510 and define a condition 3512 for the role. Embodiments of the GUI 2400 may also provide a “calculate all roles” feature 3514 that finds and lists all roles for each feature instance. Embodiments of the GUI 2400 may also provide for a user to select different device roles and view the corresponding definitions and feature instance calculation results. The GUI 2400 may also provide the user to select/set a representative device number 3516 to set specific number of representative devices. In embodiments, the GUI 2400 may provide an indication (e.g., depiction of a star ‘*’ on the “calculate all roles” feature 3514) after a role definition is created and/or modified as a reminder to the user to recalculate the roles.

Thus, as shown by the preceding scenario, embodiments of GUI 2400 provide for: the retrieval of all values of eigen variables; the combining of eigen variable values to form a specified eigen value; the grouping of devices by eigen value; the creation of a feature instance for an eigen group (having a device count may exceed a defined minimum value); and the display of calculated feature instances.

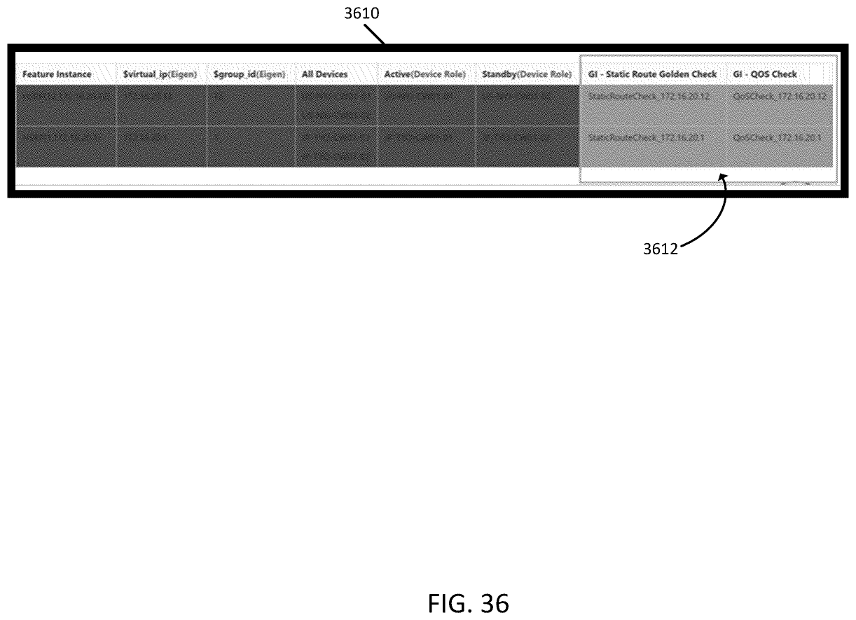

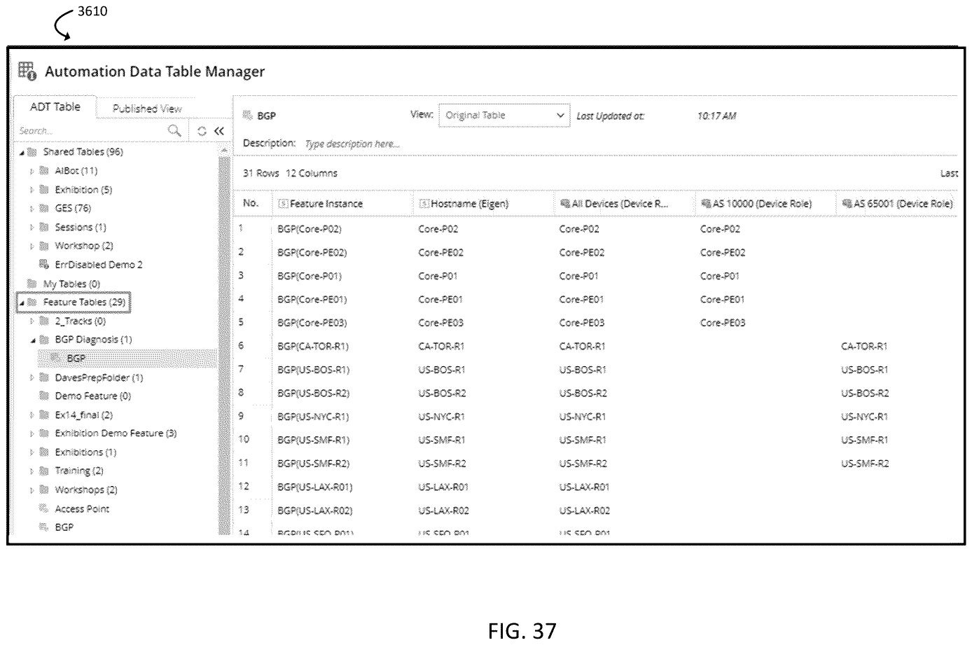

Once a golden feature is fully configured and/or debugged, the golden feature may be published (e.g., made available for use in the various components of the system 100) so that the golden feature can be used and/or accessed by and/or with golden intents 2016. Embodiments of the current disclosure may also provide for an indication (e.g., a ‘*’ displayed on a “Publish” button in a GUI) under the following conditions: 1) a user has clicked the Run button on all devices in scope and the result is not empty; and/or 2) a user has used a calculate role function under “Define Role” 2516. The indicator may be structured to remind the user to publish (and/or republish) a feature to update the results. Embodiments of the system 100 may also generate a feature ADT data structure 3610 (FIG. 36) upon publication of a golden feature, where the ADT data structure 3610 includes columns 3612 (FIG. 36) for intents. A further nonlimiting example of an ADT data structure 3610 is shown in FIG. 37

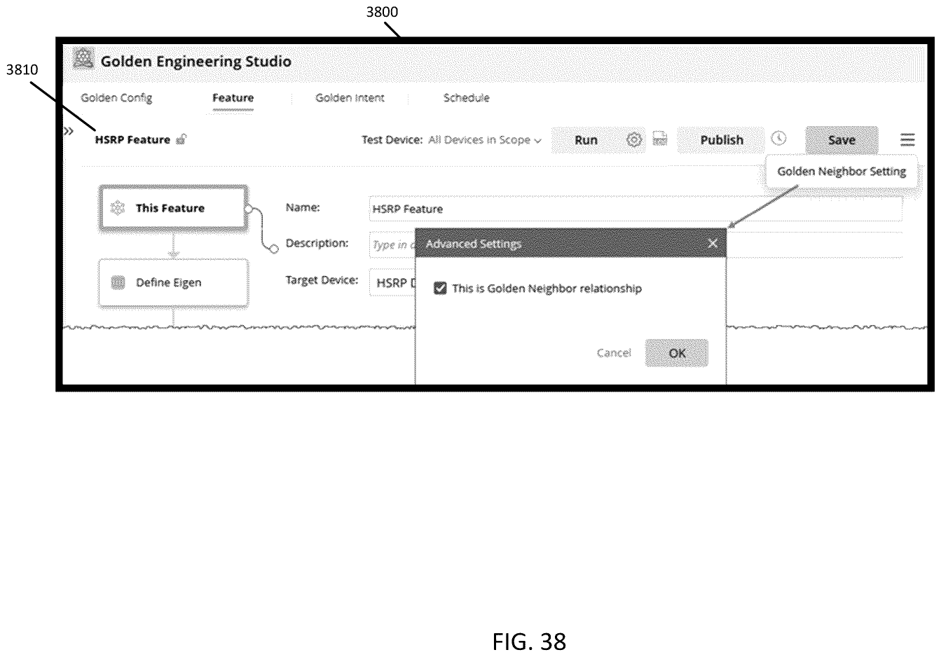

Referring to FIG. 38, embodiments of the golden feature management circuit 1916 (FIG. 19) and/or golden engineering circuit 338 (FIG. 19) may provide for the identification and/or management of golden neighbors, where a golden feature can be used as a golden neighbor. As used herein, a golden neighbor refers to a relationship (e.g., within a certain number of network hops) between one or more devices and/or features (and their corresponding devices). In embodiments, a golden neighbor may have a relationship between “this” and “neighbor.” For example, as shown in the example GUI 3800, all the devices of the “HSRP” feature 3810 use each device as “this” and its HSRP neighbor device as the “neighbor.”

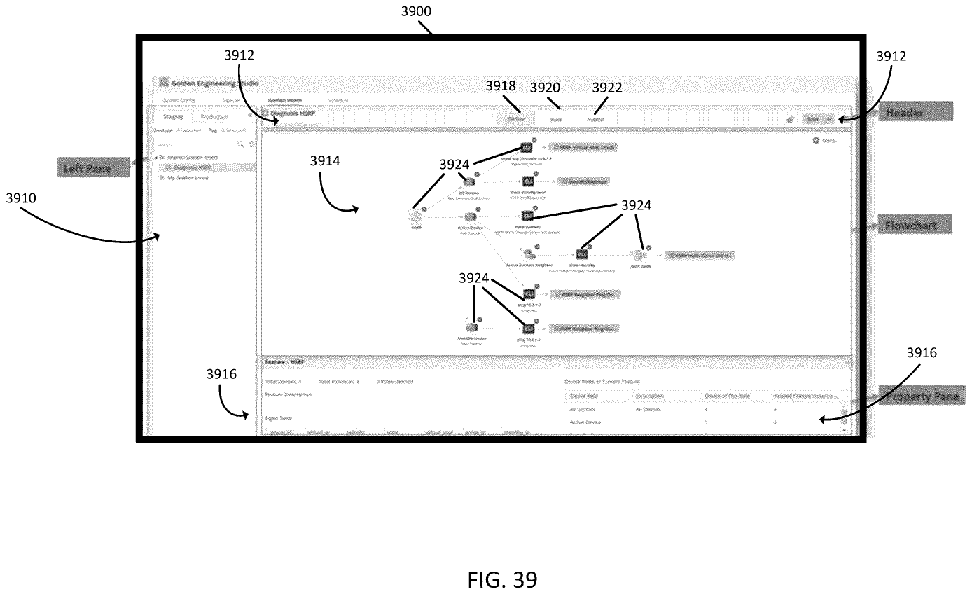

As stated herein, the golden engineering circuit 338 (FIGS. 3 and 19) may include a golden intent management circuit 1918 (FIG. 19) structured to provide for the management of golden intents 2016 (FIG. 20). Accordingly, FIG. 39 shows a nonlimiting example of a GUI 3900 that may be generated by the golden intent management circuit 1918 for creating, deleting, and/or managing golden intents

As used herein, a nonlimiting example of a golden intent 2016 includes a structured automation construct that defines the ideal operational state and expected behavior of a specific network feature or service. As explained in greater detail herein, golden intents can simplify the creation process of member intents for golden features so that users do not need to learn multiple conceptions and complex logic (e.g., NIT and ADT), reducing the learning curve. A golden intent 2016 may include several components: 1) the scope of the feature being modeled 2024; 2) the logical roles and/or relationships of participating devices 2026; 3) validation rules that specify conditions for correct implementation 2028; 4) execution logic that governs automated workflows for assessment, diagnostics, and remediation 2030; and/or 5) one or more member intents 2032.

For example, a golden intent for a Border Gateway Protocol (BGP) feature might define roles such as “primary router” and/or “peer router,” include rules to verify that neighbor sessions are established and route advertisements comply with policy, and/or incorporate logic to check live routing tables against these rules. Similarly, a golden intent for a VPN service could specify hub and spoke roles, confirm encryption settings, and/or validate tunnel health. In software, a golden intent 2016 may be implemented as a structured template and/or an object that stores the components 2024, 2026, 2028, and/or 2030, along with associated scripts and/or APIs to query live network data and compare it against a golden configuration 2010 (FIG. 20). Once deployed, a golden intent 2016 may act as a benchmark for continuous and/or periodic validation, enabling preventive automations to detect and/or resolve network and/or device issues, often before such issues impact service. Golden intents 2016 may also be used to identify configuration drift, and/or enforce compliance across dynamic and/or complex network environments. As will be appreciated, the use of golden intents, as disclosed herein, can shift network management toward an intent-based paradigm, where the actual state of the network is constantly measured and/or maintained against a predefined, automated representation of the desired state.

Member intents 2032, as used herein, may be subordinate automation constructs that represent specific instances and/or components of a broader intent-based model (e.g., a golden intent 2016). Member intents 2032 may include the detailed configuration, operational parameters, and/or validation logic for a single device and/or role within the scope of the larger golden intent 2016. In embodiments, each member intent 2032 of a golden intent 2016 may define the responsibilities and/or expected state of an assigned device and/or element, including role-specific attributes, compliance rules, and/or diagnostic checks. For example, in a BGP routing scenario, a member intent 2032 for a peer router might specify neighbor IP addresses, authentication settings, and/or route advertisement policies, along with validation steps to confirm session establishment and prefix exchange. Similarly, in a VPN feature, a member intent 2032 for a spoke device could define tunnel endpoints, encryption parameters, and health checks for connectivity. In software, member intents 2032 may be implemented as structured objects linked to their parent golden intents 2016, where the member intents 2032 store device-specific definitions, associated scripts, and/or APIs to query and validate live network and/or device data.

Embodiments of the GUI 3900 (FIG. 39) are designed to simplify the creation of member intents 2032 for related feature instances, reducing learning costs. In embodiments, after discovering features configured on a device in a network and generating a feature instance table based on the feature discovery function, the GUI 3900 provides for a user to associate one or more golden intents 2016 for each device list and feature for diagnosis analysis. Furthermore, golden intents 2016 and/or the GUI 3900 can be integrated with automation frameworks (AFs), to include preventative automation frameworks (PAFs), and/or triggered automation frameworks (TAFs), and/or the artificial intelligence circuit 362.

In embodiments, the GUI 3900 may include four (4) areas/portions: a golden intent manager 3910; a header 3912; a flowchart 3914; and a property pane 3916. The golden intent manager 3910 is structured to allow users to manage golden intents. The header 3912 displays the data at the golden intent level and/or provides the major intent-level operations. The header 3912 may also provide for the user to switch the GUI 3900 between three modes: “Define” 3918, “Build” 3920, and “Publish” 3922. The flowchart 3914 may provide for a user to generate, define, and/or complete an entire golden intent definition.

The property pane 3916 may provide for a user to select different nodes (e.g., devices), where the corresponding device information or configuration interface can be displayed (e.g., on the property pane 3916 itself). In embodiments, the GUI 3900 may guide a user through a workflow for creating and/or managing a golden intent 2016 having the following portions: “define golden intent”, “build golden intent”, and/or “publish golden intent”, respectively corresponding to the “Define” 3918, “Build” 3920, and “Publish” 3922 modes.

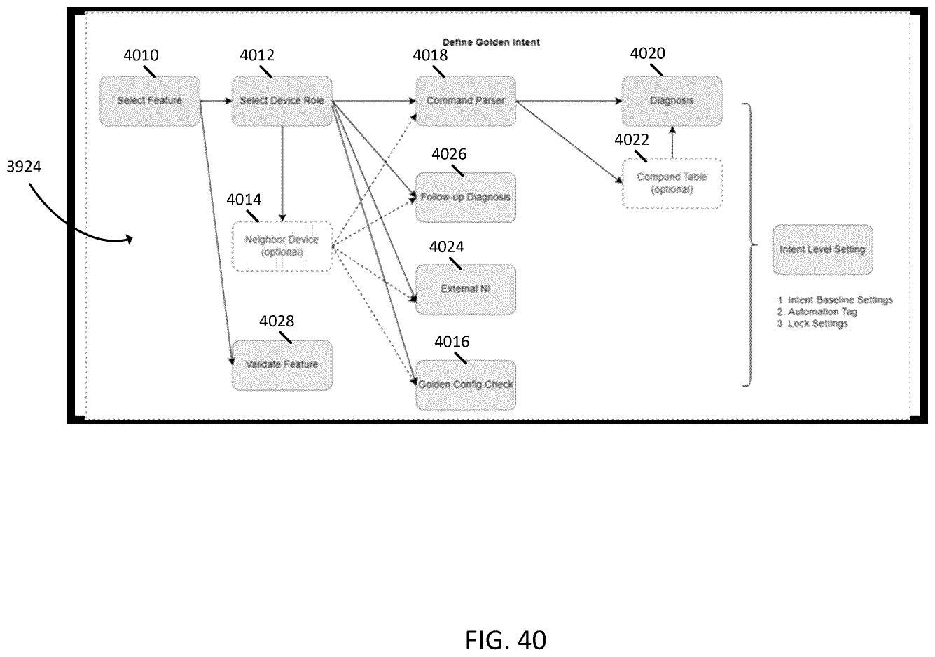

In the “Define” mode 3918, the GUI 3900 provides for a user to complete a golden intent definition by clicking on nodes 3924 (which extend) and defining properties. Nonlimiting examples of nodes 3924 for use in building a golden intent are shown in FIG. 40 with corresponding descriptions in Table 1.

TABLE 1

| | | | Can it be added |
|---|---|---|---|
| Node Type | Description | Extend Node Type | multiple times? |
| Feature 4010 | Have the ability to | Device Role Node | No |
| | select features and switch | | |
| | features. | | |
| | Display the properties | | |
| | related to the current | | |
| | feature. | | |
| | Display the device role | | |
| | information defined | | |
| | under the current feature | | |
| Device Role Node | Each Device Role can | Parser Variable | No |
| 4012 | be added to the flowchart | Golden Config | |
| | as a stand-alone node and | Neighbor Device Node | |
| | can be followed by | | |
| | different commands and | | |
| | diagnosis templates. | | |
| Neighbor Device | The neighbor device | Parser Variable | No |
| 4014 | node can be defined | Golden Config | |
| | based on the related | | |
| | device node for | | |
| | subsequent checks. | | |
| Golden Rule Node | Used for diagnosis | | No |
| 4016 | analysis of match pattern | | |
| | based on the selected | | |
| | golden rule. | | |
| Command Parser | Automatically extended | Diagnosis Node | Yes |
| Node 4018 | by selecting a specific | Compound Table Node | |
| | variable on the device | | |
| | role node. | | |
| | Support configuration, | | |
| | CLI command, GDR, | | |
| | SNMP, and API | | |
| Diagnosis Node | Support users to define | | Yes |
| 4020 | diagnosis logic | | |
| | efficiently with 4 | | |
| | templates: | | |
| | comparing (with | | |
| | baseline/last/customized | | |
| | value/another variable) | | |
| Compound Table | Support merge, sub, | Diagnosis Node | Yes |
| Node 4022 | append, and joint table | Compound Table Node | |
| | nodes. | | |
| More Action | External Intent Node | | |
| | 4024 | | |
| | Follow-up Diagnosis | | |
| | 4026 | | |
| | Validate Feature 4028 | | |

In embodiments, GUI 3900 may provide for a user to start with a feature and extend it (e.g., modify, specify, and/or add onto the node) with a device role. In such embodiments, the feature node 4010 provides for a user to select and switch features and view the current feature's properties. For example, selecting a feature for an empty node may cause the feature's details to be displayed on the property pane 3916 (FIG. 39) with (optionally) a summary of the device roles and the total number of devices and/or instances (of the selected feature). The user may then select device roles defined in the feature for use in the current golden intent 2016.

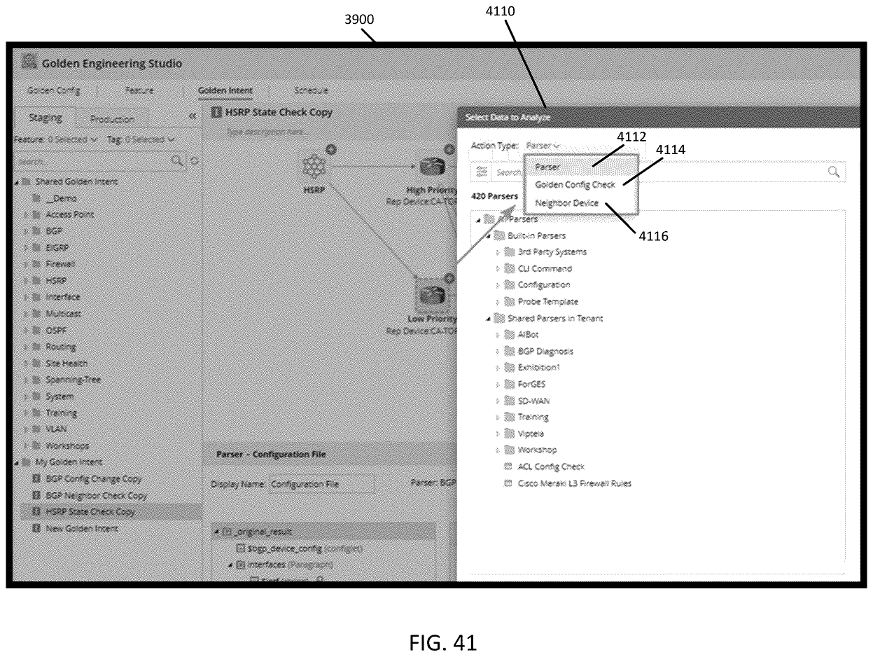

FIG. 41 depicts an embodiment of the GUI 3900 where a device role can be extended with a parser, golden configuration check, and/or a neighbor device. As shown, while in a device role node screen 4110, a user can extend the following actions: “parser” 4112, “Golden Configuration Check” 4114, and “Neighbor Device” 4116.

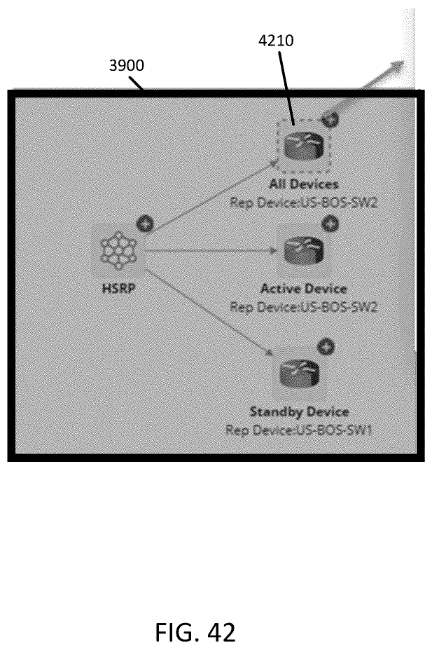

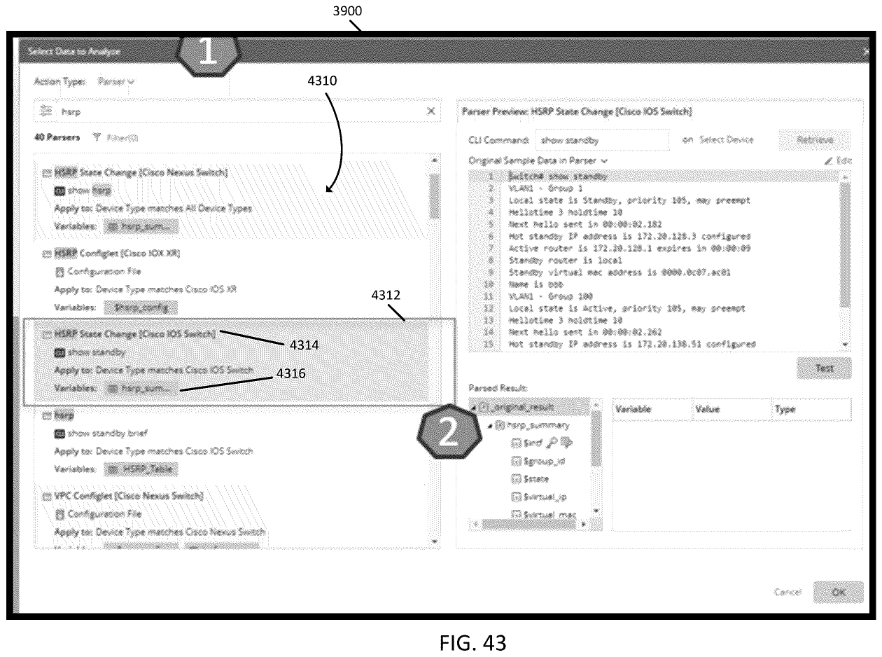

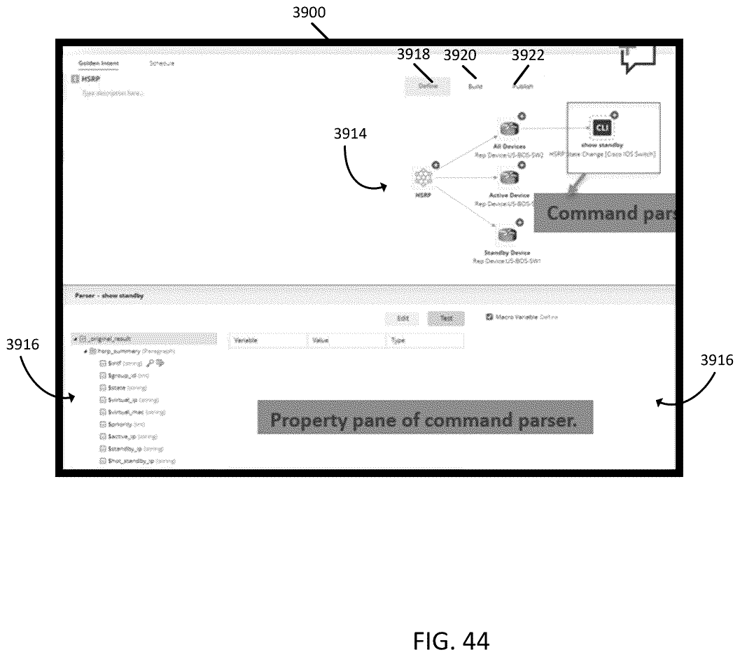

FIGS. 42, 43, and 44 depict a “parser” action extension 4112 for a node 4210, where the GUI 3900 depicts a listing of matched parsers 4310 for the node 4210. Selection of a matched parser (e.g., parser 4312) reveals and/or determines the command 4314 for retrieving a particular variable 4316. The GUI 3900 may also provide for a user to define one or more settings on the property pane 3916 (FIG. 39) (e.g., macro variable) and assign values. One or more variables in the selected parser may be made available on a subsequent diagnosis node.

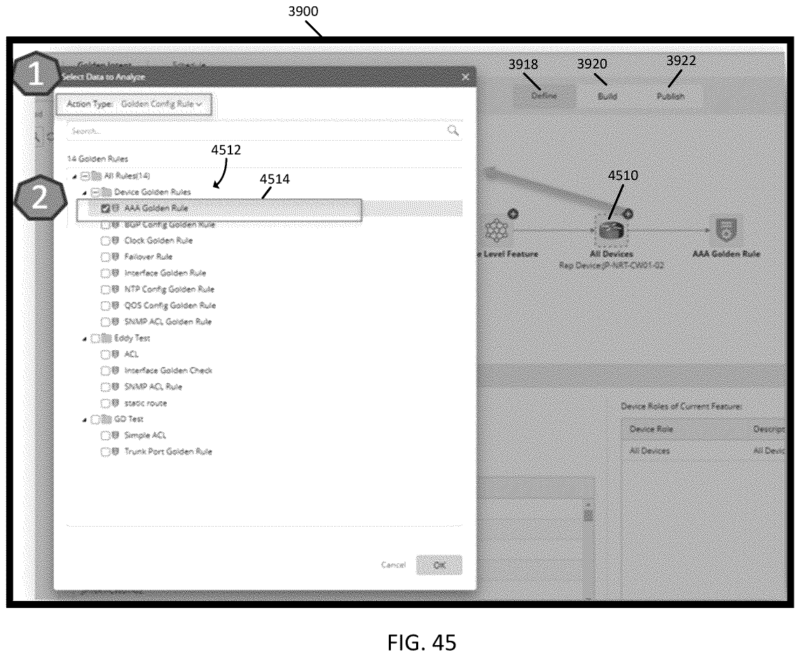

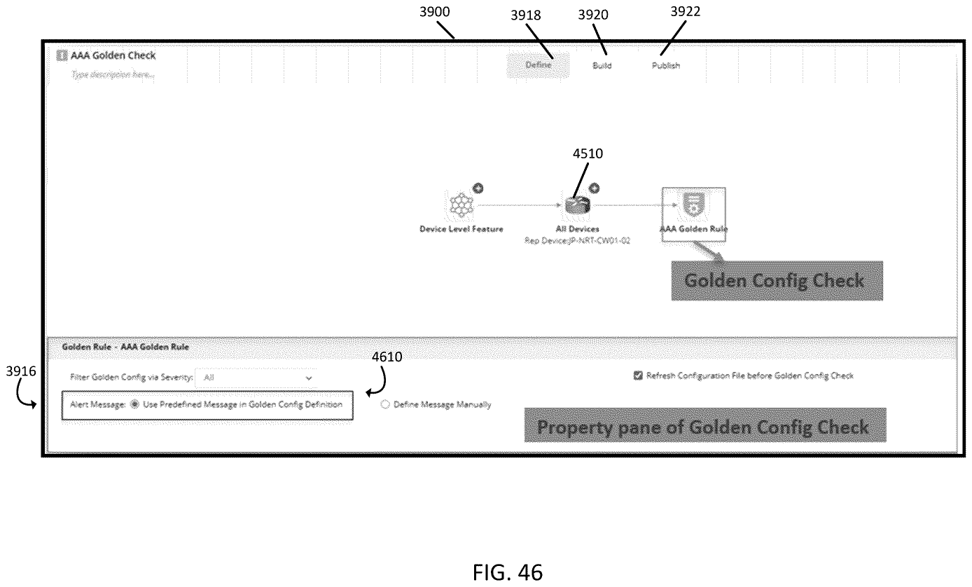

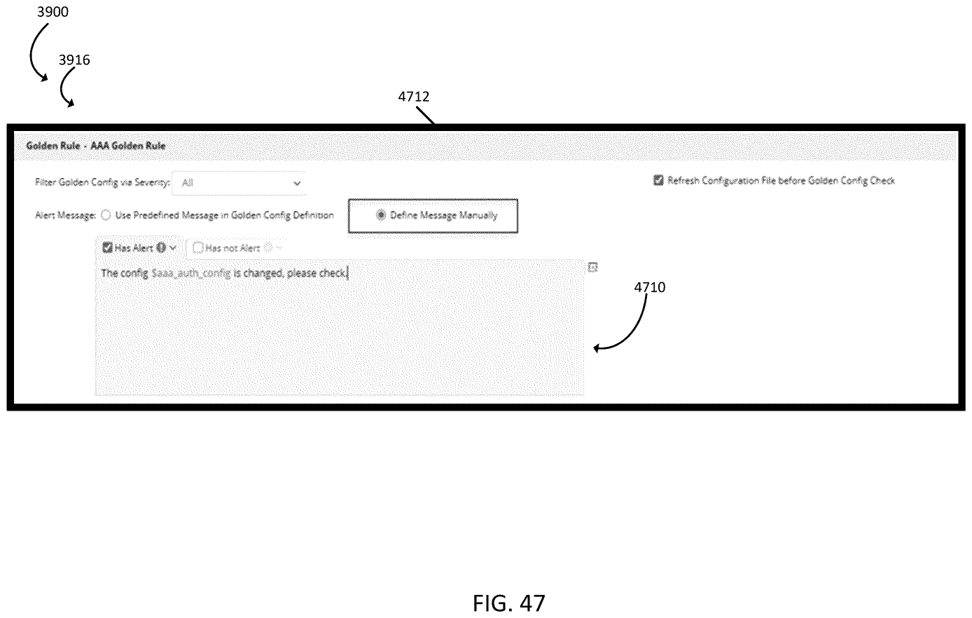

FIGS. 45, 46, and 47 depict a “Golden Configuration Check” action extension 4114 for node 4510, where GUI 3900 depicts a listing of all available golden rules 4512 for user selection. Selection of a listed golden configuration rule 4514 may update the property pane 3916 to display properties of the selected golden configuration rule 4514 and/or options 4610 for performing a golden configuration check of the selected golden configuration rule 4514 against the node 4510. Results 4710 of the golden configuration check may be displayed in a diagnosis window 4712 opened by extending a diagnosis node. Embodiments may also provide for checking of the golden configuration and/or golden configuration template.

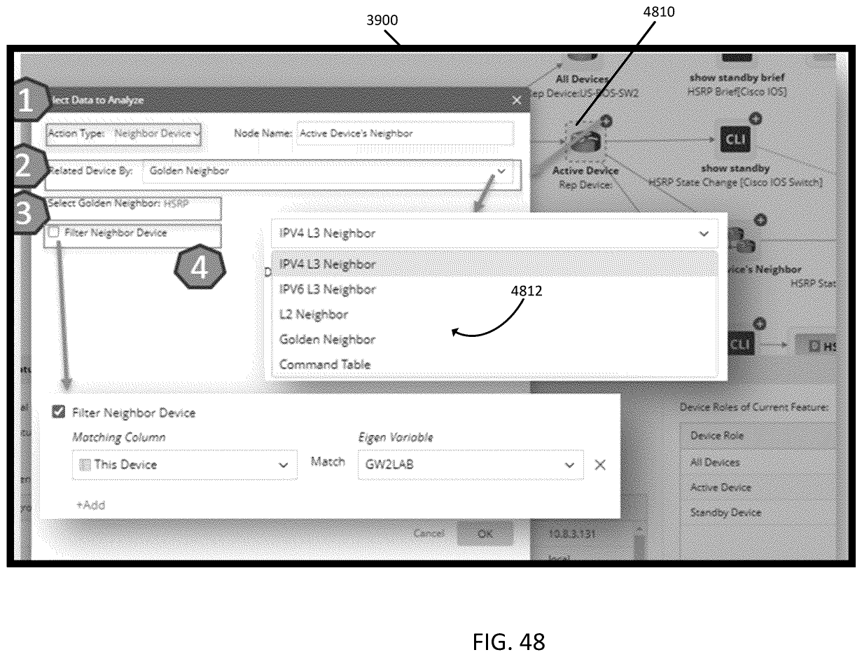

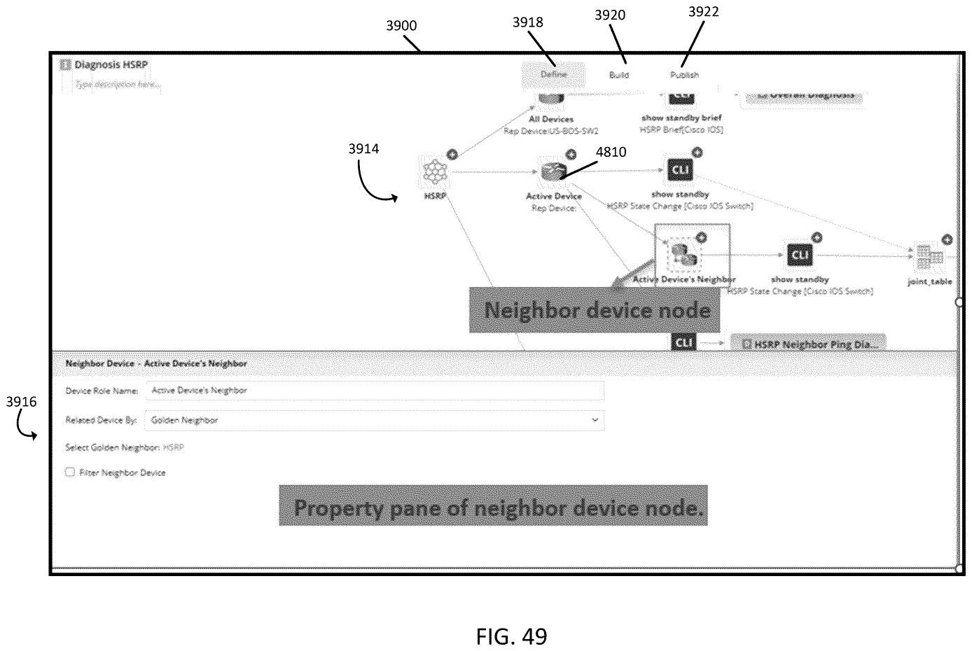

FIGS. 48 and 49 depict embodiments of the GUI 3900 where device roles defined in a feature are independent of each other and/or have no network relationship. In such a scenario, a user can extend neighbor devices from a device role node 4810. Neighbor devices may be extended based on scope 4812 (e.g., IPv4 L3 Neighbor/IPv6 L3 Neighbor/L2 Neighbor—extend all the neighbor devices based on topology; Golden Neighbor—dynamically find neighbors depending on the structure of the golden table, if a user has specified a golden neighbor table); Command Table-refer to the table variables parsed from CLI commands; Filter Neighbor Device-determine which column in the table is ‘This’ and which column is ‘Neighbor’ (when Golden Neighbor is selected)).

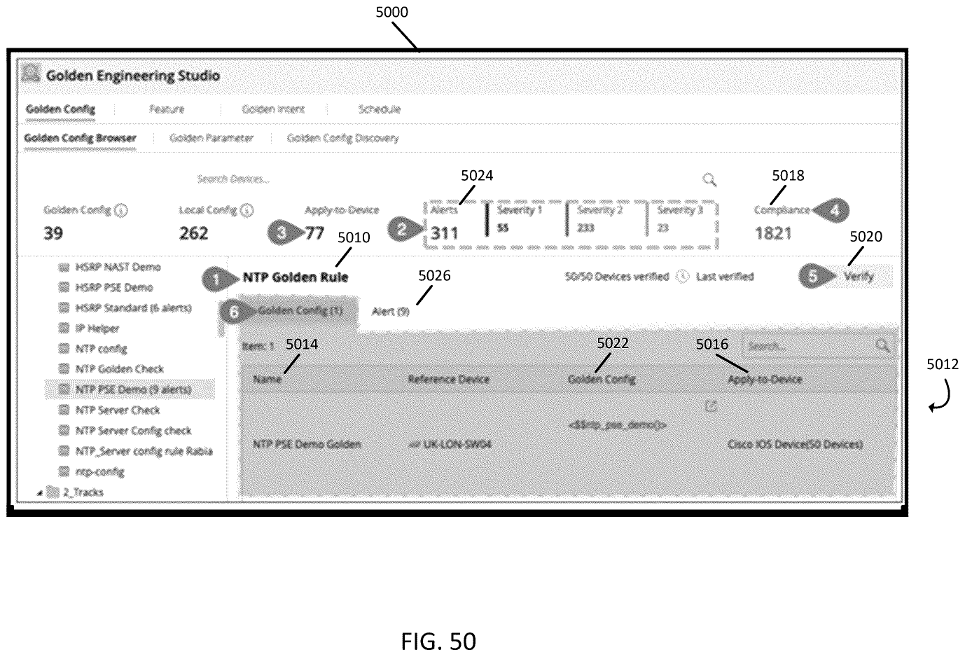

FIG. 50 depicts a nonlimiting embodiment of a GUI 5000, generated by the golden configuration browsing circuit 1914 (FIG. 19) for browsing golden configurations 2010 and/or golden configuration templates 2012. The GUI 5000 allows a user to verify a golden rule 5010 and see the results 5012 of golden configurations. Embodiments of the GUI 5000 may depict one or more of the following: rule name 5014 (the name of the currently selected golden configuration rule); apply-to-device 5016 (the collection of all devices from one or more applicable golden configuration templates); compliance 5018 (information on compliance for a golden configuration template after calculation); verify 5020 (calculations performed for the selected golden rule based on baseline configuration files); “golden configuration” 5022 (the number of golden configuration templates included in the currently selected golden configuration rule); and/or alerts 5024 (information about the number of generated alerts). Embodiments of the GUI 5000 may also provide one or more of the following: an alert tab 5026 (displays more detailed information regarding alerts related to a matched golden configuration for a device instance, where, in embodiments, if a device instance matches multiple golden configuration templates, each alert for each golden configuration template will be counted separately); a filter (provides for filtering of the results 5012 based on success and alert severity); and/or muted alerts (e.g., a representation of entries configured with muted alerts).

Referring again to FIG. 19, embodiments of the golden engineering circuit 338 enable users to define, identify, and/or discover a network's design and/or topology and generate corresponding golden configurations by forward and/or reverse engineering processes. As will be appreciated, and as explained in greater detail herein, embodiments of the golden engineering circuit 338 improve the network arts by automating and/or simplifying the discovery and/or documentation of a network's configuration and/or topology, which traditionally take network engineers days, weeks, months, and (in some cases) years to perform. For example, embodiments of the golden engineering circuit 338 may create thousands of automations without requiring coding (at the time of discovering and documenting a network's design) by a network engineer. Accordingly, embodiments of the golden configuration management circuit 1910 may include a forward engineering circuit 1920, a reverse engineering circuit 1922, and/or a discovery circuit 1924.

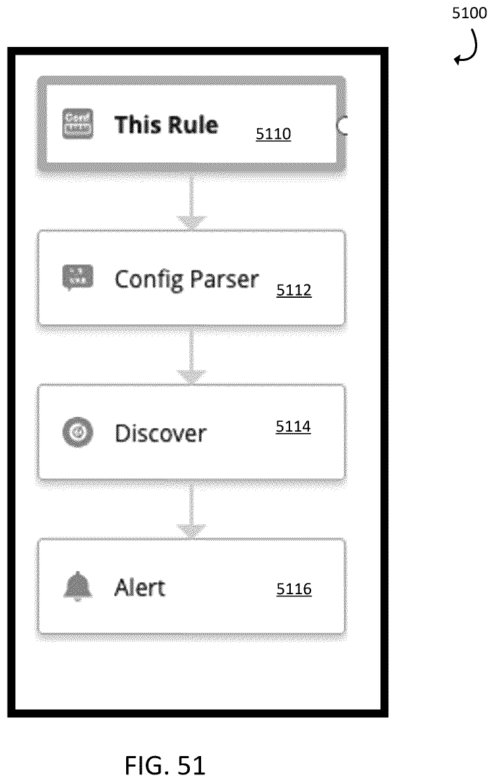

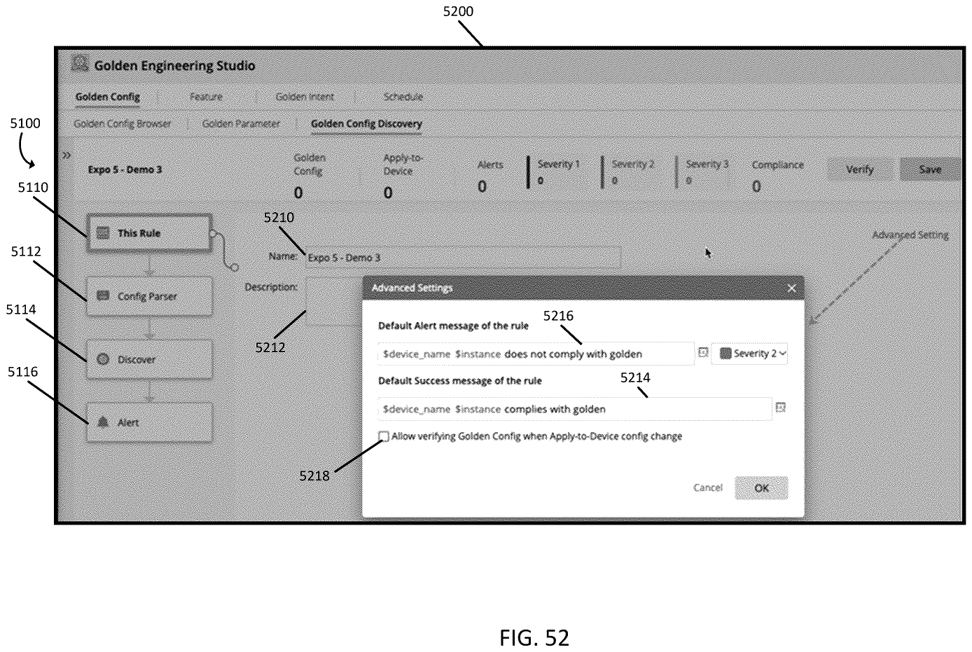

Illustrated in FIGS. 51 and 52 are aspects of an interactive workflow 5100 and corresponding GUI 5200 provided by the golden engineering circuit 338 for discovering, defining, and/or managing golden configurations 2010, in accordance with embodiments of the current disclosure. Embodiments of the GUI 5200 may represent a segment of configlet representing a standard for network design. The interactive workflow 5100 may include the following nodes/processes: “This Rule” 5110; “Configuration Parser” 5112; “Discover” 5114; and/or “Alert” 5116.

As the first node in the interactive workflow 5100, “This Rule” 5110 provides for a user to define the basic information for a golden configuration rule, e.g., name the name 5210, description 5212, etc. The GUI 5200 may also provide for a user to modify success 5214 and/or alert messages 5216 using an advanced Settings option. Golden configuration calculations may be triggered by a change analysis (CA) feature provided in advanced settings via an optional checkbox 5218. In embodiments, the CA feature is applied to the devices within the scope of an apply-to-device range. For example, when device configuration files are changed and updated to the current baseline, a configuration files' verification event will be triggered, with the results of the CA viewable in the golden configuration browser GUI 5000 (FIG. 50).

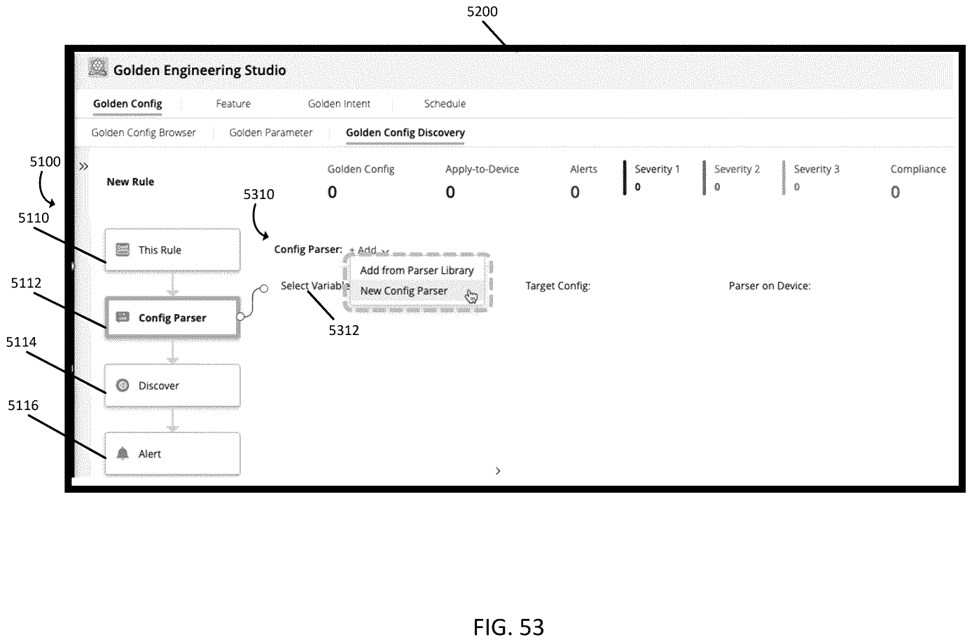

The “configuration parser” node 5112, as shown in FIG. 53, provides for the selection of a configuration parser 5310 and corresponding variable 5312 for use. Users can create a new configuration and/or select an existing configuration parser from the library.

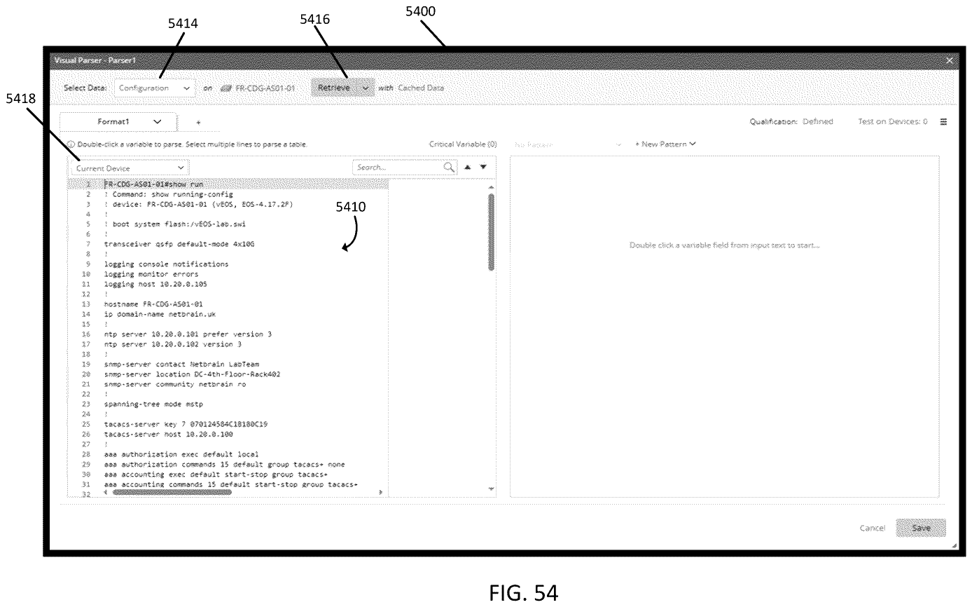

FIG. 54 illustrates a GUI 5400 for creating a configuration parser. In embodiments of the GUI 5400, configuration information 5410 appears by default, and CLI commands cannot be executed. Drop-down menus 5414, 5416, 5418 may provide for adding/selecting a device and/or retrieving the data with an (optional) default cached data selection. With the foregoing settings set, a user may then proceed to parse the variables from the data 5410.

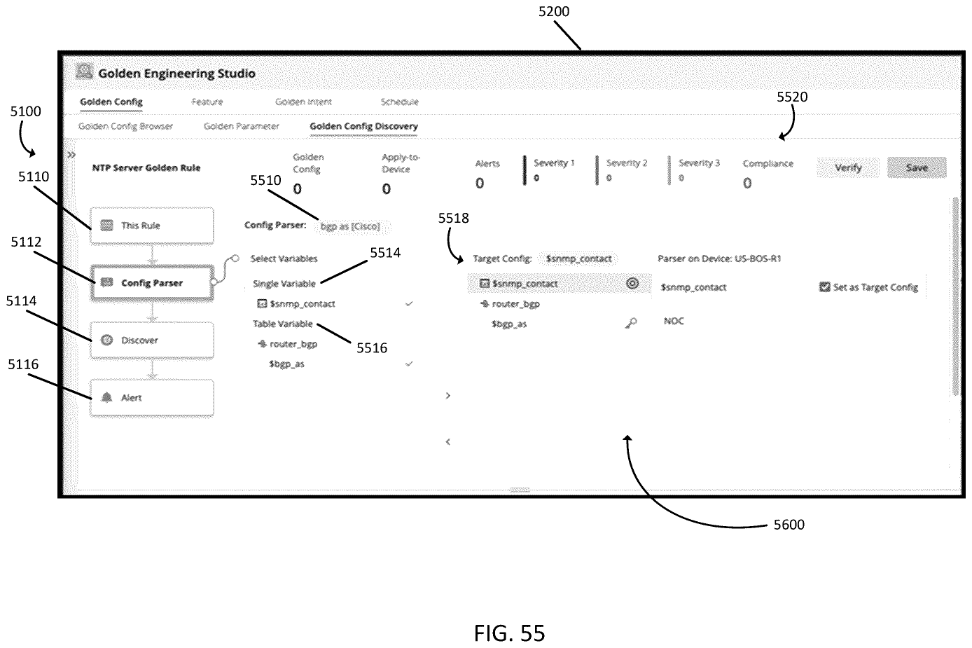

As shown in FIG. 55, once a parser is chosen 5510, it will be added to the interactive workflow 5100 with the corresponding variables (e.g., single variables 5514 and/or table variables 5516), where the variables can be selected for use with/for selection of a target configuration 5518 (for comparing with a golden config template); defining compliance/violation messages 5520; filter of configuration instances; and/or setting values for the input variables of golden parameters. The GUI 5200 may provide for selection of one of the variables as a target configuration 5518 for subsequent golden configuration definitions, calculations, and/or verifications. The selected variables may be either a single-value variable 5514 (e.g., for device-level configurations) and/or a table column variable 5516 (e.g., for instance-level config). If a configuration variable is defined at an instance level via a table column variable 5516, the target configuration may have multiple instances.

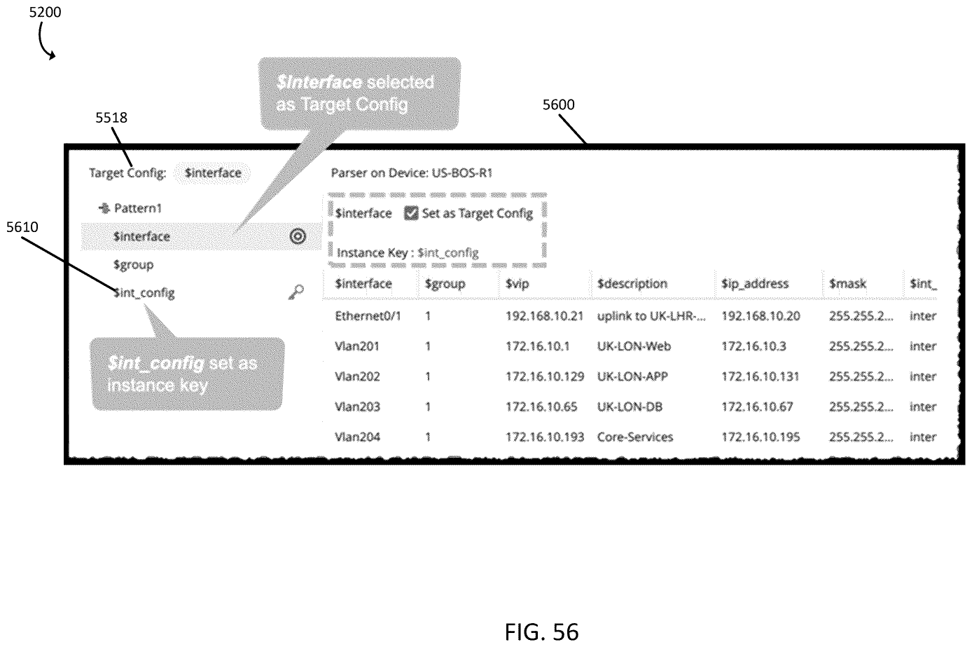

FIG. 56 depicts a portion 5600 of GUI 5200 having filled fields showing instances. A unique identifier may be set for the instance information using an instance key 5610. The instance key 5610 may define the representation and unique identification of each instance-level configuration. The instance key 5610 may be (optionally) inherited from the parser.

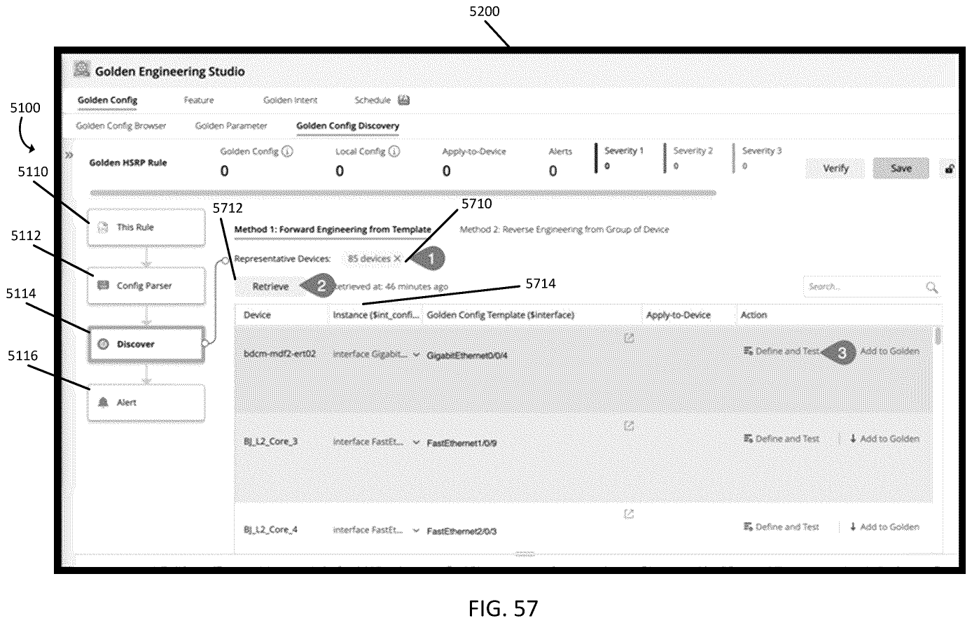

Referring to FIG. 57, the “Discover” node 5114 of the interactive workflow 5100 may provide for the discover and/or definition of a golden configuration 2010 via a forward engineer process (provided by the forward engineering circuit 1920 (FIG. 19)) and/or a reverse engineering process (provided by the reverse engineering circuit 1922 (FIG. 19)).

The “Alert” node 5116 (FIG. 51) may provide for viewing of alert information generated by a golden configuration for the selected/specified device scope.

FIG. 57 depicts an embodiment of the forward engineering process, which finds/discovers a golden configuration 2010 (FIG. 20) using a golden configuration template 2012 (FIG. 20). The forward engineering process is ideal for scenarios where a user has a golden configuration template 2012 and knows the target devices to which it should be applied. In other words, forward engineering, as used herein, is suitable for instances where an ideal and/or golden configuration 2010 for a device and/or network is known. Users may manually create the golden configuration template 2012 using static configurations, parser variables, and/or golden parameters 2020. A user should (but may not always) specify the target devices for the golden configuration template 2012 when performing the forwarding engineering process. Users may also define the applicable configuration instances for the golden configuration template 2012 by setting specific criteria. The components (subprocesses) of forward engineering a golden configuration follow.

With reference to FIG. 57, reference devices are selected 5710 and/or added (optionally). A device configuration is retrieved 5712 from a current baseline (e.g., a digital twin). In embodiments, multiple instances of the retrieved configuration are retrieved from a device and listed in the instance column 5714, allowing users to switch between instances.

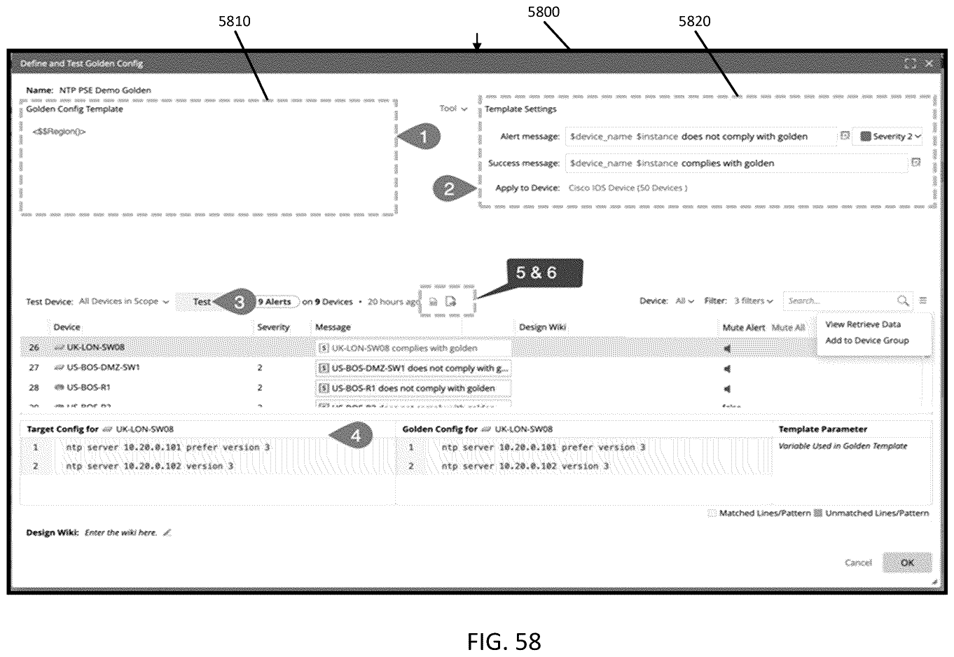

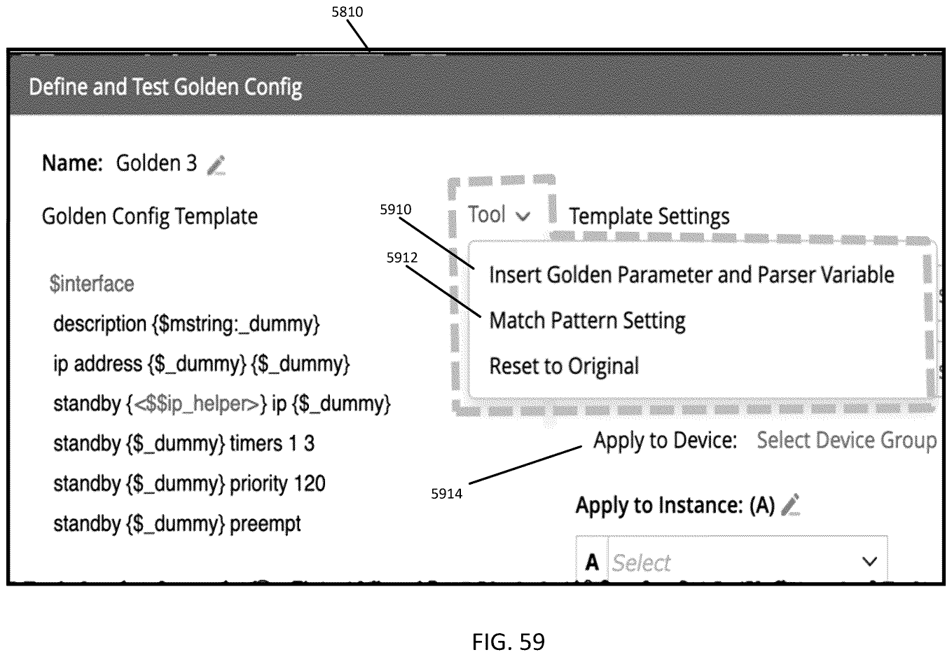

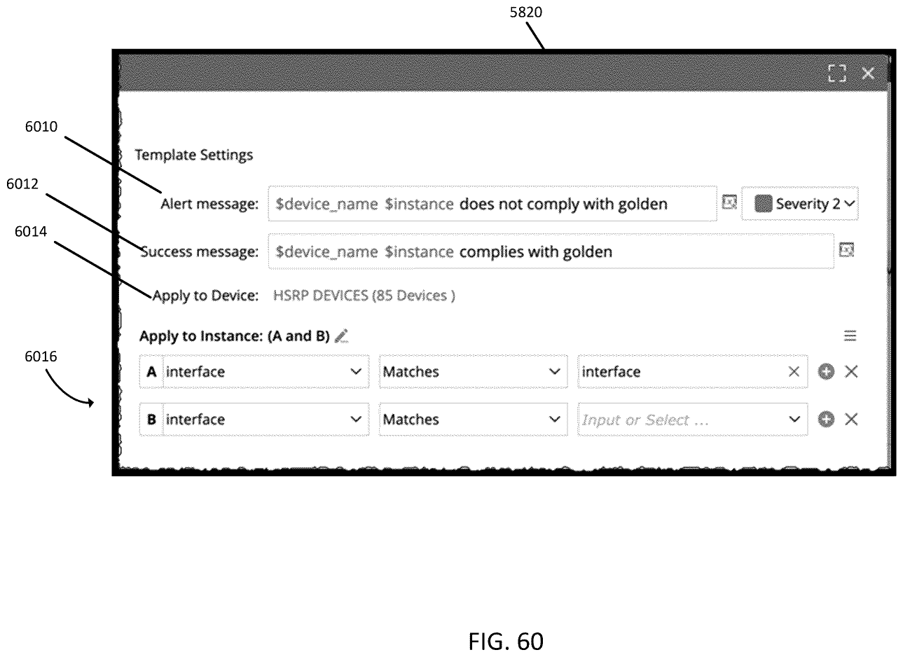

FIG. 58 depicts a GUI 5800 (which may form part of the GUI 5200) that provides for the defining and testing of a golden configuration (e.g., configuration settings and target devices), where FIGS. 59 and 60 depict first 5810 and second 5820 portions, respectively, of the GUI 5800. A user may select and/or edit a golden configuration template (e.g., via portion 5810) as a starting point for defining the golden configuration. For example, a user may add references to a parser variable (e.g., <$name>) (which may be from a currently selected configuration parser) and/or golden parameter (e.g., $$name) 5910. The GUI 5800 may also provide for the defining of verification settings. Embodiments of the GUI 5800 may provide for a user to define match pattern rules 5912 (e.g., defined patterns for comparing the target configuration against the golden configuration template, which may be functionality the same as in a network intent), messages (and corresponding severities), select devices for application 5914, and/or instance condition(s) for the golden config verification.

The referenced golden parameter 5910 may be a value identified through a parameter value defined based on a match condition. The user may set the golden parameter field to a base parameter value or a configuration parameter value.

In embodiments, the portion 5820 may provide for the user to define alert messages 6010, success messages 6012, applicable device groups 6014, and/or applicable instance conditions 6016 for the current golden configuration template. Alert messages and success messages may include variables, such as the parser variable, golden parameter information, ADT table variables, and/or match pattern return values. In embodiments, the golden configuration may be set to only the instances having one or more specified matching conditions and/or properties.

After defining the golden configuration, the GUI 5800 may provide for the user to select one or more devices and test and verify the golden configuration against them. Results of the test(s) may be displayed for evaluation by the user. In embodiments, the GUI 5800 may provide for a user to select a standard set of devices, and/or to select all devices in scope (e.g., all devices within the apply to device scope for the golden configuration). In embodiments, testing of the golden configuration template involves verifying data from the current baseline(s) against the test devices. Test results may display information in the form of X alerts on y Devices along with a timestamp. Instances set with multiple table columns as the instance key may be displayed as (value1, value2). Template parameters (e.g., values of the current variable used in the golden template, including the parser variables and/or golden parameters) may also be displayed in conjunction with the test results. In embodiments, the test results may display the comparison between the target variable of a selected device and the golden configuration computed for the device using the match patterns (as disclosed herein). The GUI 5800 may also depict an execution log showing instances that did not match filter conditions and/or corresponding messages to facilitate troubleshooting of if the golden configuration appears to be misconfigured.

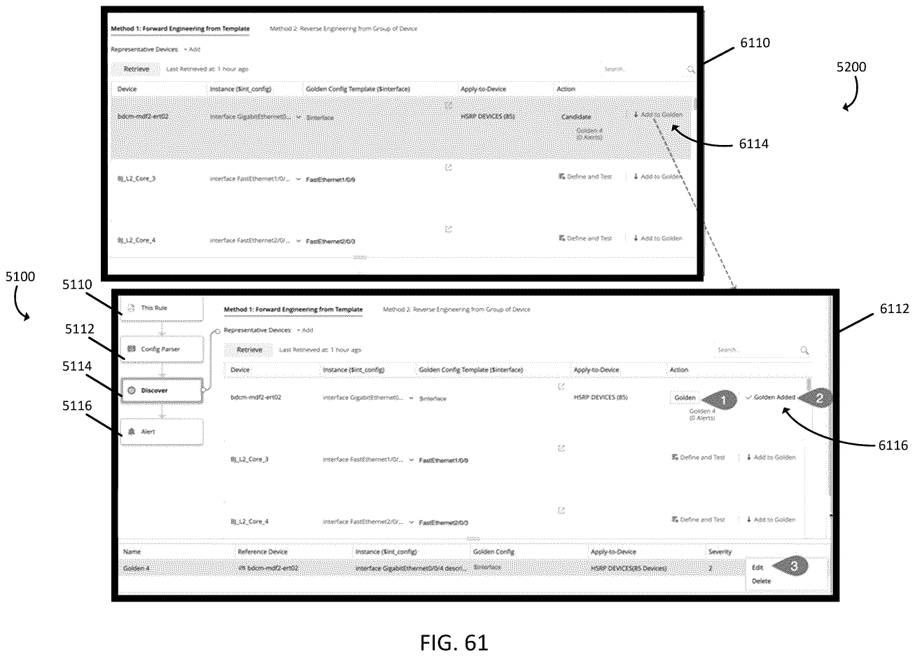

FIG. 61 depicts a transition of the GUI 5200 (FIG. 52) from a first instance 6110 to a second instance 6112 showing the addition of the golden configuration generated via GUI 5800 (after being successfully tested), where the golden configuration is absent (indicated by arrow 6114) from instance 6110 and added/adopted/present (indicated by arrow 6116) in instance 6112. As shown in instance 6112, the golden configuration's name and/or alerts generated from the last verification operation (e.g., test) may be displayed upon adoption/addition of the golden configuration into the interactive workflow 5100.

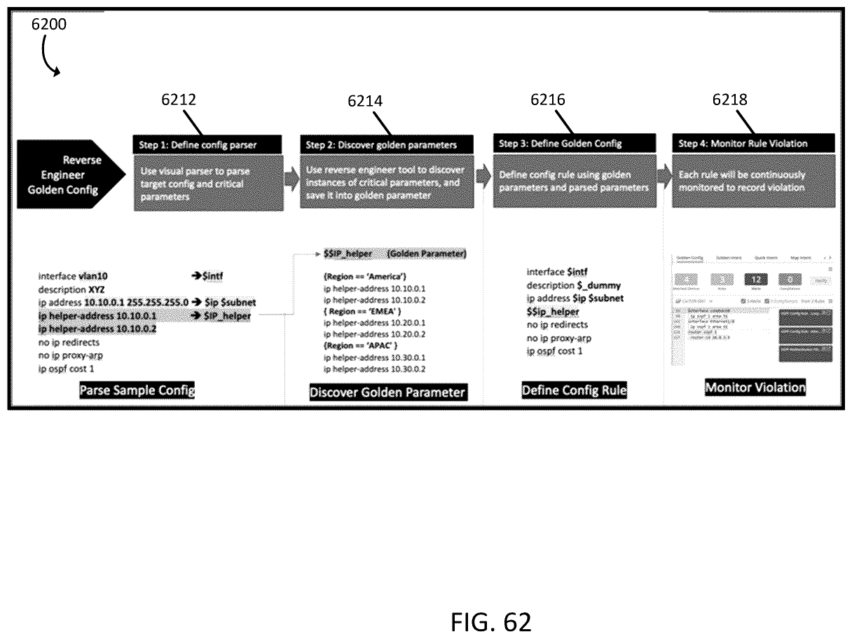

FIG. 62 depicts a nonlimiting embodiment of a process flow 6200 for the reverse engineering process (provided by the reverse engineering circuit 1922 (FIG. 19). At a high level, the process flow 6200 includes: defining a configuration parser 6212; discovering golden parameters 6214; defining a golden configuration 6216; and monitoring rule violations 6218. Defining the configuration parser 6212 may involve using a visual parser (and/or other parsing tool) to parse a target configuration and parameters. Discovering the golden parameters 6214 may involve using a reverse engineering tool (e.g., the reverse engineering circuit 1922) to discover instances of parameters and save/form them into a golden parameter(s). Defining the golden configuration 6216 may involve defining a configuration rule using the golden parameter(s). Monitoring rule violations 6218 may involve continuously running rules to identify violations.

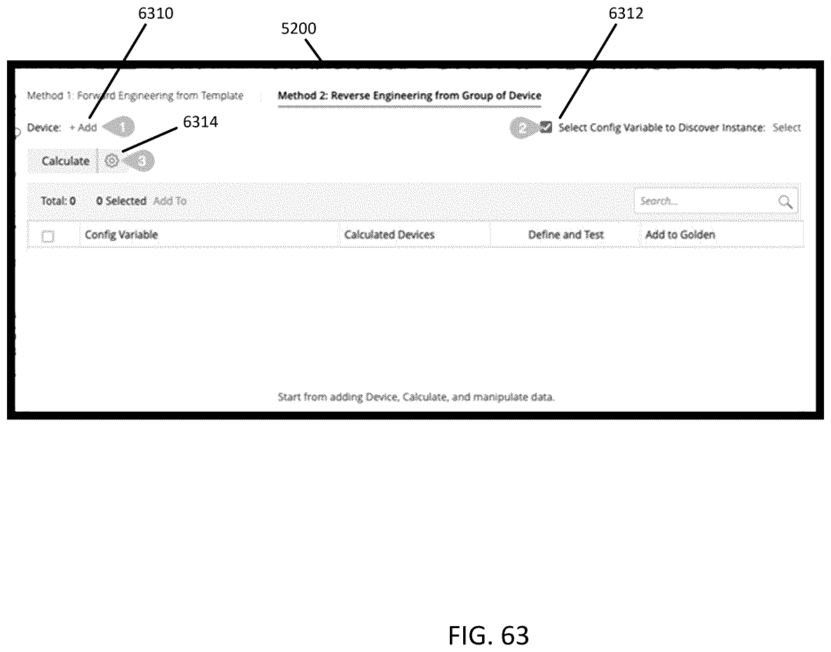

FIG. 63 depicts the GUI 5200 configured for the reverse engineering process, which provides for a user to calculate the golden configuration from a batch of devices (e.g., identifying the candidate of the golden information). Values for a target-configuration (or normalized-configuration variables) may be calculated the specified set/batch of devices, where the results are aggregated to identify the number of distinct values and the corresponding device count for each value. The values may then be sorted in descending order based on the number of devices. Configurations with a device count exceeding a pre-configured threshold, M, may be designated as candidate golden configuration templates. In embodiments, only the top N configurations determined (optionally) by another pre-configured threshold may be selected as candidates. Users can then review these candidates and choose one of the candidates as the final golden configuration template.

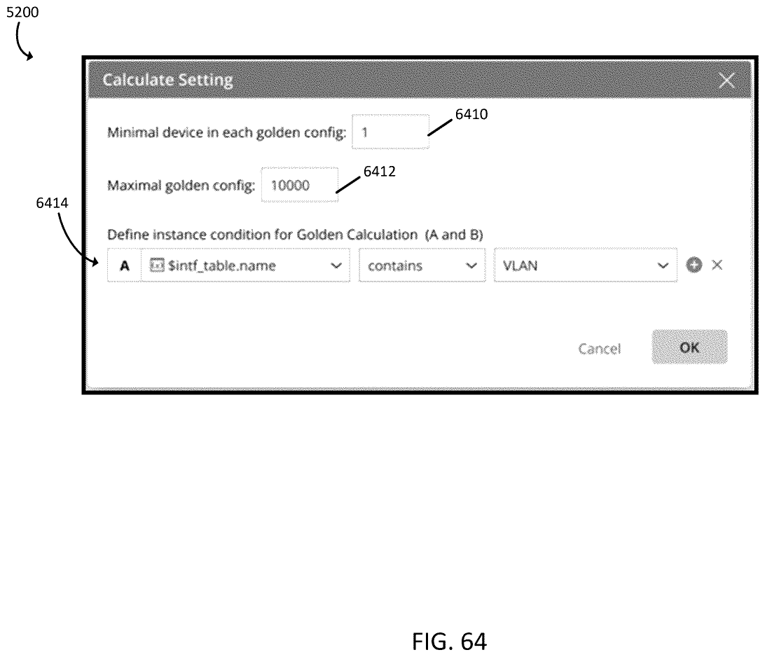

Accordingly, the GUI 5200 may include an add devices interface 6310 that provides for the selection of devices that need to comply with a current/selected golden configuration rule defined under the “This Rule” node 5110. The GUI 5200 may provide for a user to choose 6312 to select the configuration variable to discover the instance, otherwise, the target configuration variable may be directly used for performing calculation(s) 6314. In embodiments, users can modify the calculation(s) 6314 settings, as shown in FIG. 64, (e.g., the user can set a minimal device in each golden configuration 6410, a maximum number of golden configurations 6412, instance conditions settings 6414 for the calculation, and/or the like).

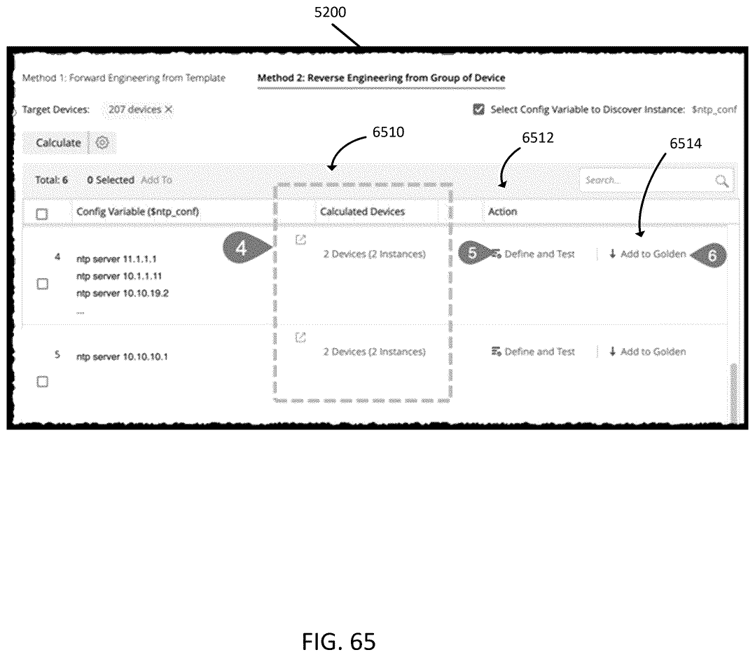

Moving to FIG. 65, upon matching the number of devices/instances conditions, the GUI 5200 may display devices instances 6510, options 6512 to define and test a golden configuration, and/or options 6514 to add to a golden configuration. In embodiments, defining and testing 6512 may be performed in a manner similar to the one disclosed herein with respect to the forward engineering process. The add to golden options 6514 provide for candidate golden configuration information (e.g., candidate golden parameters) to be moved/promoted into the golden configuration.

Embodiments of the GUI 5200 may further provide for a user to update a device scope setting (e.g., recalculation of the latest golden information based on the most recent configuration). For example, if the golden information does not completely match a calculated device scope, the GUI 5200 may provide for the updating of the device scope.

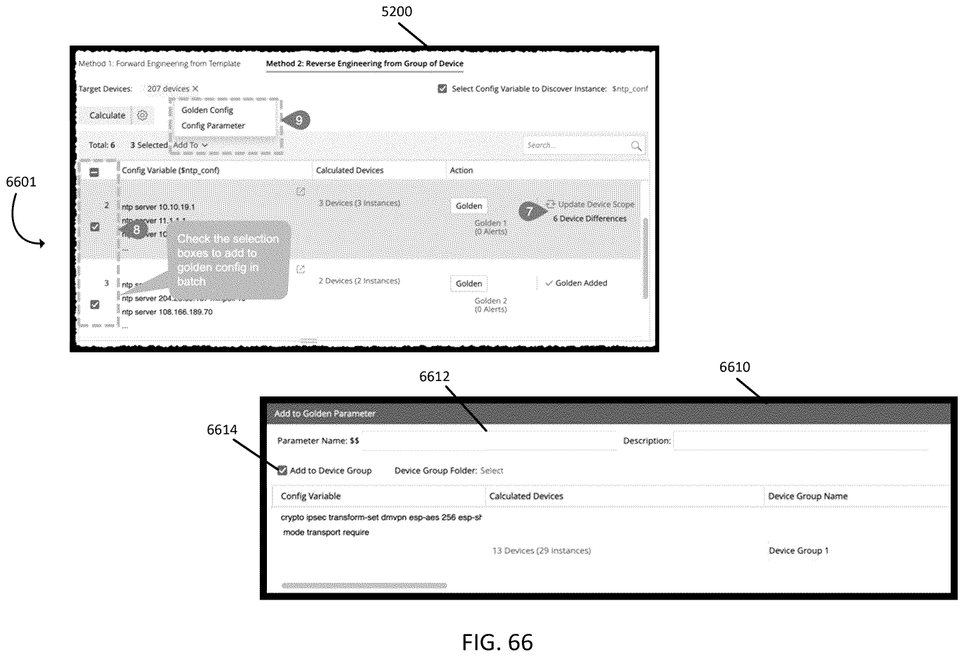

As shown in FIG. 66, embodiments of the GUI 5200 may provide for batch addition (represented by checkboxes 6601) of candidate golden configurations to an adopted golden configuration template. For example, a user may add multiple candidate golden config templates to an adopted golden configuration template at once by selecting multiple checkboxes provided on a pane within the GUI 5200. In such embodiments, when adding multiple candidate configurations to the golden configuration, the embodiments of the system 100 may check for the following: name conflicts (e.g., if two candidate configurations have identical names, the GUI 5200 may notify the user and forego adding the offending candidate configurations); existing golden configuration template (e.g., the system 100 may provide options for handling a golden configuration template that already exists; available options include: appending the new information to the existing golden configuration, overwriting the existing golden configuration with the new one, cancelling the addition process, and selectively adding items to a golden parameter.

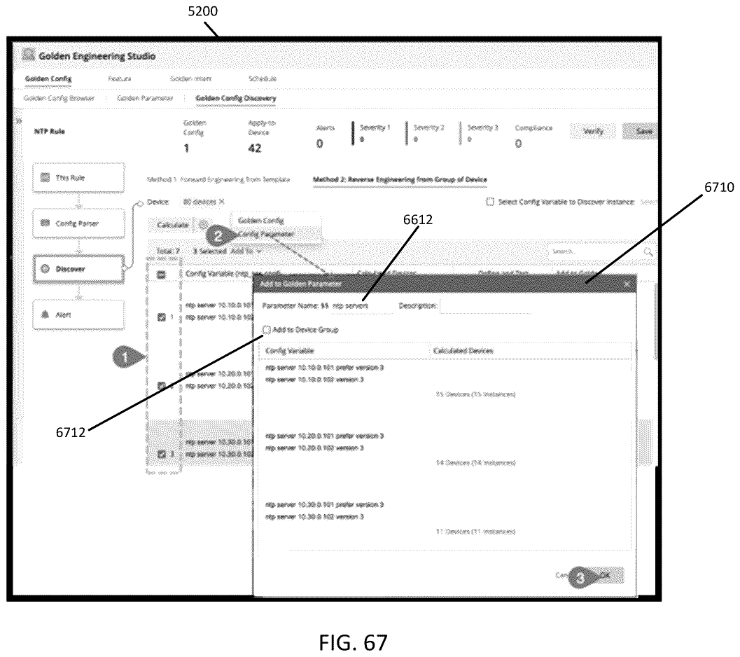

FIGS. 66 and 67 depict two instances 6610 and 6710 of a window of the GUI 5200 for selecting candidate golden configuration templates and adding golden parameters via a selection box 6612 (shown in both FIG. 66 and in FIG. 67). Instance 6610 of the window is shown when a user desires to add golden parameters to a device group (e.g., check box 6614); whereas instance 6710 is shown when a user does not want to add the golden parameters to a device group (e.g., “unchecked” box 6712).

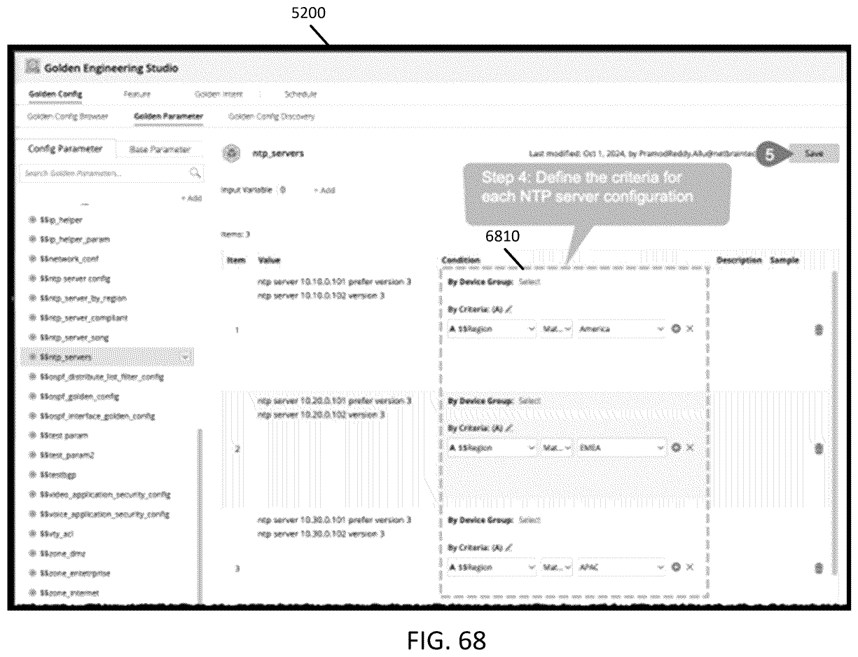

FIG. 68 depicts a scenario where a user can select multiple golden configuration items for a NTP server as golden parameters, where the user can then define criteria 6810 to match against actual NTP server configurations.

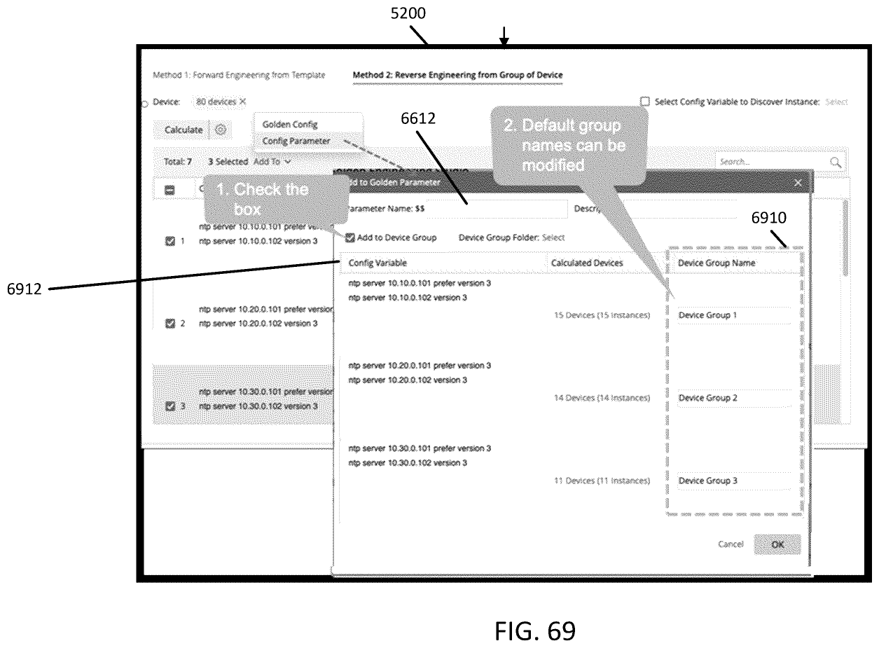

FIG. 69 depicts a scenario where a user creates a new device group 6910 with the calculated devices for each corresponding configuration variable 6912. The newly created device groups 6910 appear along with default names.

Accordingly, and as disclosed herein, a non-limiting embodiment of the current disclosure includes system 100 for identifying a golden configuration via reverse engineering. Nonlimiting examples of reverse engineering include retrieving configuration files from multiple related network computing devices and finding commonalities. For example, in embodiments, the system includes at least one processor and a memory device. The memory device stores an application that, when loaded into the at least one processor, causes the at least one processor to: interpret a first user command; and, in response to the first user command, display a portion of a configuration file of a network computing device. The application may further cause the at least one processor to: interpret a second user command; and, in response to the second user command, select a configuration setting within the portion of the configuration file. The application may further cause the at least one processor to interpret a third user command; and, in response to the third user command, identify one or more groups of network computing devices based at least in part on the selected configuration setting. The application may further cause the at least one processor to interpret a fourth user command; in response to the fourth user command, select a common configuration setting of one of the one or more groups of network computing devices as a golden configuration; and at least one of transmit the golden configuration or store the golden configuration in a database.

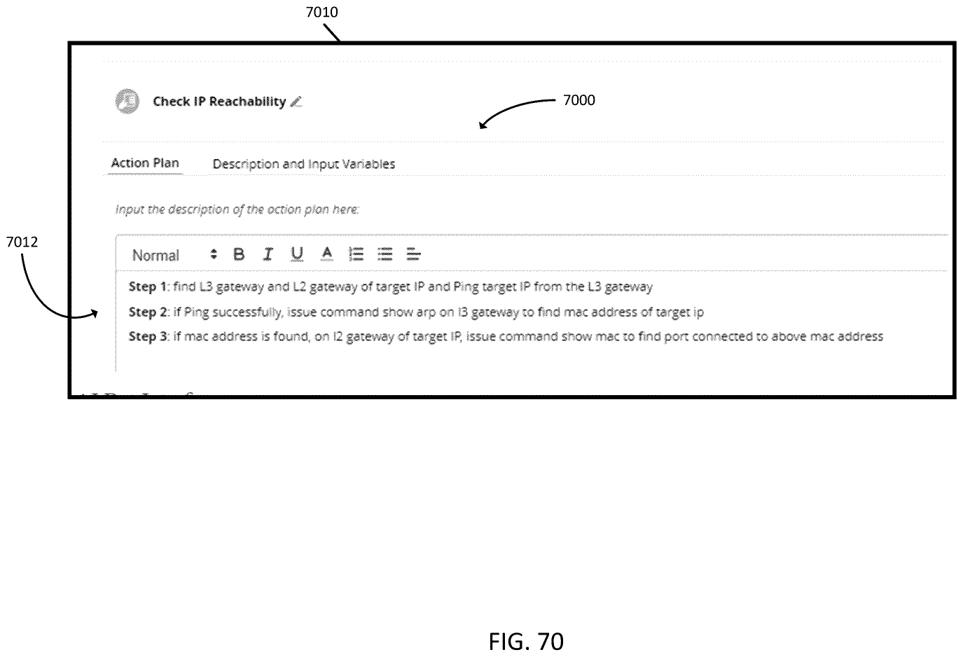

Embodiments of the current disclosure also provide for the automation and/or simplification of preventing, mitigating, and/or resolving network issues/problems (e.g., loss and/or degradation of network services). Such embodiments utilize action plans to handle (and/or assist network engineers and technicians) in handling/resolving network issues. Accordingly, the action plan management circuit 340 (FIG. 3) stores actions plans. An action plan 7000, as disclosed herein and as shown in GUI 7010 in FIG. 70, may include sequences of predefined steps 7012 described in natural language, which the orchestration circuit 312 (FIG. 3) and/or the artificial intelligence circuit 362 (FIG. 3) can interpret and/or execute via the execution engine 330 (FIG. 3). An action plan may include combinations of commands, data gathering operations, comparison operations, and/or analysis steps. An action plan, as disclosed herein, may also store and/or identify, store operations for troubleshooting and/or resolving network issues.

In embodiments, a user can invoke stored operations (e.g., include action plans and/or network intents) through natural language requests in multiple ways. The user may directly reference a stored operation by name, such as requesting execution of a specific security assessment action plan. Alternatively, a user may describe their desired outcome in natural language, allowing the system 100 to match the request with appropriate stored operations. The orchestration circuit 312, aided by the artificial intelligence circuit 362, may determine whether to execute a stored operation and/or to perform a new sequence of actions based on the user's request.

In embodiments, when a user invokes a stored operation, the system 100 may process the request through several stages. For example, as a non-limiting example, the orchestration circuit 312 first identifies the referenced operation and retrieves its definition. For action plans, this may include the natural language description of required steps. For network intents, this may include the defined automation parameters and/or execution requirements. Next, the orchestration circuit 312 and/or the artificial intelligence model 362 generates appropriate API calls to execute the operation, maintaining the same validation and security controls used for direct commands.

Embodiments of the system 100 may support parameterization of stored operations, allowing users to specify variables through natural language. For example, a stored security assessment action plan may accept target devices as parameters, allowing users to specify which devices to assess through their natural language request. The artificial intelligence model then interprets these parameters from the user's request and incorporates them into the generated API calls.

Stored operations may be scheduled for repeated execution through the natural language interface. For example, a user can specify execution schedules using natural language, such as requesting an operation to run periodically or at specific times. The system 100 maintains these schedules and/or executes the operations accordingly, storing results for later review and comparison.

Results from stored operations can be displayed in various formats, including dashboards that update automatically with new execution results. Users can interact with these results through natural language queries, requesting additional details or initiating follow-up operations.

In complex troubleshooting cases, the orchestration agent's 914 response might not adequately address the problem due to lack of network knowledge (e.g., context data). To automate the diagnosis, users can leverage the action plans to describe the troubleshooting steps in natural language, allowing the orchestration agent 914 to follow the steps to identify potential root causes of the network issue.

As will be appreciated, embodiments of the system 100 that provide action plans, as disclosed herein, improve the network management arts by providing an easy way for users to translate human knowledge into actionable steps, convert human network knowledge into automated troubleshooting, and/or customize the orchestration agent's 914 response.

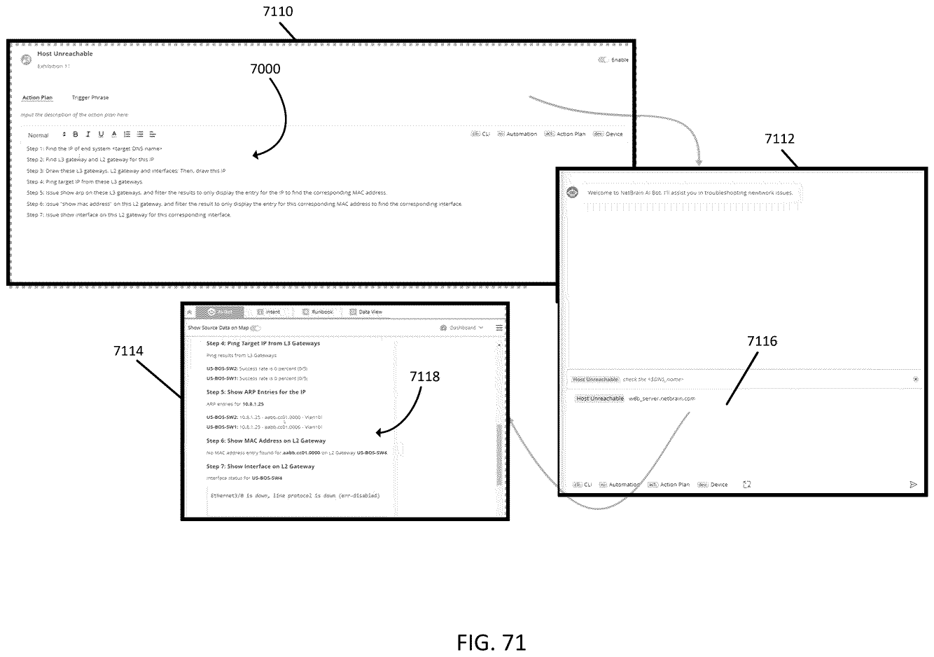

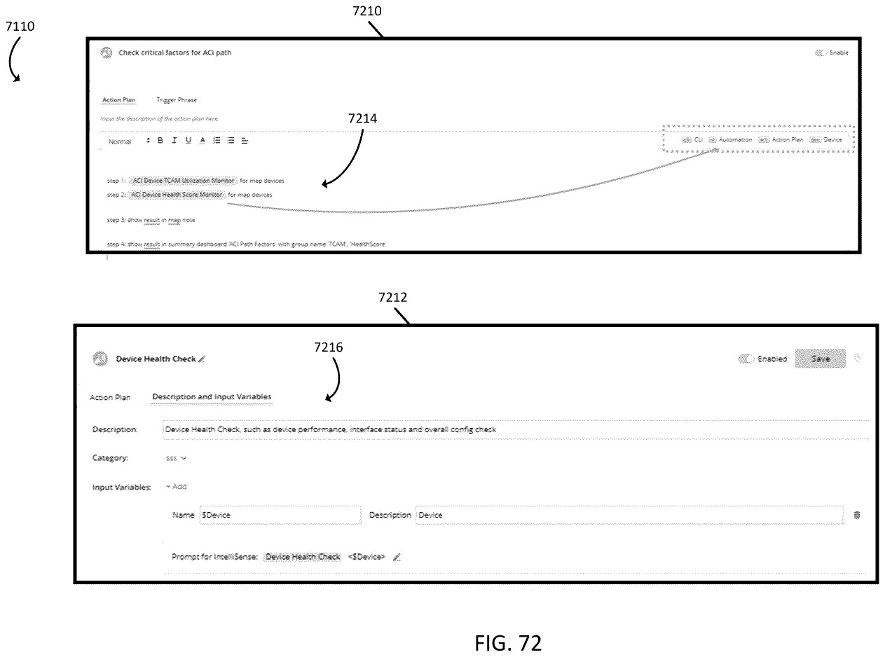

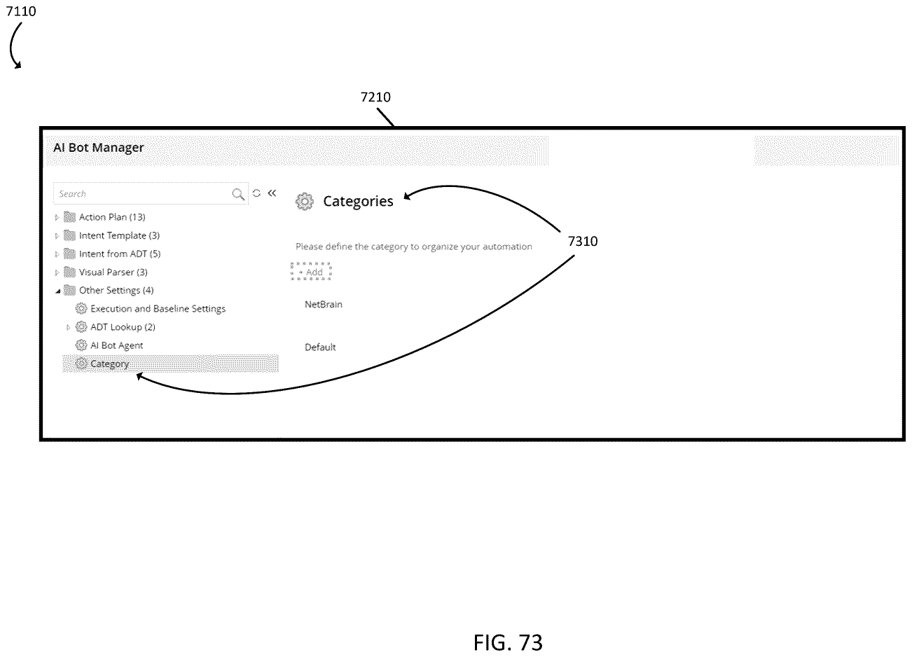

FIG. 71 depicts a series of GUIs 7110, 7112, and 7114 showing a non-limiting scenario in which a user chats with the orchestration agent 914 via a chat portal 7116 to generate an action plan 7000. As will be understood, GUI 7110 depicts the action plan 7000 and GUI 7114 depicts responses 7118 from the orchestration agent 914 (FIG. 9). FIG. 72 depicts two instances 7210 and 7212 of GUI 7110, where instance 7210 provides for a user to tag a device, automation, CLI, and/or or even another action plan in plain text 7214, and instance 7212 provides for a user to define a corresponding description, category, and/or input variable 7216 to help the orchestration agent 914 (FIG. 9) extract input variables from user input (e.g., the text 7214). Embodiments of the instance 7210 may provide for a user to create categories to organize action plans and/or automations. The instance 7210 may also provide for the user to define the data source for the CLI tool, automation tool, and/or NIT replication. For example, the instance 7210 may provide for users to specify the data that the CLI tool will use as the baseline for comparison. As shown in FIG. 73, the instance 7210 may provide for a user to create categories 7310 to organize action plan and/or automations. Embodiments of the instance 7210 may also provide for searching of action plans, either by a user or by the orchestration circuit 914, where matched action plans may be sent to the artificial intelligence circuit 362 (optionally) along with the search criteria (input) used to identify the matched action plans.

Referring again to FIG. 3, the remediation circuit 336 (FIG. 3) is structured to facilitate repair and/or mitigation actions upon the discovery of noncompliant devices (e.g., devices that violate a golden rule) and/or encountering a network issue, as disclosed herein. The remediation circuit 336 may perform one or more remediation actions (to address a network issue) which may involve use of network intents, golden configurations, and/or action plans, as disclosed herein.

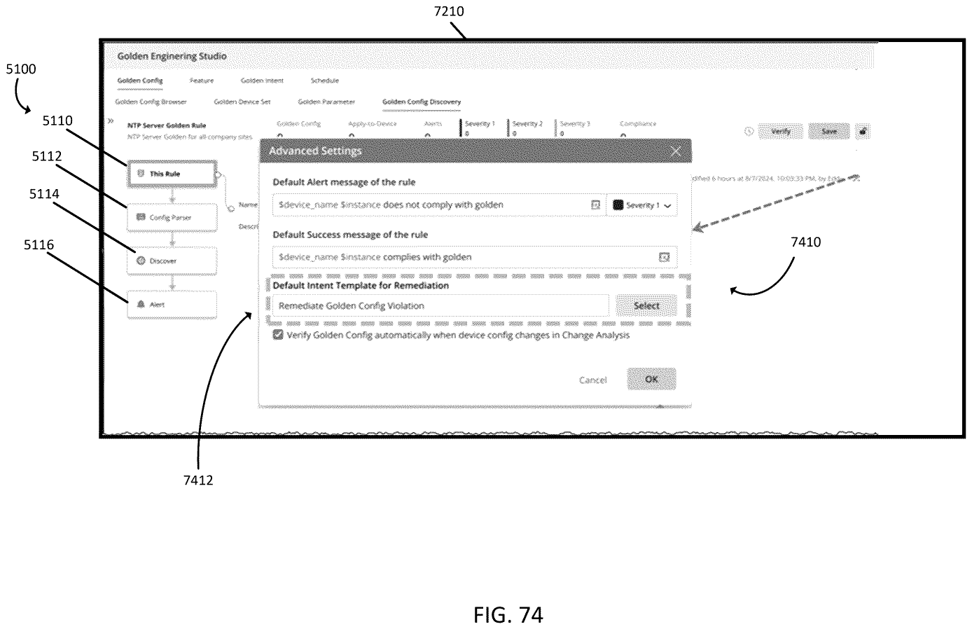

For example, with reference to FIG. 74, embodiments of the GUI 5200 under the “This Rule” node 5110 may utilize one or more aspects of the remediation circuit 336 (FIG. 3) to set up auto-remediation settings 7410. Such settings 7410 may execute a golden intent that runs a golden configuration against a golden feature (a group of one or more devices) and/or against configuration type on a device. After evaluating the differences/discrepancies, the user can create configlets to resolve detected issues. Users may also set a default intent template 7412 to remediate devices.

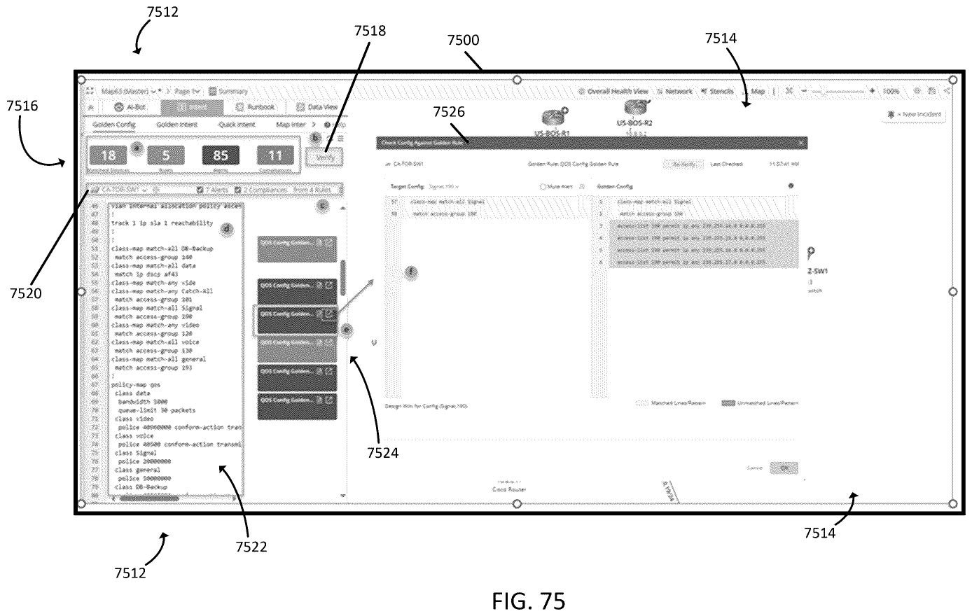

Referring now to FIG. 75, embodiments of the system 100 (FIG. 1 and FIG. 3) may provide for a GUI 7500 that integrates a golden configuration pane 7512 with a network map pane 7514. Embodiments of the GUI 7500 may show and/or provide access to: summary information 7516; verification and/or reverification of a golden configuration rules 7518; summary information for a specific device 7520; configuration lines 7522; instances of applied golden configuration rules 7524; and/or a window 7526 for checking a golden configuration against a golden configuration. The summary information 7516 may include the count of matched devices, the count of golden configurations rules matched to the devices, and/or the count of alerts/compliances from golden configuration checks. Verification and/or reverification of a golden configuration rules 7518 may be manually performed against one or more of the golden configuration rules via batching to get the latest/current results. Summary information for a specified device 7520 may include the statistical data for a specified device, including the number of golden configuration rules applied to the device, the count of alerts and/or the count of compliances generated by the device against the golden configuration rules. The configuration lines 7522 may depict the full configuration of the selected device. The instances of the applied golden configuration rules 7524 depicts configuration rules matching the device and may be identified by unit of instance. A ‘Golden Config Rule Check Note’ and/or other types of indicators may be used to indicate compliance status. For example, embodiments of the current disclosure may use a color-coded scheme to indicate the golden configuration check results (alert/compliance) (e.g., green to show compliance, red to show a violation, yellow to show unknown, etc.). Window 7526 may display the details of golden configuration check results for each configuration instance, and provide visual verification of the current golden rule.

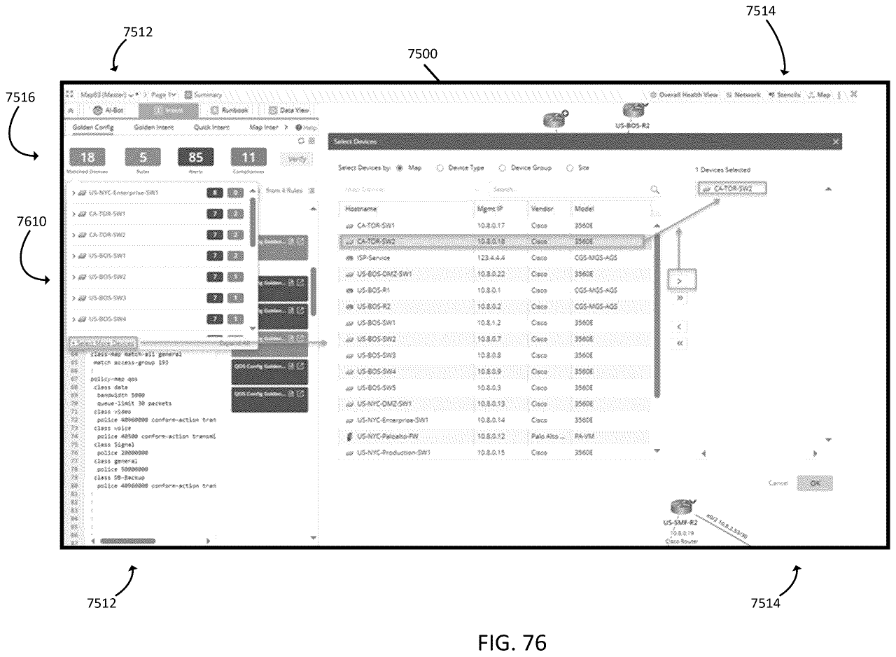

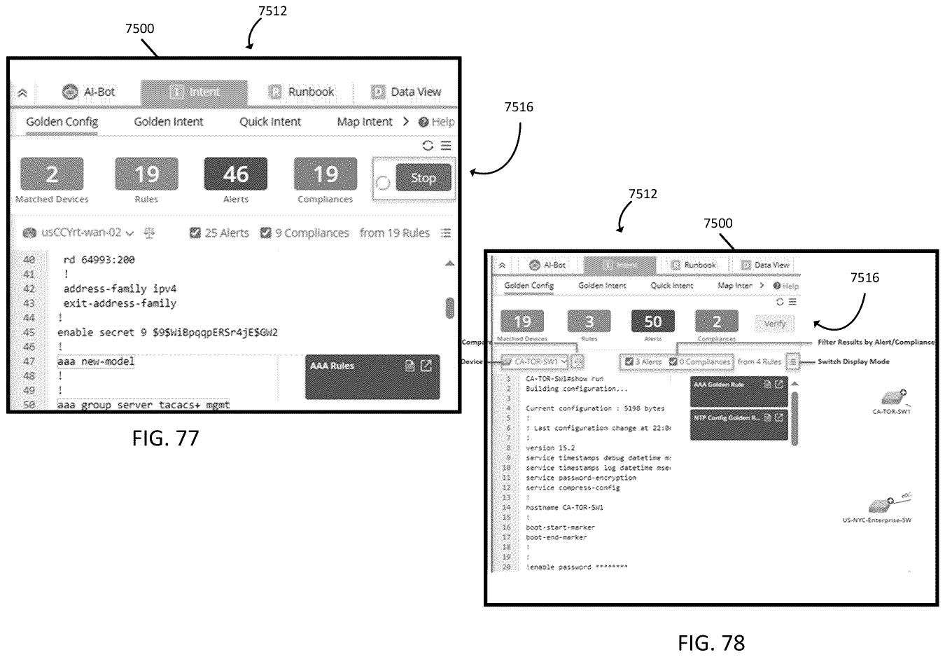

In embodiments, golden configuration check results shown in the golden configuration pane 7512 may be generated from one or more of the following sources: golden configuration checks triggered by a change analysis event, and/or users manually verifying the golden configuration rule. Embodiments of the golden configuration pane 7512 may also support adding additional devices (to view related golden configuration check results) 7610 (FIG. 76). In embodiments, the summary information 7516 may be updated accordingly. In embodiments, the data in the golden configuration pane 7512 may be manually refreshable in real-time (or near real-time), and/or the golden configuration rules may also be verified and/or reverified via batch processing as shown in FIG. 77; and, as shown in FIG. 78, users may be able to view the golden configuration check results for one matched device at a time, where the GUI 7500 may further provide for the selection of a device, the filtering of results by alert and/or compliance, comparison the data, etc.

As will be understood, embodiments of the current disclosure may include one or more components, circuits, and/or features of the foregoing examples (e.g., the components of system 100 shown in FIG. 3). It will be further understood that embodiments of the circuits disclosed herein may include one or more aspects of and/or perform one or more features of the other circuits disclosed herein. Further still, embodiments of the various circuits disclosed herein may be embodied by and/or form part of the apparatus 200 (FIG. 2).

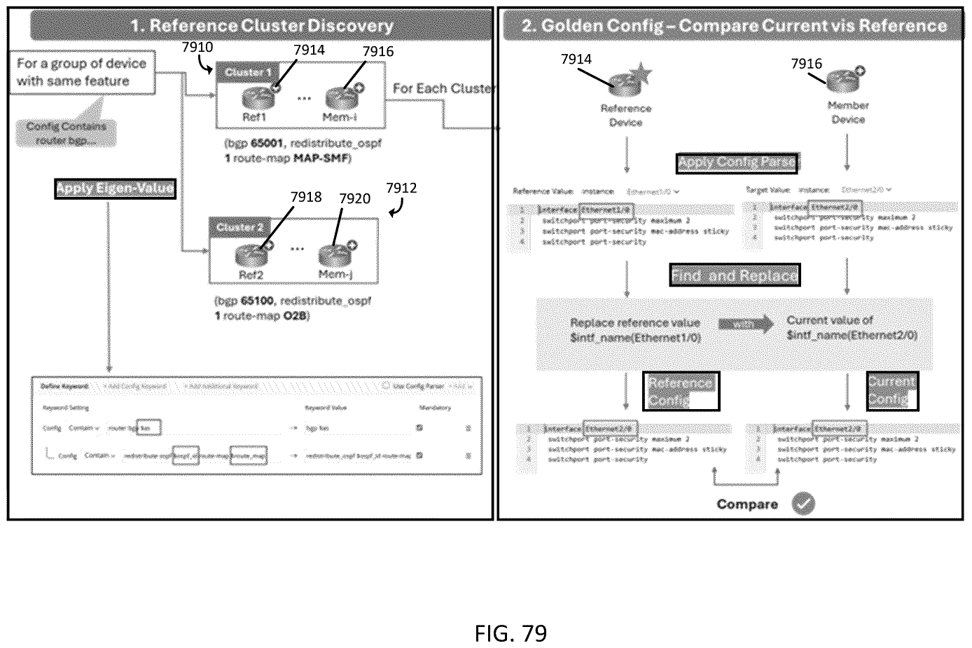

Referring to FIG. 79, embodiments of the current disclosure may also provide for the use of golden assessments, as opposed to and/or in addition with, reverse engineering (as disclosed herein), to identify clusters 7910, 7912 of devices 7914, 7916, 7918, 7920 having the same and/or similar configurations for particular network properties, which can then be used to generate a standard against (e.g., an assessment and/or golden configuration) which other target configurations (e.g., of devices within or exterior to a cluster) can be compared to determine network drift, e.g., movement over time of network device configurations from a desired state, e.g., a golden configuration. For example, a user (and/or computer) can define a golden assessment structured to identify clusters 7910, 7912 of devices based on their assigned properties (e.g., a primary NTP server), where each cluster 7910, 7912 includes devices 7914, 7916, 7918, 7920 having the same primary NTP server (e.g., device 7914 and 7916 in cluster 7910 may be assigned the same NTP server). The user (and/or computer) can then select, for each cluster 7910, 7912, one or more representative/reference devices (e.g., device 7914 for cluster 7910) which can then serve as a baseline to compare against other target configurations (e.g., configurations of other network devices (e.g., device 7916) that serve similar network roles and/or are in a similar network group policy object). In other words, golden assessments may provide for users to select a reference device 7914 to represent a cluster of devices 7910, 7912 with the same (or similar) feature(s) and then use the configuration associated with the feature(s) of the reference device 7914 as a golden configuration for comparison.

As will be appreciated, and as explained in greater detail herein, the embodiments described herein provide new technical benefits that improve several aspects of network management. For example, embodiments disclosed herein include a new approach for discovering reference clusters (e.g., clusters 7910 and 7912) by intelligently grouping network devices that share common operational or configuration features, facilitating improved consistency and standardization across network deployments. By identifying clusters of devices with similar characteristics, the embodiments of the current disclosure enable efficient and precise selection of a representative device within each cluster as the golden configuration, informed by dynamically selected reference devices based on defined criteria, such as configuration keywords or patterns. This dynamic selection ensures flexibility and adaptability, allowing network administrators to rapidly accommodate evolving network conditions or configuration standards. Embodiments described herein further offer significant operational benefits, including reducing the manual effort typically required to maintain configuration consistency, minimizing errors through automated reference management, and promoting faster troubleshooting and compliance validation. In certain aspects, embodiments of the current disclosure provide an enhanced and scalable framework for evaluating and managing networks, resulting in improved network reliability, reduced operational expenditures, and more efficient utilization of network administration resources.

Further, embodiments disclosed herein provide substantial benefits through feature-based device grouping and assessment by utilizing the grouping of network devices according to their support for specific features, thereby allowing users to rapidly identify commonalities and effectively derive golden configurations tailored to each distinct group. This approach reduces complexity and manual oversight, enabling faster, more precise assessments. The system and methods accommodate variables prone to frequent changes, such as interface names, thereby ensuring reusability of configurations without manual user intervention.

Building and/or performing a system of network assessments via golden assessments may include: defining assessment features (also referred to herein simply as features); discovering reference clusters; and/or defining an assessment rule for a golden configuration comparison.

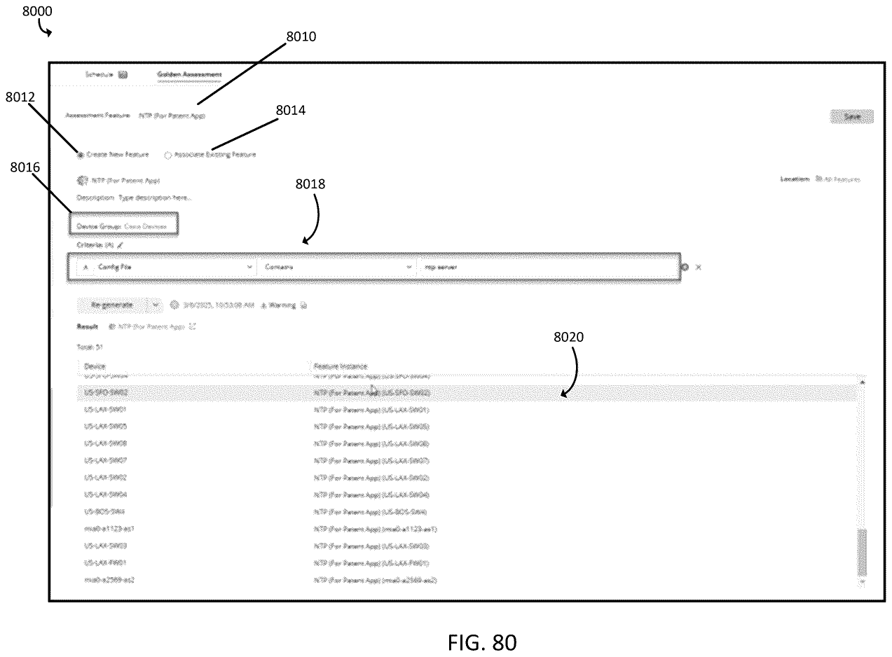

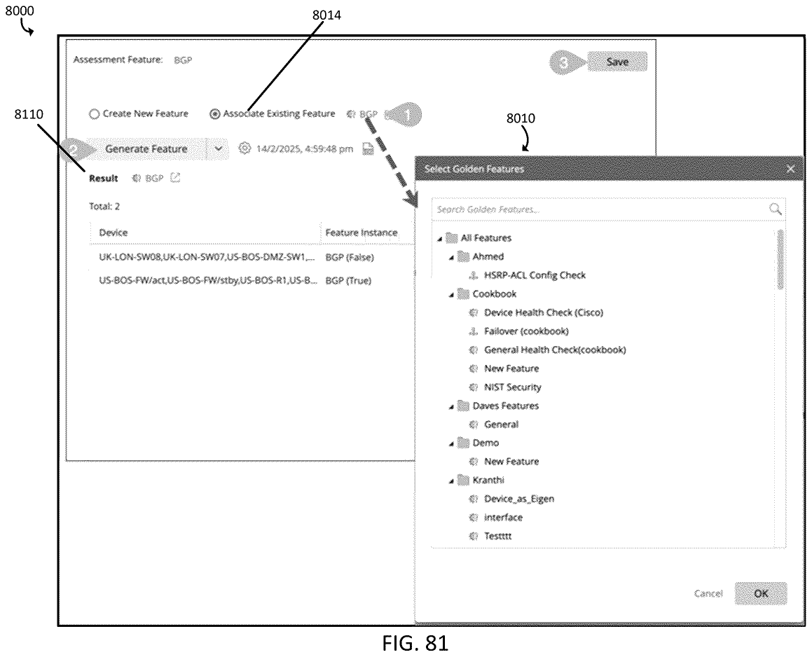

Referring to FIG. 80, a graphical user interface 8000 for defining assessment features 8010, in accordance with embodiments of the current disclosure is shown. The GUI 8000 may provide an option to create 8012 a new golden assessment feature or associate 8014 (also shown in FIG. 81) an existing feature with a golden configuration and/or assessment. The GUI 8000 may include a group selection option 8016 to define a group of devices and/or an input region 8018 to enter search criteria to filter a list 8020 of devices falling within the group 8016. Non-limiting examples of the search criteria include: a device type, a device vendor, a device model, a software version, a geographic location, a site identifier, a node role, a fabric membership, a tenant identifier, a routing protocol, a security policy type, an interface type, an interface attribute, a neighbor relationship, a hostname pattern, an IP address range, a virtual routing and forwarding instance, a configuration tag, a service type, and/or a parser-derived configuration parameter. For any network feature that a user wishes to assess the configuration and state, the user can define an assessment feature via the GUI 8000 via defining the device scope (e.g., group 8016 and/or criteria 8018). Non-limiting examples of assessment features 8010 include: supported network protocols (e.g., BGP, OSPF, NTP, DNS, IMAP, and/or any other network protocol at any level of the TCP/IP stack and/or the Open Systems Interconnection (OSI) model); device manufacturer; device type (e.g., layer 2/3 switch, router, frame relay, mail server, web server, firewalls, traffic shaper, virtual private network (VPN), gateway, intrusion detection system (IDS), and/or any other type of network computing device); and/or configurations thereof and/or any set of device properties that can be used to identify/group one or more network computing devices. For example, an assessment feature 8010 may be used to identify: all devices running the BGP routing protocol; all devices having a configured NTP server, etc. The scope of devices, as used herein with respect to an assessment feature, may include the range, number, and/or types of devices captured by the assessment feature.

To define an assessment feature, embodiments of GUI 8000 may provide for a user to select one or more devices based on the intersection of a group of devices and one or more criteria (e.g., filtered device listing 8020). For example, to define an NTP feature for all Cisco devices, a user may select a device group 8016 which includes all Cisco devices and define the criteria as Config File contains “ntp server”.

As shown in FIG. 81, after a feature 8010 has been generated/defined and/or otherwise entered, embodiments of the current disclosure may then display the results 8110 (e.g., a list of devices and their corresponding feature instances that match the defined criteria).

In embodiments, the GUI 8000 may provide for the discovery of reference devices where, for each assessment feature, the user and/or computer may divide the devices into clusters of devices and discover, identify, and/or select a reference device for each cluster. For example, a user interested in BGP devices may define a keyword, e.g., “router bgp $as” to find the bgp AS number, $as, from the device configurations and use the value of $as as the Eigen-Value to divide the identified BGP devices into clusters, e.g., each cluster may include devices having the same $as number. Embodiments of the current disclosure may also provide for the user to statically select or ask the system to select a reference device for each cluster. As explained in greater detail herein, the configuration(s) of the identified/selected reference device for a cluster may be used as golden configuration applicable to all devices in the cluster.

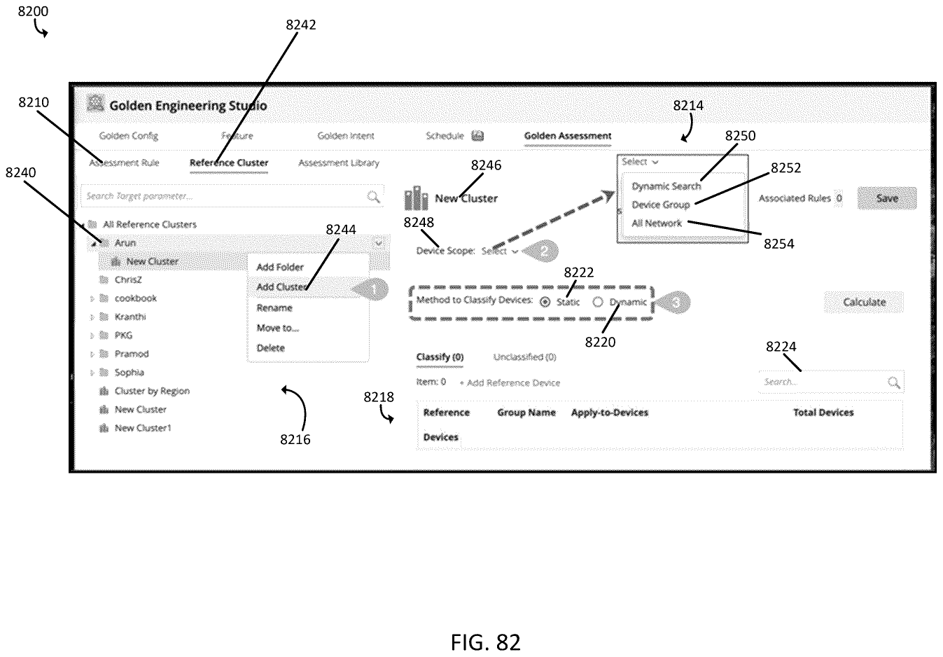

With reference to FIG. 82, a graphical user interface 8200 is shown in accordance with embodiments of the current disclosure. GUI 8200 may provide for a user to define an assessment rule 8210 for comparing against a golden configuration. Assessment rules, as disclosed herein, provide for a user to define a target configuration (e.g., a configuration for a device that is to be tested against a reference device and/or a golden configuration). As will be appreciated, a device's configuration may include values (e.g., interface name) that differ across devices but are not relevant to determining whether the configuration conforms to the reference device and/or golden intent. In such scenarios, GUI 8200 may provide for a configuration parser to find and replace such variables in the reference device's configuration (e.g., in a copy thereof used during the comparison process) prior to comparing the target configuration of the member devices with the configuration (or copy thereof) of the reference device.

A reference cluster 8214, as disclosed herein, may be a set/group of devices 8216 sharing a common configuration property/setting, where the group 8216 may have an assigned reference device 8218 (e.g., a device that is representative of the other devices within the group 8216 and/or a device that is to serve as a configuration standard against which other devices in the group can be compared). The reference device 8218 may be selected from a pool of devices (using a dynamic 8220 and/or static process 8222), and a criteria condition 8224 may be applied to devices identified as being within a particular cluster to ensure they meet specific requirements. In embodiments, devices meeting the criteria condition of a cluster may be labeled as “classified”, while devices not matching the criteria condition may be labeled as unclassified.

For example, in a non-limiting example of a procedure to define a reference cluster, a folder 8240 may be selected in a reference cluster manager module 8242 of the GUI 8200, with a user clicking ‘Add Cluster’ 8244 and providing a name and description for the new cluster 8246. The device scope 8248 may be established via: a dynamic search 8250 (e.g., using a dynamic search with standard criteria filters); from a device group 8252 (e.g., selecting a predefined device group); and/or using all network devices 8254 (e.g., selecting all devices in the network). The method to classify devices (e.g., dynamic 8220 or static 8222) may also be selected.

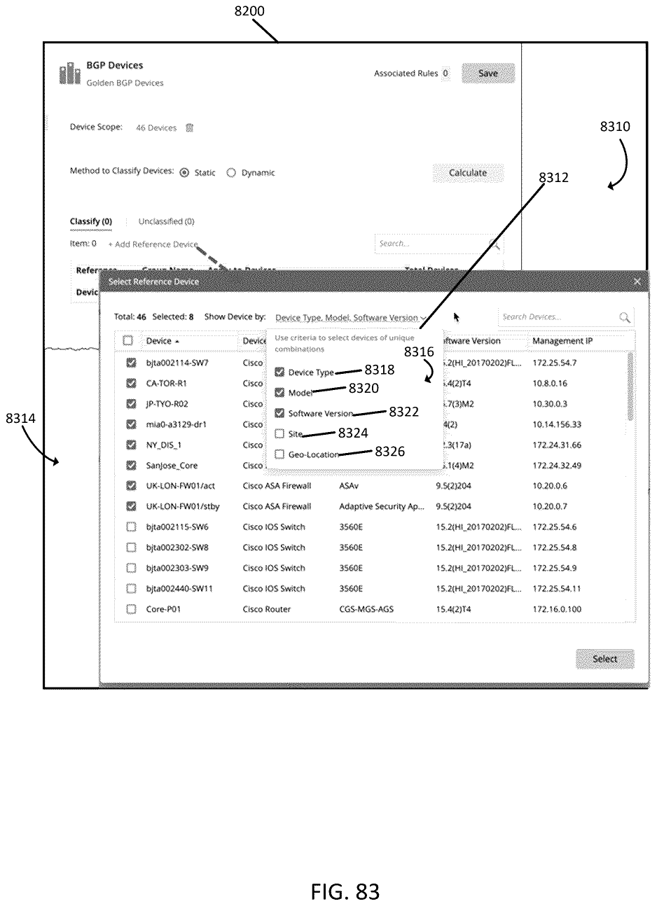

Illustrated in FIG. 83 is a static selection sub-process 8310 that may occur as part of the static classification 8222 (FIG. 82) of devices. The static selection sub-process 8310 may involve filtering 8312 reference devices 8314 based on unique parameters 8316 like device type 8318, model 8320, software version 8322, site 8324, geo-location 8326, and/or the like. In embodiments, a user may select one or multiple devices 8314 as the reference devices.

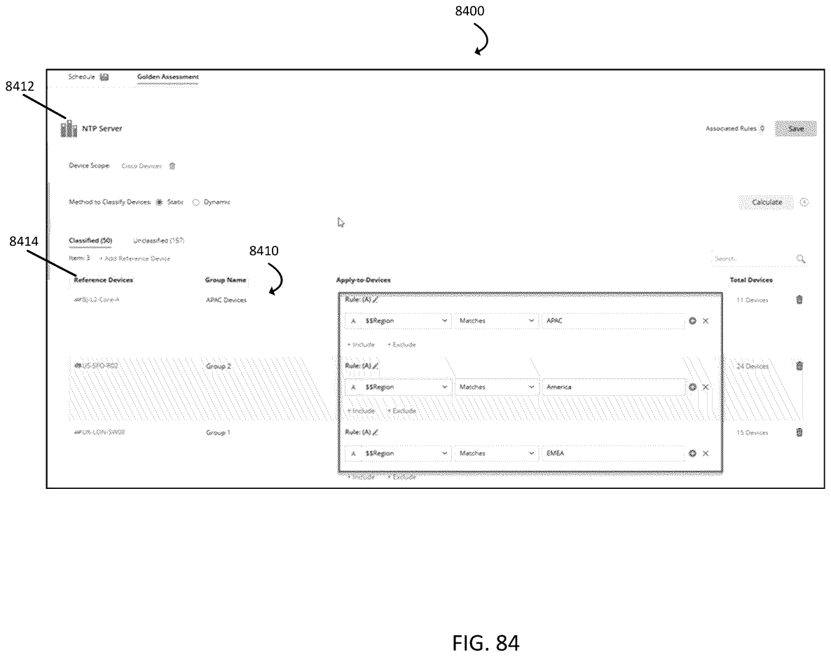

Turning to FIG. 84, embodiments of the current disclosure may provide for a GUI 8400 to create clusters 8410 for all devices with a given property 8412 (e.g., having a configured NTP server). Since different regions in a large scale network (e.g., a network for an international company and/or organization) such as Northeast America, Southwest America, United Kingdom, France, China, Japan, etc., typically each have different NTP servers, the GUI 8400 may provide for the creation of groups/clusters 8410 of devices according to their region and/or for the selection of a reference device 8414 for each region. In other words, the GUI 8400 may provide for the creation of clusters 8410 of devices, where each cluster 8410 includes devices configured to use an NTP server in the same geographic region. While the foregoing example concerned NTP servers and geographically-based clusters, it is to be understood that the concept of grouping devices into clusters based on similar and/or shared attributes can be expanded to other types of properties and/or relationships. For example, firewall devices could be arranged into clusters based on: manufacturer type; security/confidentiality level of the data and/or network they are protecting; whether they support/allow virtual private connections, and/or the like.

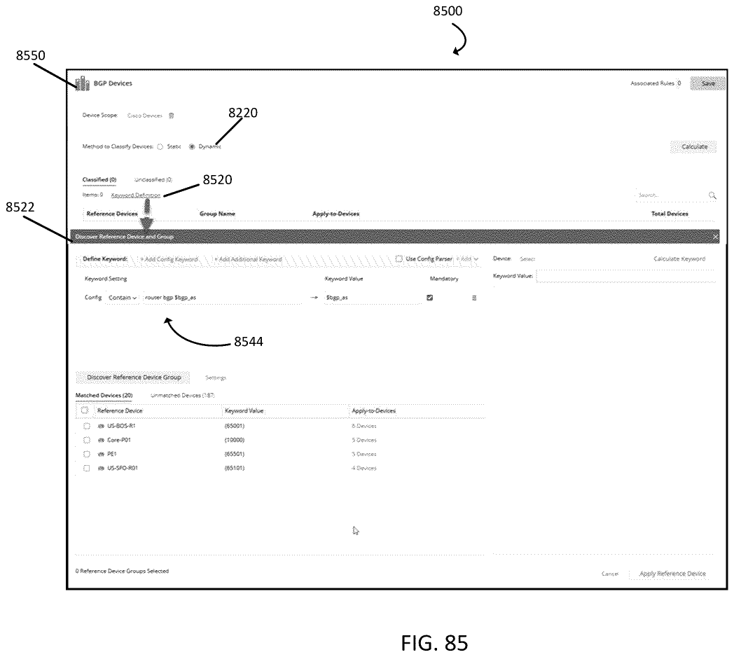

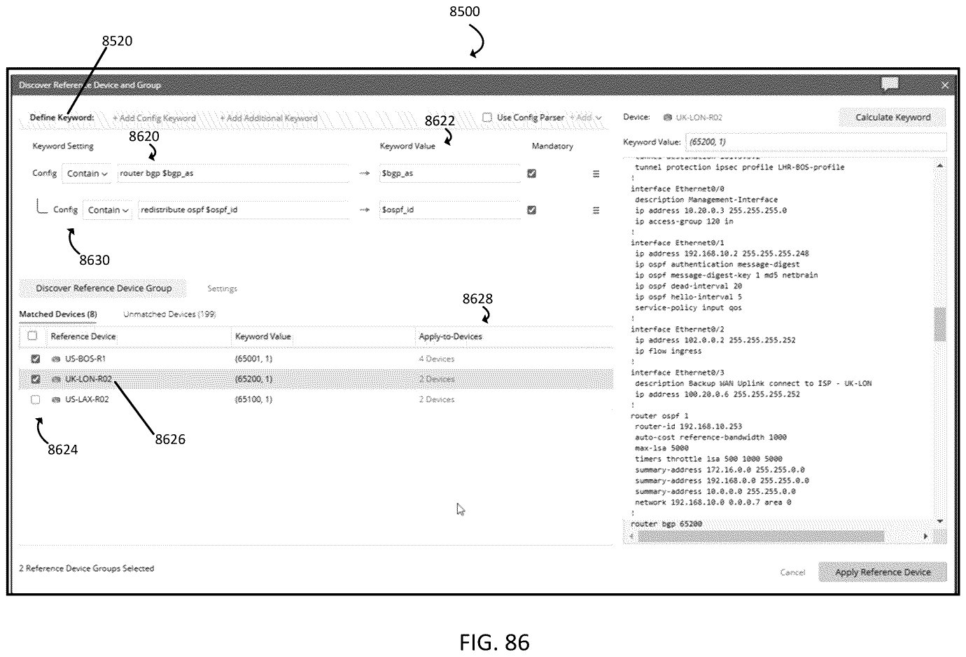

Illustrated in FIGS. 85 and 86 is a GUI 8500 for a dynamic selection and/or classification sub-process that may occur as part of the dynamic classification 8220 of devices. Dynamic selection may involve a computer (e.g., an application executing on at least one processor) classifying devices. Put another way, instead of (or in addition to) manually selecting a reference device, a user can ask a computer (e.g., via GUI 8500) to discover the reference device dynamically. In embodiments, a user may create search queries using keywords 8520 via a sub-menu 8522. Embodiments of the current disclosure may search for the variable values of the devices that meet the conditions/assessment features 8544 (which may be specified by a user). These values may then be grouped and the results displayed in two parts, e.g., classified and unclassified devices, as disclosed herein. Embodiments may also provide for users to further refine the classified devices by including and/or excluding devices within the scope of the assessment feature.

By way of a non-limiting example, a user may create a reference cluster 8550 (e.g., BGP Devices), and then, as shown in FIG. 86, define a keyword 8620 as Config Contains “router bgp $bgp_as”, and set the keyword value 8622 to be $bgp_as. Embodiments of the current disclosure may then discover reference devices 8624, where each device represents a unique keyword value, (e.g., $bgp_as). The GUI 8500 may also provide for the selection 8626 and application 8628 of reference groups from the discovered results 8624. Embodiments of the GUI 8500 may also provide for the addition of sub-keyword conditions 8630 to refine the search within the initial results. For example, the user may define a reference device for a unique $as_number and redistributed $ospf_id by adding a sub-keyword.

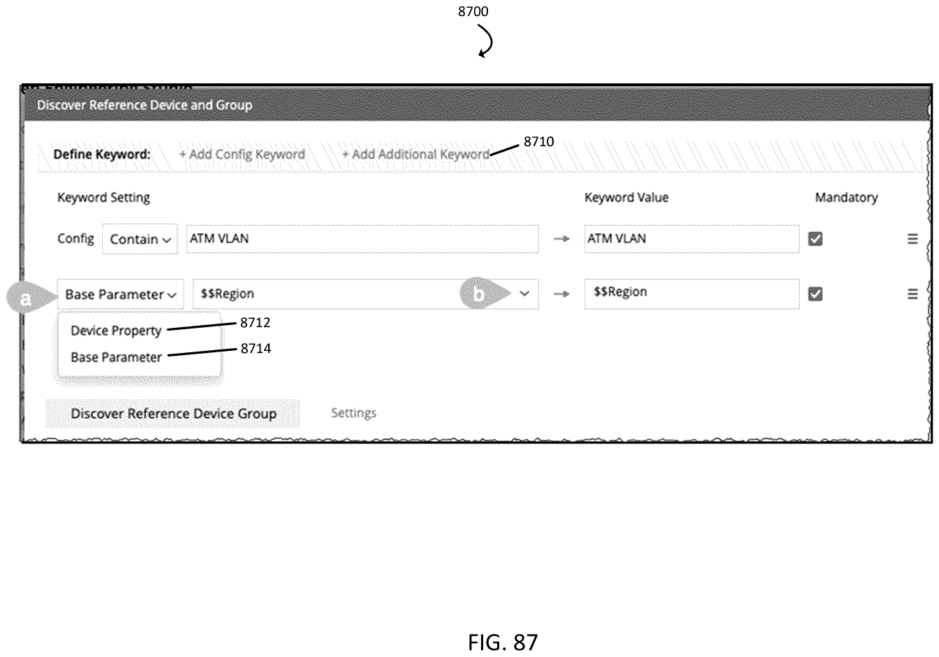

As shown in FIG. 87, embodiments of the current disclosure may include a GUI 8700 that provides for the specification of additional keyword settings 8710 based, in part, on a device property 8712 and/or a base parameter 8714.

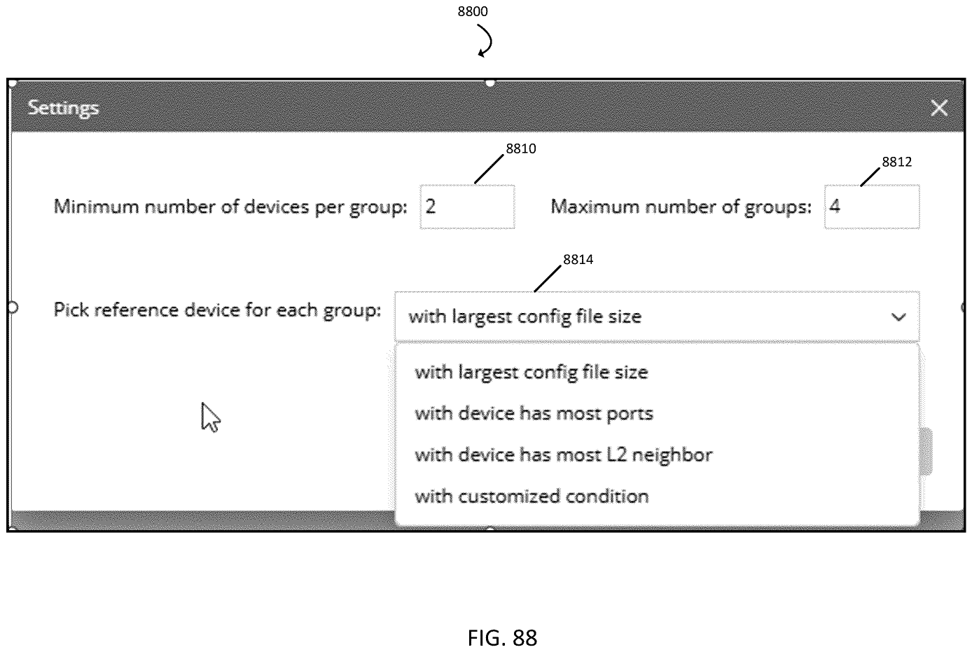

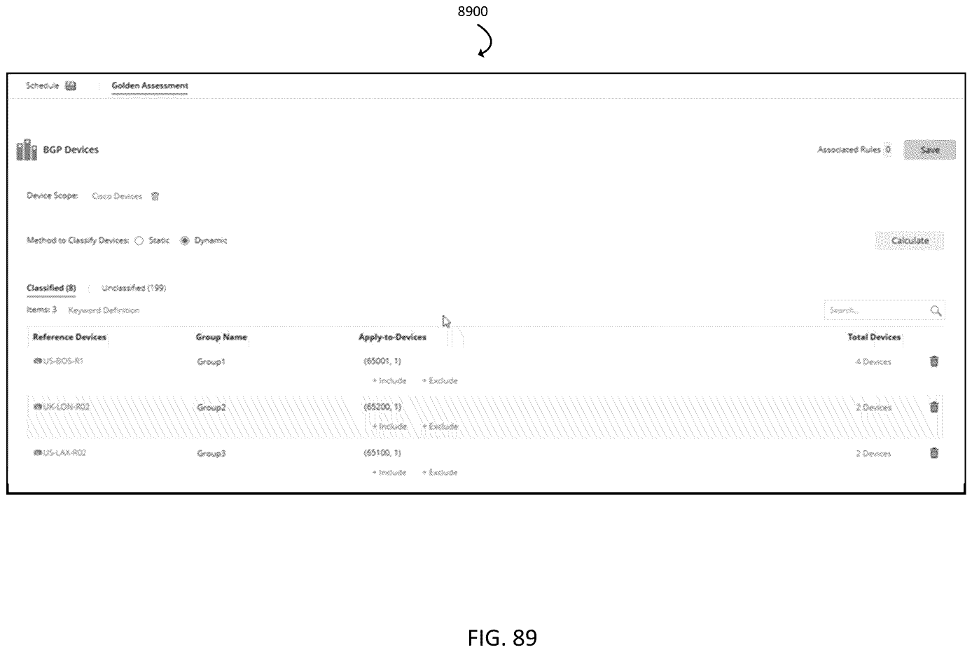

As shown in FIG. 88. embodiments of the current disclosure may also provide a GUI 8800 that provides for the adjustment of one or more of the following settings to customize device discovery: maximum number of devices per group 8810; maximum number of groups 8812; and/or a defined rule 8814 to pick a reference device for each group.

FIG. 89 depicts a GUI 8900 showing the results of the reference group identified by the keyword and sub-keyword examples discussed in relation to FIGS. 85-88.

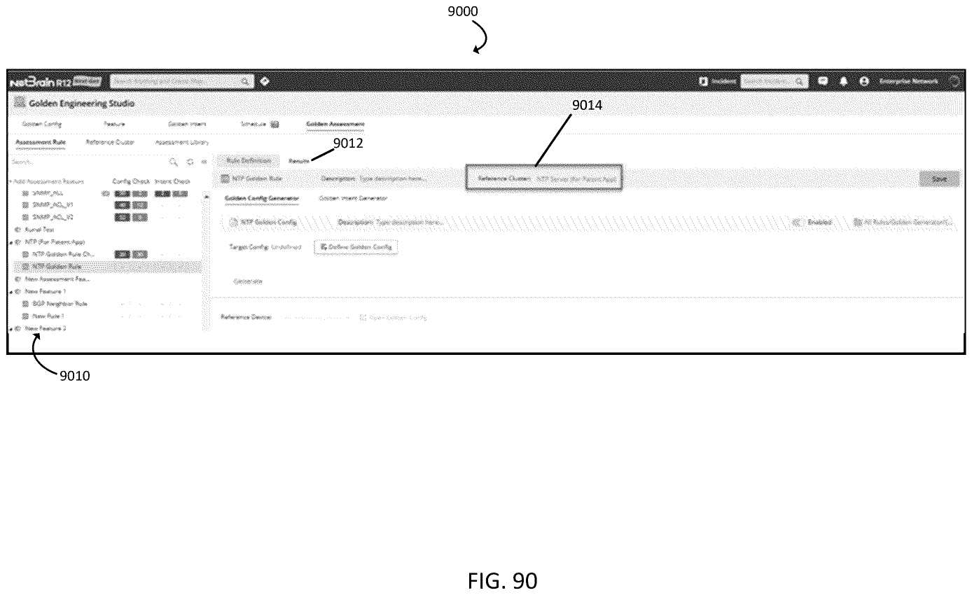

Turning to FIG. 90, embodiments of the current disclosure may provide for GUI 9000 that facilitates the addition of assessment rules 9010 for a configuration and network state check 9012 for an assessment feature. In addition to basic information (e.g., rule name, description, location, etc.), each rule 9010 may receive/have an associated reference cluster 9014 before the generation of a golden configuration and/or a golden intent.

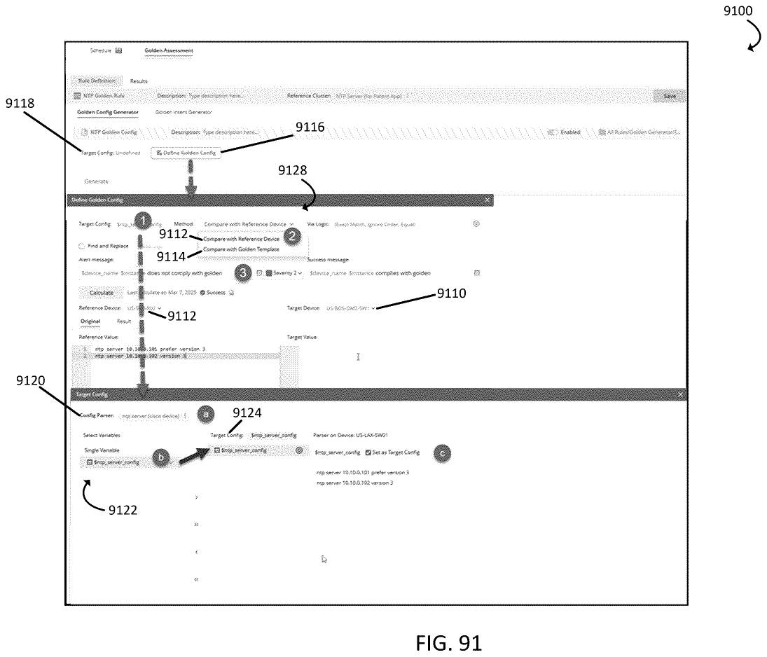

Referring to FIG. 91, embodiments of the current disclosure may include a GUI 9100 structured to facilitate the comparison of one or more devices 9110 of a cluster to a reference device 9112 and/or a golden configuration 9114. For example, a user may define 9116 a golden configuration by providing a name, description, and/or a location, and then define a target configuration 9118 (e.g., the configuration of a device that is to be tested against the representative device and/or the golden configuration) and choose a configuration parser 9120 from the parser library or create a new one. The user may then select variables 9122 as the candidates of target configs, and then set one variable as the target configuration 9124.

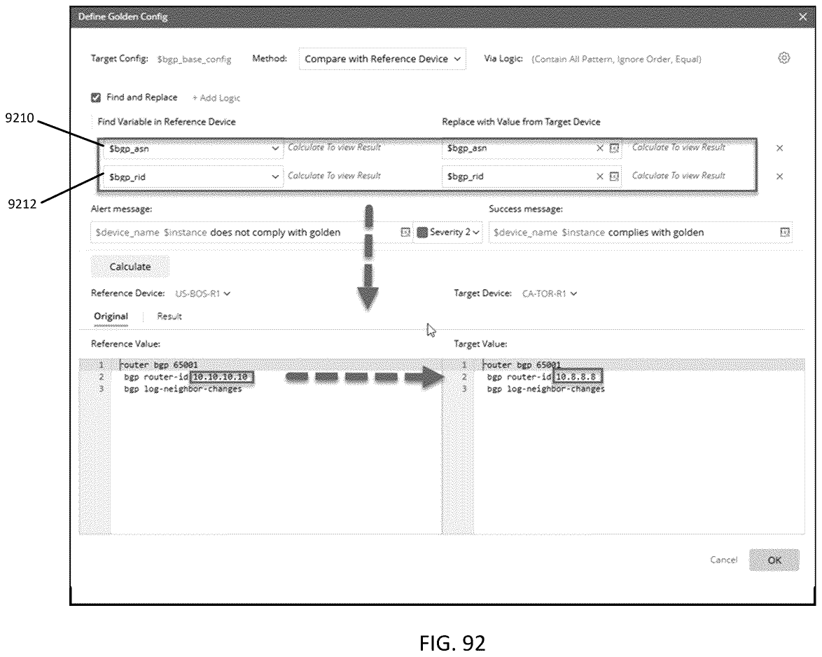

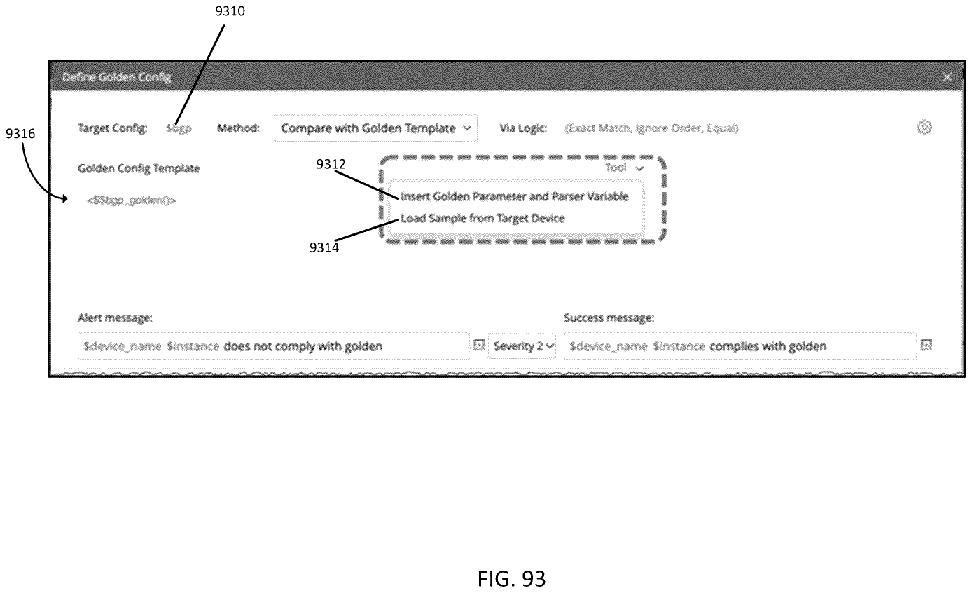

The user may then select the comparison method 9128 (e.g., comparing the target against the reference device 9112 or the golden template 9114). In embodiments, comparison of the target configuration against the reference device may be dynamic (e.g., a user need not define the golden template). If the target configuration includes variable(s) that are local to a particular device (associated with the target configuration), the user can use the find and replace feature (as disclosed herein) to replace the variable(s). For example, if the target configuration is the interface of a device, the user has the option to parse the interface name and replace the interface name of the reference device with that of the member device, as shown in FIG. 92, in which the BGP AS 9210 number and router-id 9212 are replaced. As shown in FIG. 93, for the comparison of the target configuration 9310 against a golden configuration, the user and/or computer may insert a golden parameter 9312 and/or parser variable 9314 into a golden configuration template 9316.

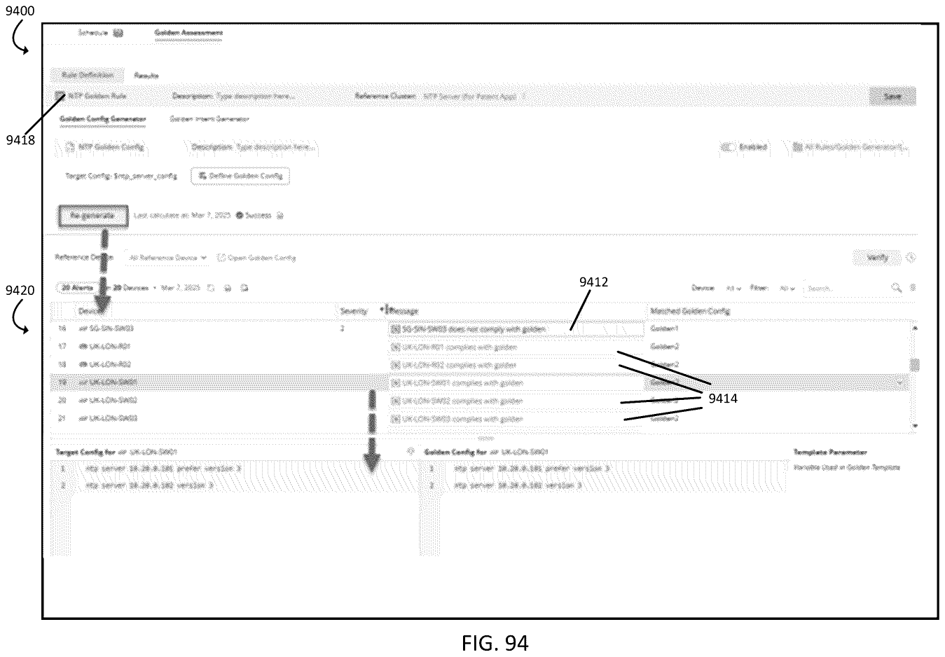

Referring to FIG. 94, embodiments of the current disclosure may also provide for a GUI 9400 to define alert messages 9412 and/or success messages 9414. For example, after defining a golden configuration 9418, a user may calculate and compare the golden configuration 9418 to target devices 9420. In such embodiments, for each reference cluster, the system parses the target configuration of the reference device and member devices and compares them. If they are different, the system may raise an alert 9412 that may contain details associated with the triggering of the alert.

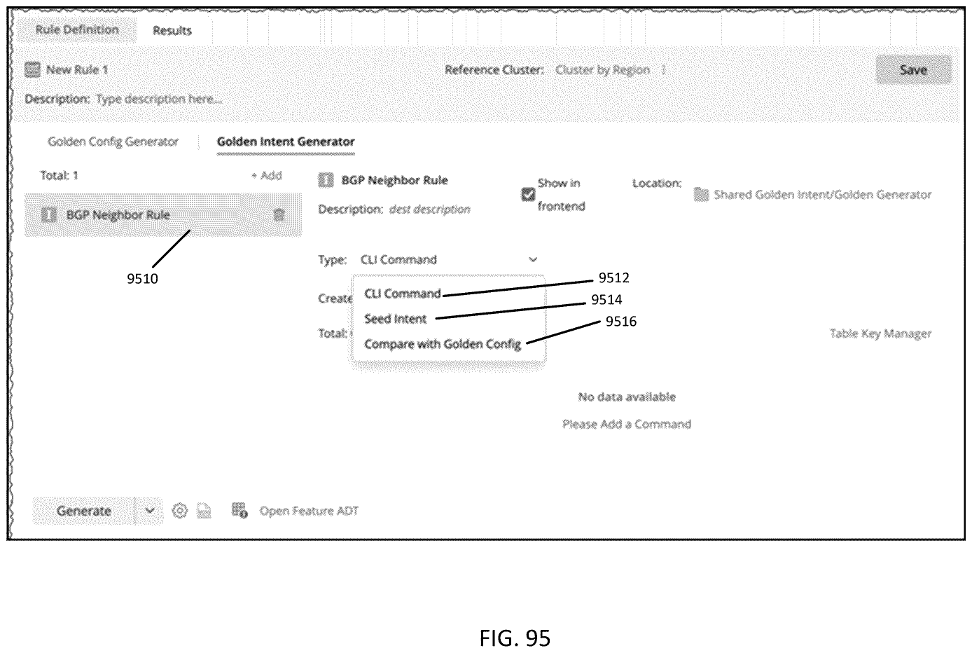

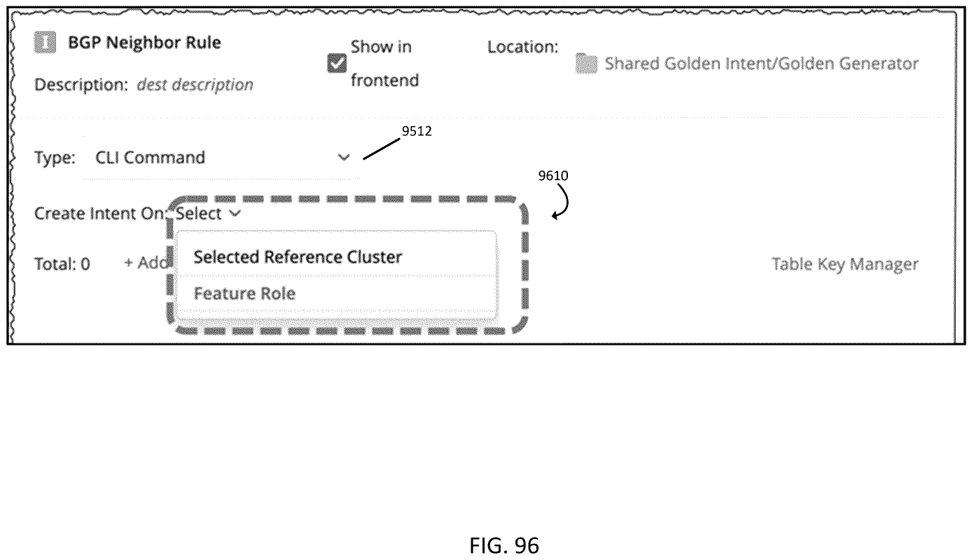

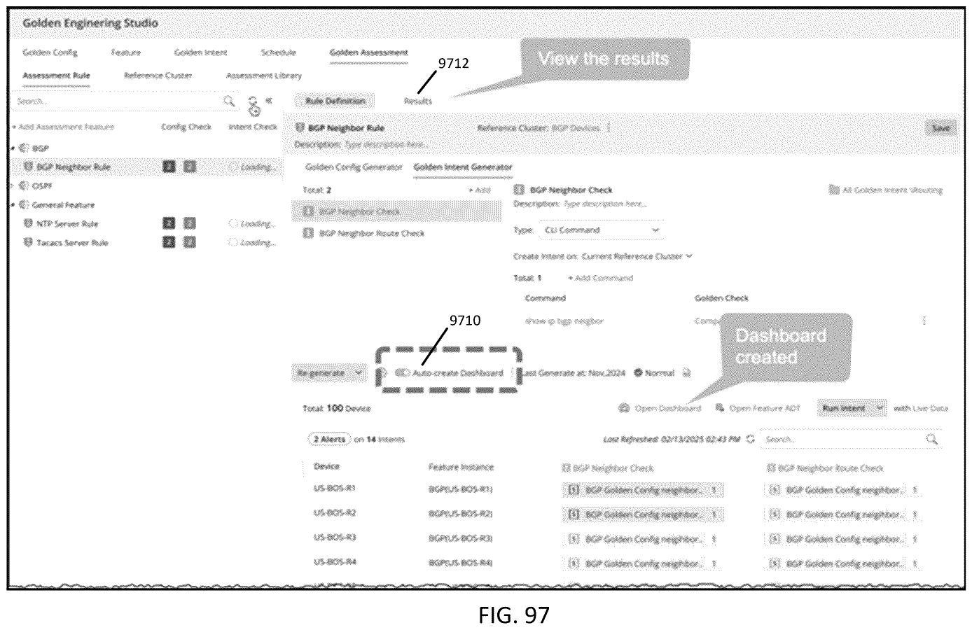

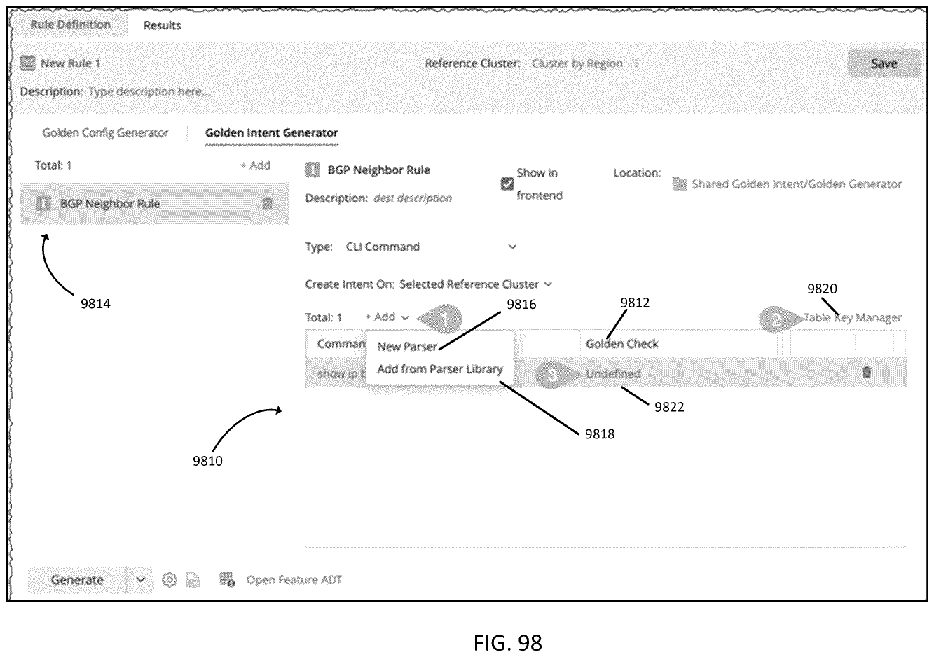

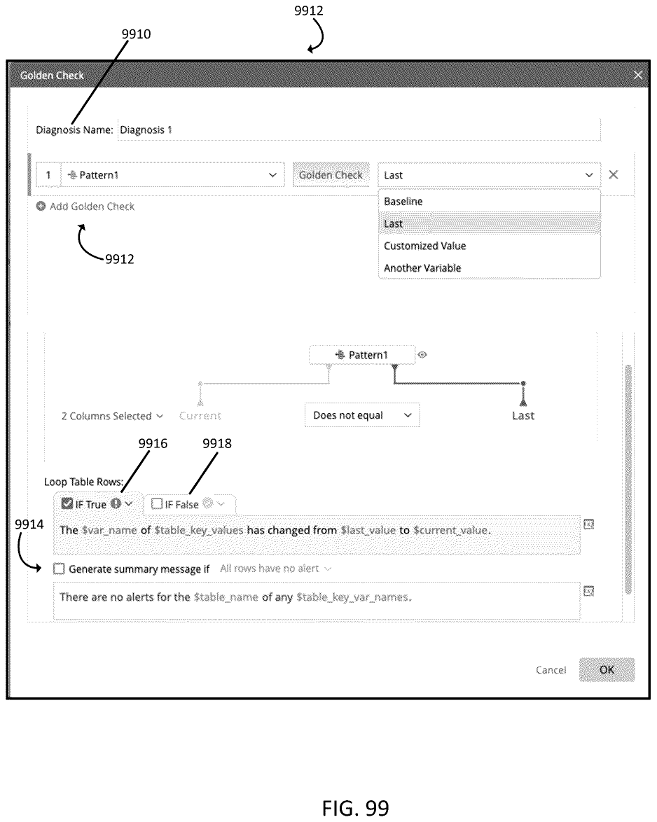

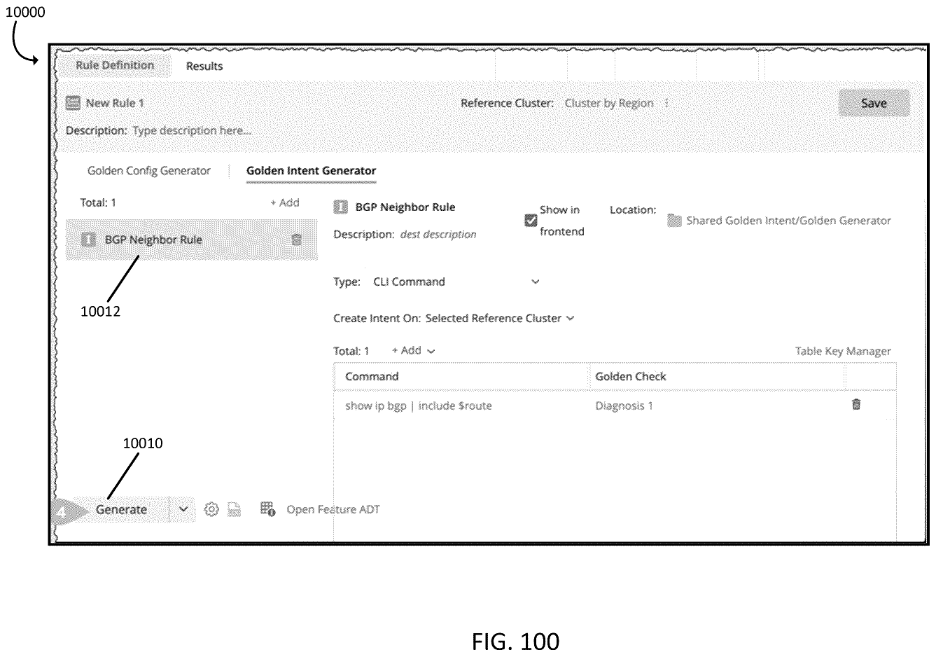

As illustrated in FIG. 95, golden intents may be generated from and/or based on assessment rules 9510. In embodiments, golden intents may be generated/created from assessment rules in one or more of the following ways: CLI command 9512, seed intent 9514, and/or golden configuration check 9516. The CLI command 9512 process provides an option for the user to define a command parser to perform a check. The user may also select an intent, which can be created either on the current Reference Cluster/Feature Role 9610 (FIG. 96) and/or all devices of the network. In embodiments, the user may enable an Auto-create Dashboard option 9710 (FIG. 97) to automatically generate a dashboard after successful Golden Intent execution. Results for both the golden configuration and intent checks may be made available in a Results tab 9712. Further, for CLI command-based intents, a user may add a command 9810 (FIG. 98) and specify the diagnosis and corresponding message in a golden check column 9812 (FIG. 98). Each intent 9814 may include multiple commands 9810 and checks 9812. In embodiments, a user may add command 9810 and/or golden check 9812 information by selecting either an existing parser 9816 from a corresponding library or by creating 9818 a new parser. The user may then set a table key in a Table Key Manager 9820 (FIG. 98) and go to an Undefine menu option 9822 (FIG. 98) in the Golden Check column 9812 to define a diagnosis 9910 (FIG. 99). The user may then define a golden check module 9912 in which they can add multiple golden checks and/or define a message 9914 for display for true conditions 9916 and/or false 9918 conditions. A generate option 10010 (FIG. 100) may then be presented to the user via a GUI 10000 to facilitate execution of the created intent 10012, and a window may pop up displaying the golden configuration and/or golden intent definition for the current golden rule.

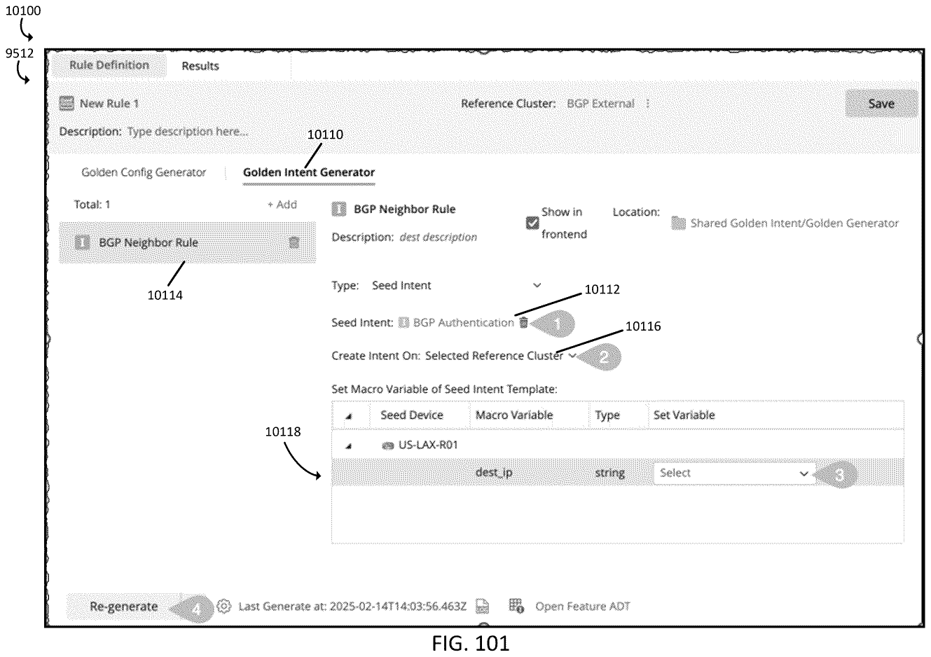

Turning to FIG. 101, the seed intent process 9514 provides for the creation of a golden intent 10110 using an existing seed intent. In such embodiments, a user interface 10100 may provide for a user to select 10112 a seed intent as a type to facilitate replication of an existing intent 10114 from an intent manager to a target device. Upon selecting 10112 a seed intent and selecting 10116 target reference cluster, the interface 10100 may provide for the user to configure any necessary macro variable values 10118.

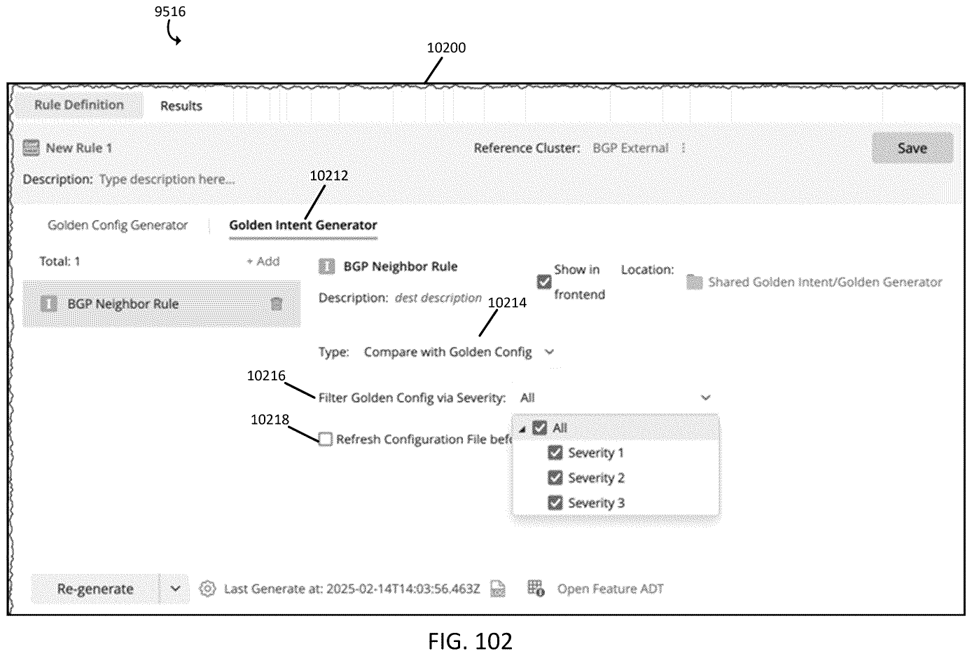

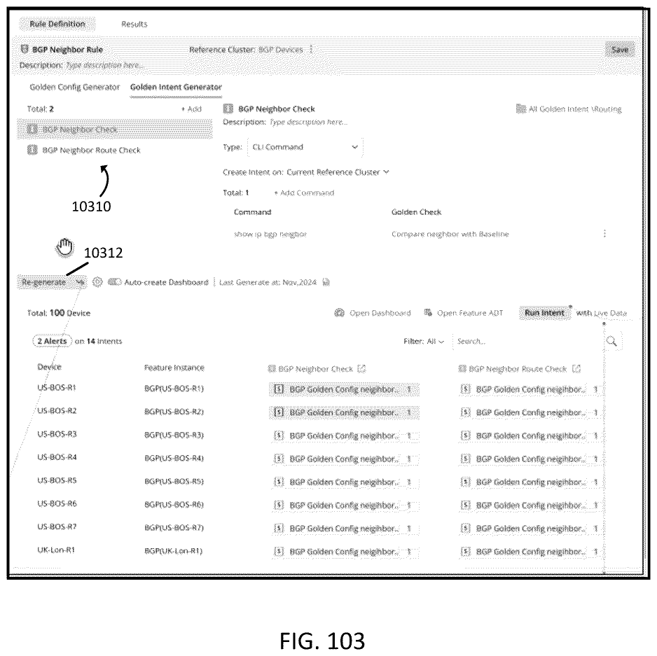

As shown in FIG. 102, the golden configuration check process 9516 provides for a user to generate 10212 the corresponding golden intent through a golden configuration check. In such embodiments, a compare with golden configuration function 10214 may be scheduled to periodically check and display results. The interface 10200 may further provide an option 10216 to select a filter for the golden configuration via a severity option 10218 to enable a refresh configuration file before executing a golden configuration check. In embodiments, multiple golden intents 10310 (FIG. 103) created under the same rule can be selected for batch replication 10312 (FIG. 103) to target devices.

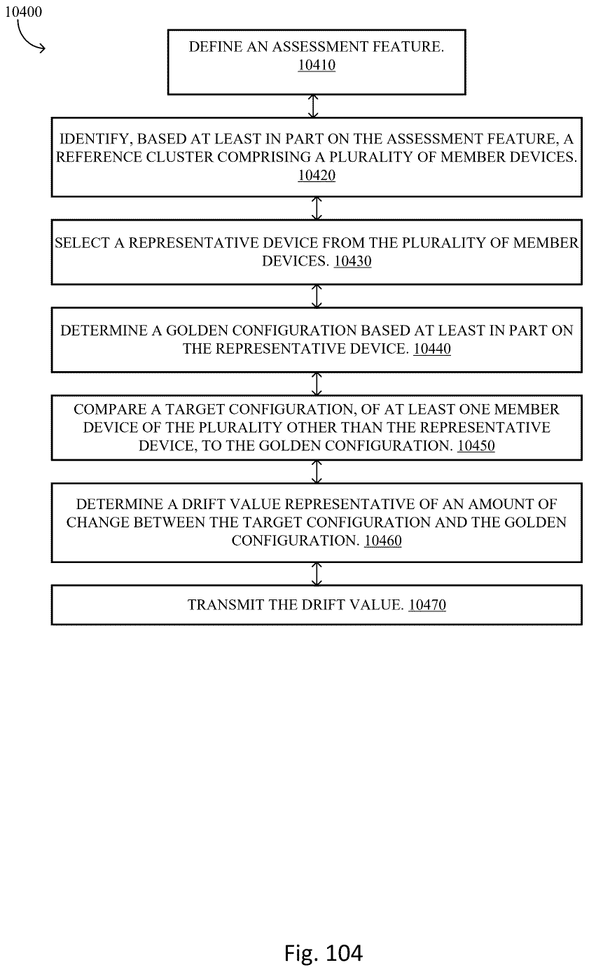

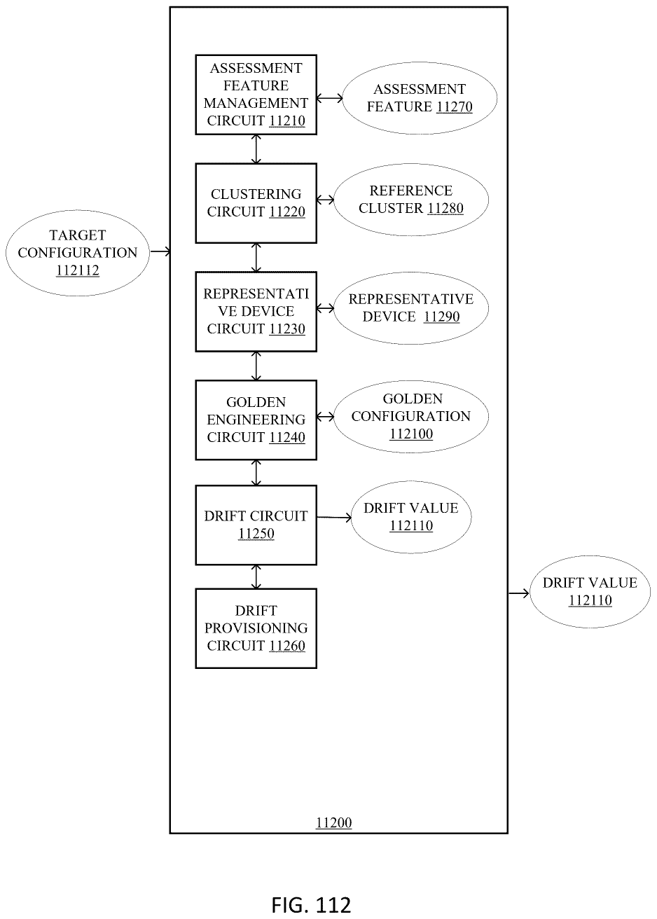

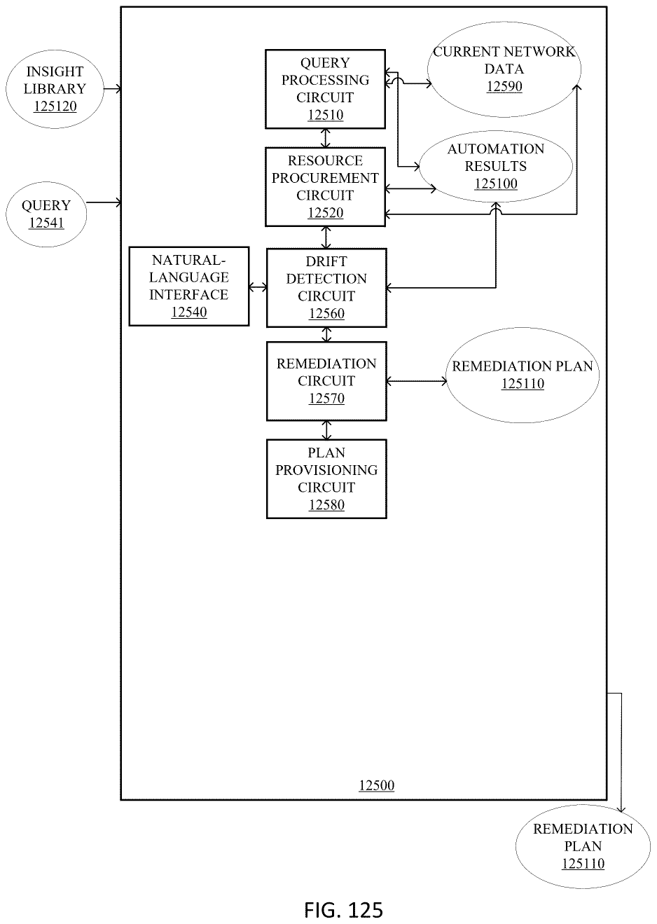

Accordingly, and referring to FIG. 104, embodiments of the current disclosure provide for a method 10400 for managing a network. As will be appreciated, the method 10400 (and/or one or more of its components) may be performed by the apparatus 11200 (FIG. 112), apparatus 12500 (FIG. 125), orchestration circuit 312, apparatus 200, the application 214, and/or any other computing device disclosed herein. The method includes: defining an assessment feature 10410; identifying, based at least in part on the assessment feature, a reference cluster that includes a plurality of member devices 10420; selecting a representative device from the plurality of member devices 10430; and determining a golden configuration based at least in part on the representative device 10440. The method 10400 further includes comparing a target configuration, of at least one member device of the plurality other than the representative device, to the golden configuration 10450; determining a drift value representative of an amount of change between the target configuration and the golden configuration 10460; and transmitting the drift value 10470.

Defining the assessment feature 10410 may include selecting one or more characteristics that are expected to be shared among devices that should be evaluated relative to a common configuration baseline. For example, the assessment feature 10410 may be based on device type, protocol participation, software version, site designation, topology role, service association, parser-derived variable, or another attribute indicative of a common operational context. By defining the assessment feature 10410 in this manner, the method 10400 may reduce the likelihood that dissimilar devices are grouped together for comparison, which may improve the technical relevance of later drift analysis. In various implementations, the assessment feature 10410 may be defined through a user interface, generated from discovered network information, derived from one or more eigen variables, or determined using a combination thereof.

Identifying the reference cluster 10420 may include evaluating device information associated with a plurality of candidate devices and grouping those devices that satisfy the assessment feature 10410 into a reference cluster. The resulting reference cluster may therefore represent a subset of the network in which the member devices are sufficiently similar that one device may be used as a basis for establishing an expected configuration state for the others. This approach may be particularly beneficial in large-scale network environments in which a single universal baseline would be overly generalized and therefore less useful for identifying meaningful deviations. Optionally, the reference cluster may be updated dynamically as devices are added, removed, reconfigured, or reassigned within the network.

Selecting the representative device 10430 may include identifying a member device that is most characteristic of the plurality of member devices in the reference cluster. For example, the representative device 10430 may be selected based on similarity to other member devices, historical compliance, stability, administrative designation, or another selection criterion. Use of the representative device 10430 may reduce the need for manual review of every device configuration in the cluster and may provide a practical mechanism for establishing a technically coherent point of reference. In various implementations, the representative device 10430 may be selected automatically according to one or more rules, while in other implementations a user may designate the representative device 10430 based on operational knowledge of the network.

Determining the golden configuration 10440 based at least in part on the representative device may include extracting selected configuration content from the representative device, normalizing the extracted configuration content, and storing the resulting golden configuration as a comparison baseline for the reference cluster. The golden configuration 10440 may, in certain implementations, correspond to a complete device configuration and, in other implementations, correspond to only a subset of configuration content associated with one or more targeted features, protocols, interfaces, services, or policy settings. This may permit the method 10400 to focus on configuration content that is relevant to the intended assessment, rather than requiring full-text comparison of entire device configurations. Depending on the implementation, the golden configuration 10440 may be newly generated or an existing golden configuration may be refined using information obtained from the representative device.

Comparing the target configuration 10450 to the golden configuration may include parsing the target configuration to identify one or more relevant configuration elements and evaluating those configuration elements relative to corresponding elements of the golden configuration 10440. The comparison may be exact, rule-based, template-based, similarity-based, or otherwise structured to determine whether the target configuration is aligned with the expected configuration state represented by the golden configuration 10440. Based on that comparison, the method 10400 may determine the drift value 10460, which may indicate a magnitude, severity, or other measure of deviation between the target configuration and the golden configuration. Transmitting the drift value 10470 may include presenting the drift value in a user interface, generating an alert, storing the drift value for later analysis, or providing the drift value to another system for use in remediation, reporting, or workflow automation. In this way, the method 10400 may improve visibility into configuration inconsistency and may support more efficient identification and correction of drift across the managed network.

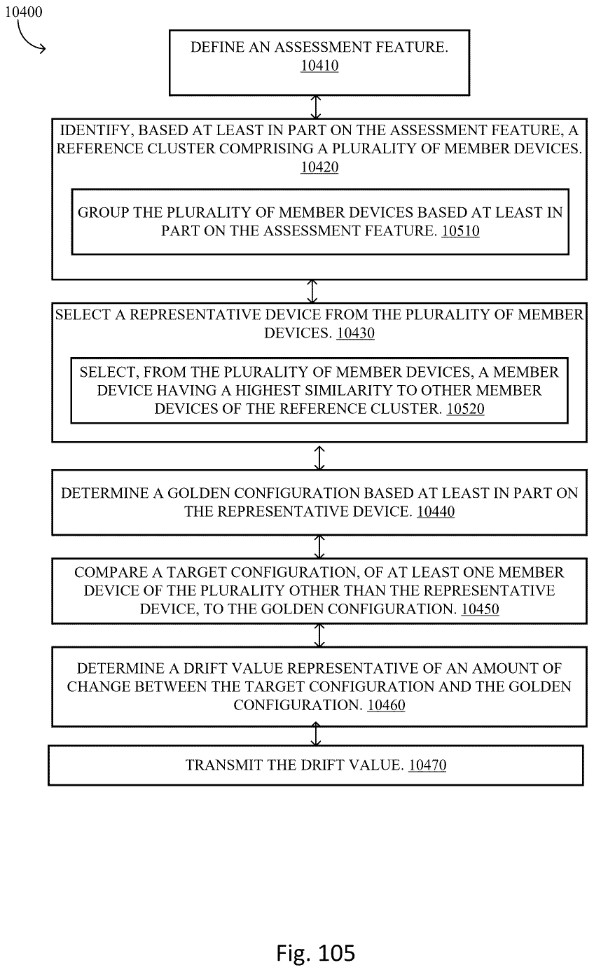

As shown in FIG. 105, in certain aspects, identifying the reference cluster includes grouping the plurality of member devices based at least in part on the assessment feature 10510. In certain aspects, selecting the representative device includes selecting, from the plurality of member devices, a member device having a highest similarity to other member devices of the reference cluster 10520.

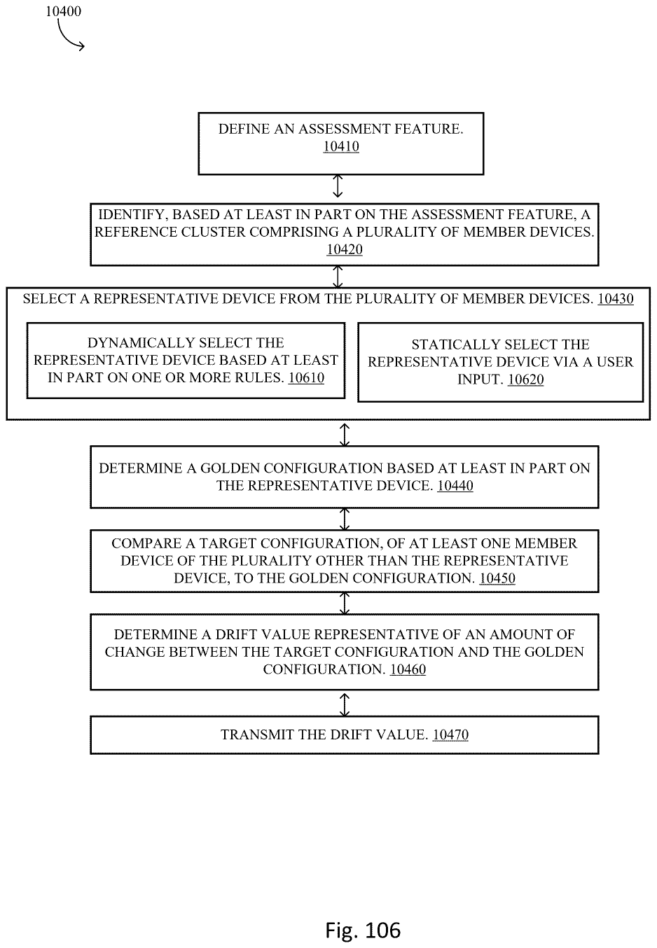

Turning to FIG. 106, in certain aspects, selecting the representative device includes dynamically selecting the representative device based at least in part on one or more rules 10610. In certain aspects, selecting the representative device includes statically selecting the representative device via a user input 10620.

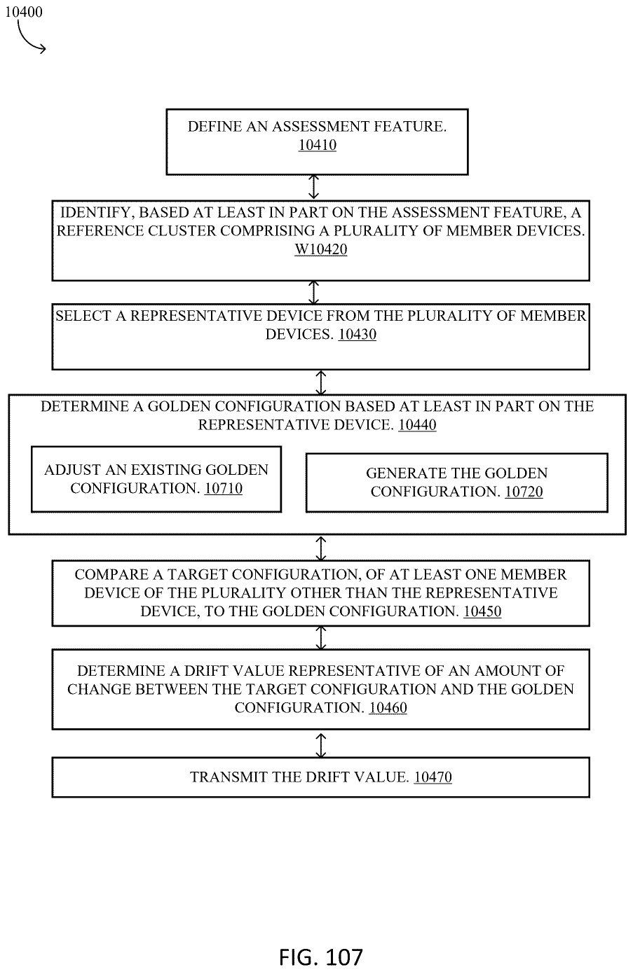

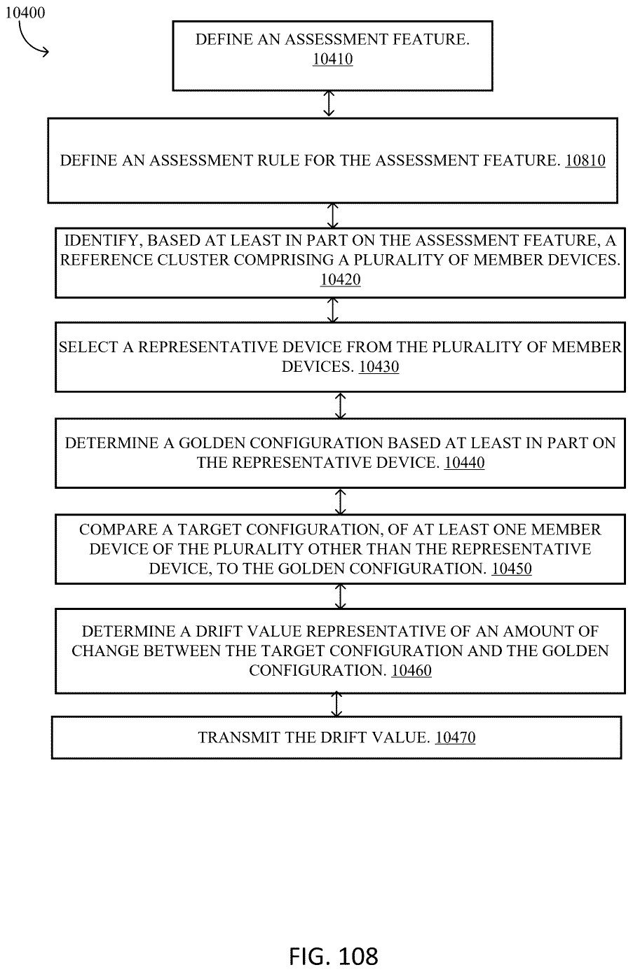

FIGS. 107, 108, and 109 depict yet further aspects of the method 10400. For example, determining the golden configuration based at least in part on the representative device may include adjusting an existing golden configuration 10710 (FIG. 107) and/or generating the golden configuration 10720 (FIG. 107). The method 10400 may also include defining an assessment rule for the assessment feature 10810 (FIG. 108). In embodiments, defining the assessment rule for the assessment feature 10810 may include: identifying a target configuration using a configuration parser 10910; selecting a comparison method that includes comparison with the representative device or comparison with a golden template 10920; and/or defining an alert message and a success message for a result of the comparison 10930.

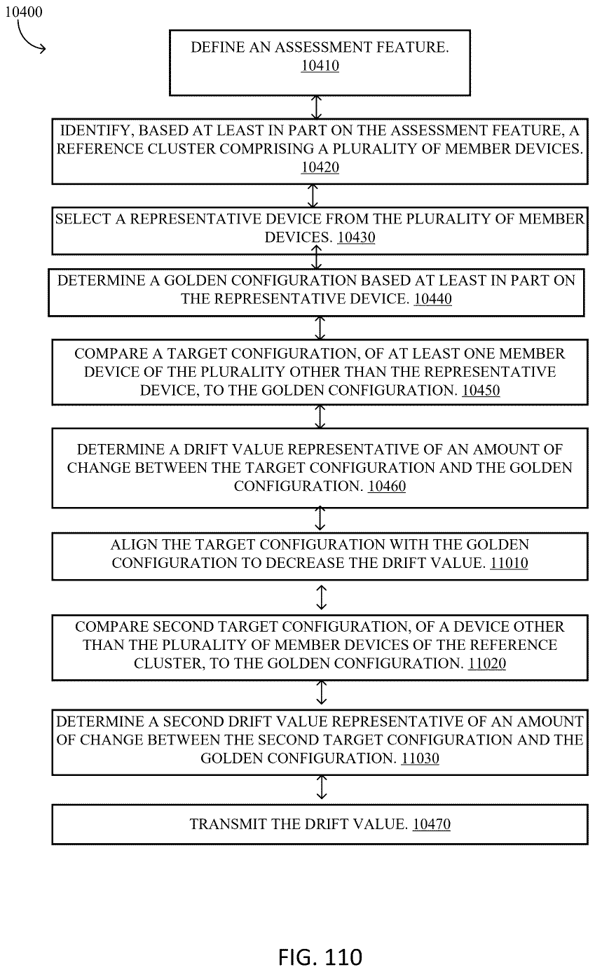

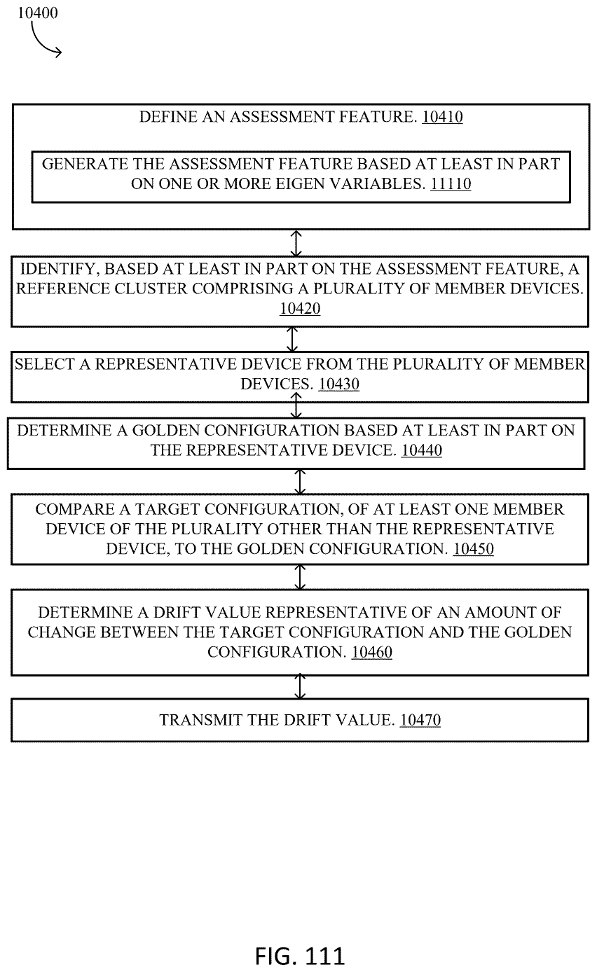

As illustrated in FIGS. 110 and 111, the method 10400 may include aligning the target configuration to/with the golden configuration to decrease the drift value 11010 (FIG. 110). The method 10400 may further include: comparing a second target configuration, of a device other than the plurality of member devices of the reference cluster, to the golden configuration 11020 (FIG. 110); and/or determining a second drift value representative of an amount of change between the second target configuration and the golden configuration 11030 (FIG. 110). In certain aspects, defining the assessment feature includes generating the assessment feature based at least in part on one or more eigen variables 11110 (FIG. 111). The one or more eigen variables may be generated by a parser, and/or the one or more eigen variables may include at least one of: a supported network protocol; a device attribute; an interface-level attribute; a neighbor relationship attribute; and/or a configuration parameter. In certain aspects, the supported network protocol may be at least one of: Border Gateway Protocol; Open Shortest Path First; Network Time Protocol; Domain Name System; Internet Message Access Protocol; Internet Protocol version 4; and/or Internet Protocol version 6. In embodiments, the device attribute includes at least one of: a host name; a device type; or a location. In certain aspects, the interface-level attribute includes at least one of: a local interface name; a neighbor interface name; and/or an interface internet protocol address. The neighbor relationship attribute may include at least one of: a neighbor device name; a neighbor device internet protocol address; a layer 2 neighbor; and/or a layer 3 neighbor; and/or the configuration parameter includes at least one of: a routing protocol setting; a network time protocol server address; and/or a simple network management protocol community string.

Turning to FIG. 112, additional embodiments of the current disclosure provide for an apparatus 11200 for managing a network. The apparatus 11200 may form part of apparatus 200 (FIG. 2) and/or any other computing device disclosed herein. The apparatus 11200 may include: an assessment feature management circuit 11210, a clustering circuit 11220, a representative device circuit 11230, a golden engineering circuit 11240, a drift circuit 11250, and/or a drift provisioning circuit 11260. The assessment feature management circuit 11210 may be structured to define an assessment feature 11270; the clustering circuit 11220 may be structured to identify, based at least in part on the assessment feature 11270, a reference cluster 11280 that includes a plurality of member devices; and/or the representative device circuit 11230 may be structured to select a representative device 11290 from the plurality of member devices. The golden engineering circuit 11240 may be structured to determine a golden configuration 112100 based at least in part on the representative device 11290. The drift circuit 11250 may be structured to: compare a target configuration 112112, of at least one member device of the plurality other than the representative device 11290, to the golden configuration 112100; and/or determine a drift value 112110 representative of an amount of change between the target configuration 112112 and the golden configuration 112100. The drift provisioning circuit 11260 may be structured to transmit the drift value 112110.

In use, the assessment feature management circuit 11210 may generate the assessment feature 11270 from one or more inputs associated with the managed network. Such inputs may include user-defined criteria, discovered device attributes, parser-derived variables, topology data, service identifiers, or policy information. Thus, the assessment feature 11270 may characterize a subset of devices that are expected to share a common operational context (e.g., devices executing a common routing protocol; devices assigned to a common site classification; devices associated with a common tenant or service; devices having a common software release, etc.). By defining the assessment feature 11270 in this manner, the apparatus 11200 may improve the likelihood that the devices selected for comparison are meaningfully related from a configuration-management standpoint.

The clustering circuit 11220 may evaluate candidate devices against the assessment feature 11270 to establish the reference cluster 11280. For example, the clustering circuit 11220 may analyze configuration data, inventory information, protocol participation, interface characteristics, neighbor information, or administrative metadata to determine whether a given device should be included within the reference cluster 11280. In this regard, the reference cluster 11280 may correspond to a logical grouping of devices expected to exhibit comparable configuration behavior (e.g., access devices serving a particular environment; spine or leaf devices within a fabric; edge devices supporting a defined service chain; etc.). Formation of the reference cluster 11280 may therefore provide a more targeted basis for drift analysis than a global comparison across the entire network.

The representative device circuit 11230 may select the representative device 11290 from the plurality of member devices based on one or more selection criteria. In certain implementations, the representative device 11290 may be selected according to a similarity score that reflects how closely a given member device aligns with other devices in the reference cluster 11280. In other implementations, the representative device 11290 may be selected according to a historical stability metric, a compliance ranking, or an administrator-defined designation (e.g., a device having a highest similarity to other cluster members; a device having a relatively low historical drift value; a device designated as a preferred baseline device by a network engineer; etc.). Selection of the representative device 11290 in this manner may reduce the risk that an outlier device will be used as the basis for subsequent baseline creation.

The golden engineering circuit 11240 may derive the golden configuration 112100 from the representative device 11290 by extracting and processing configuration information associated with the representative device 11290. For example, the golden engineering circuit 11240 may normalize syntactic variations, isolate selected configuration domains, remove transient data, and store resulting configuration content as the golden configuration 112100. Depending on implementation, the golden configuration 112100 may represent a full-device baseline or a partial baseline associated with selected configuration categories (e.g., interface parameters; routing-policy elements; authentication settings; service-specific variables; etc.). In some arrangements, the golden engineering circuit 11240 may also update or refine a previously stored golden configuration 112100 to account for legitimate operational changes within the network.

The drift circuit 11250 may compare the target configuration 112112 to the golden configuration 112100 using one or more comparison techniques appropriate to the configuration domain under analysis. By way of example, the drift circuit 11250 may perform an exact comparison, a rule-based comparison, a template-based comparison, or a parser-assisted variable comparison (e.g., line-by-line comparison of selected configuration elements; comparison of extracted protocol variables; comparison against a golden template associated with a device role; etc.). Based on that comparison, the drift circuit 11250 may determine the drift value 112110 as an indication of the extent to which the target configuration 112112 departs from the golden configuration 112100. The drift value 112110 may be expressed in different forms depending on implementation (e.g., a numeric deviation score; a severity classification; a compliance indicator; a weighted drift metric; etc.).

The drift provisioning circuit 11260 may transmit the drift value 112110 to one or more downstream components for presentation, storage, or further action. For example, the drift provisioning circuit 11260 may provide the drift value 112110 to a user interface, an alert engine, a reporting workflow, a remediation engine, or a historical analytics repository (e.g., display within a dashboard; generation of a notification associated with a threshold exceedance; storage for trend analysis over time; initiation of a corrective action sequence; etc.). Through this coordinated operation, the apparatus 11200 may support scalable identification of configuration inconsistencies across a managed network while reducing reliance on manual inspection of raw device configuration data.

In certain aspects, the clustering circuit 11220 is structured to group the plurality of member devices based at least in part on the assessment feature 11270. In certain aspects, the representative device circuit 11230 is structured to select, from the plurality of member devices, a member device having a highest similarity to other member devices of the reference cluster. In certain aspects, the representative device circuit 11230 is structured to dynamically select the representative device 11290 based at least in part on one or more rules.

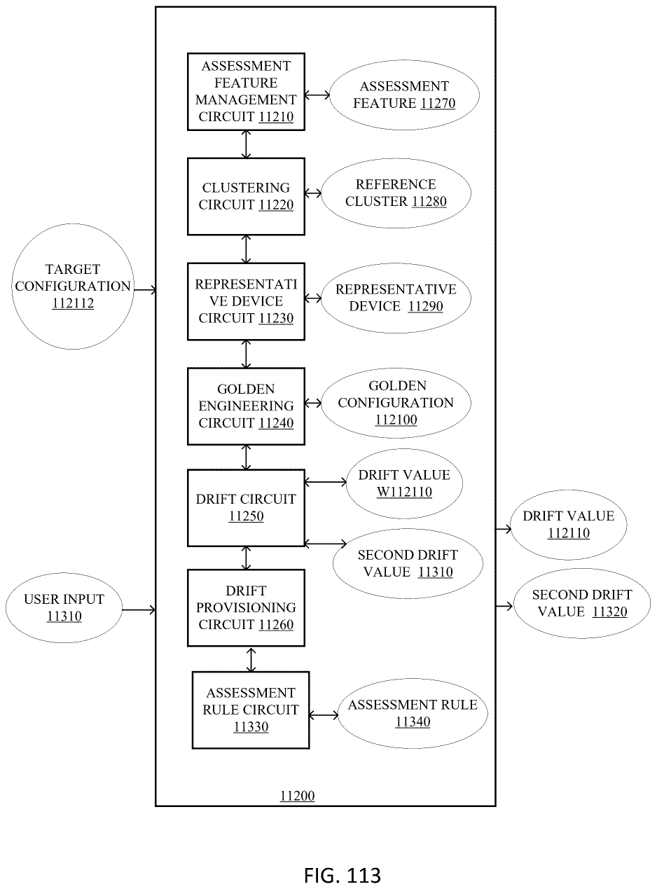

As shown in FIG. 113, in certain aspects, the representative device circuit 11230 is structured to statically select the representative device 11290 via a user input 11310. The golden engineering circuit 11240 may be structured to adjust an existing golden configuration 112100; and/or the golden engineering circuit 11240 may be structured to generate the golden configuration. In embodiments, the apparatus 11200 further includes an assessment rule circuit 11330 structured to define an assessment rule 11340 for the assessment feature by: selecting a configuration parser; selecting, from the configuration parser, a variable as the target configuration for comparison with a golden configuration template; and/or defining match pattern rules for comparing the target configuration against the golden configuration template. In certain aspects, the drift circuit 11250 is further structured to align the target configuration with the golden configuration to decrease the drift value; and/or the drift circuit 11250 is further structured to: compare a second target configuration, of a device other than the plurality of member devices of the reference cluster, to the golden configuration; and determine a second drift value 11320 representative of an amount of change between the second target configuration and the golden configuration. In certain aspects, the assessment feature management circuit 11210 is structured to generate the assessment feature based at least in part on one or more eigen variables. In certain aspects, the one or more eigen variables are generated by a parser. In certain aspects, the one or more eigen variables include at least one of: a supported network protocol; a device attribute; an interface-level attribute; a neighbor relationship attribute; or a configuration parameter. In certain aspects, the supported network protocol includes at least one of: Border Gateway Protocol; Open Shortest Path First; Network Time Protocol; Domain Name System; Internet Message Access Protocol; Internet Protocol version 4; or Internet Protocol version 6. In certain aspects, the device attribute includes at least one of: a host name; a device type; or a location. In certain aspects, the interface-level attribute includes at least one of: a local interface name; a neighbor interface name; or an interface internet protocol address. In certain aspects, the neighbor relationship attribute includes at least one of: a neighbor device name; a neighbor device internet protocol address; a layer 2 neighbor; or a layer 3 neighbor. In certain aspects, the configuration parameter includes at least one of: a routing protocol setting; a network time protocol server address; or a simple

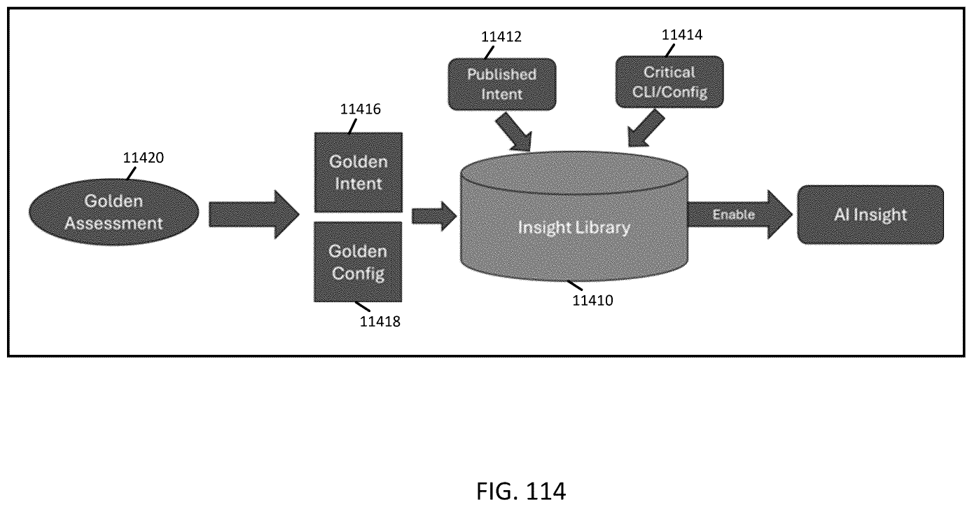

Referring now to FIG. 114, users may face hard decisions regarding what automation(s) and/or automation result(s) may be related to a particular network problem they may be working on. Accordingly, embodiments of the current disclosure may provide for an artificial intelligence (AI) insights module and/or circuit structured to solve network problems intelligently. Embodiments of the AI insights module may be based on an AI Large Language Model (LLM) and Retrieval-Augmented Generation (RAG), other types of neural network-based AI systems, and/or other types of machine learning models. In a non-limiting embodiment, an insight library 11410 can retrieve and/or store published: intents 11412; CLI configurations 11414; golden intents 11416 and/or golden configuration 11418, both of which may be based on a golden assessment(s) 11420; and/or any other type of relevant network management data.

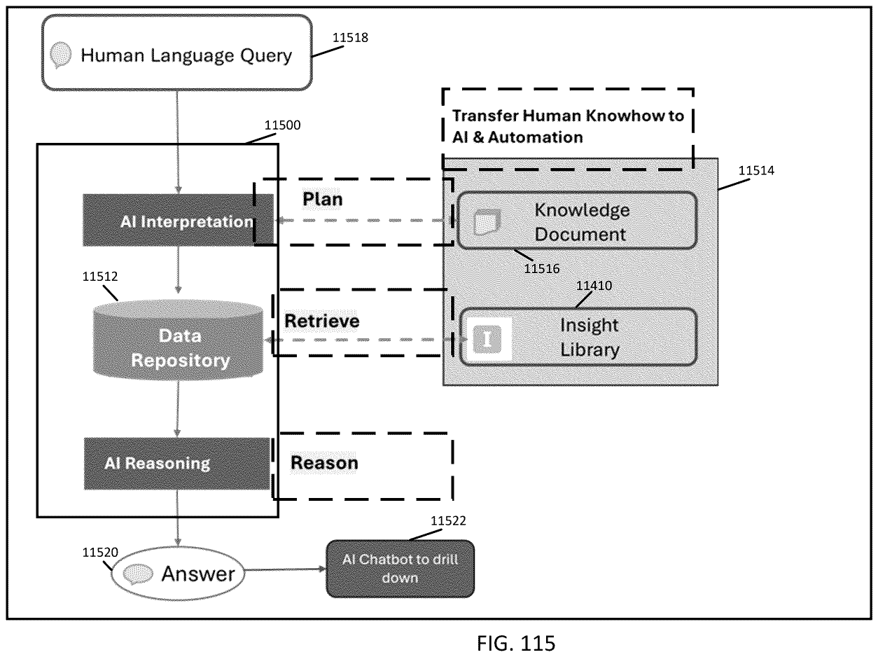

Moving to FIG. 115, embodiments of the current disclosure may use a RAG and/or other type of AI model 11500 to build a knowledge base 11512. The AI model 11500 may take automation assets such as golden intents 11416 and/or golden configurations 11418 built from a golden assessment 11420, published intents 11412, and/or critical CLI and configurations 11414 as inputs, and then build a vector database 11514 via an AI embedding model. The vector database 11514 may be based on and/or include the insight library 11410 and/or at least one knowledge document 11516. As will be appreciated, in embodiments, the insight library 11410 may provide for the AI model 11500 to generate a contextually accurate response based on not just general knowledge of the LLM, but on specific data from a subject network. In embodiments, the insight library 11410 may be updated whenever a new automation asset is added and/or an automation result changes. Embodiments of the disclosure may provide for a user to create the knowledge documents (e.g., troubleshooting steps for a network problem and/or category of network problems, where the AI module 11500 can use these documents to build more accurate insights.

Accordingly, in a non-limiting example, when a user enters a query 11518, embodiments of the AI model 11500 reason, based on the insight library 11410, and provide an answer 11520 by interpreting the query 11518 based on the insight library 11410 and/or knowledge document(s) 11516. The result of the interpretation may be a query plan, which includes a set of data, automation, and/or automation results. The AI model 11500 may retrieve data specified in the query plan from the Insight library 11410, where the result may be a data repository that includes relevant automation results. The AI model 11500 may then reason, based on the data repository, and refine the query plan. For example, if an intent raises an alert, the AI model 11500 may do further queries. The AI model 11500 then displays and/or transmits the answer 11520, via and/or to an AI chatbot interface 11522.

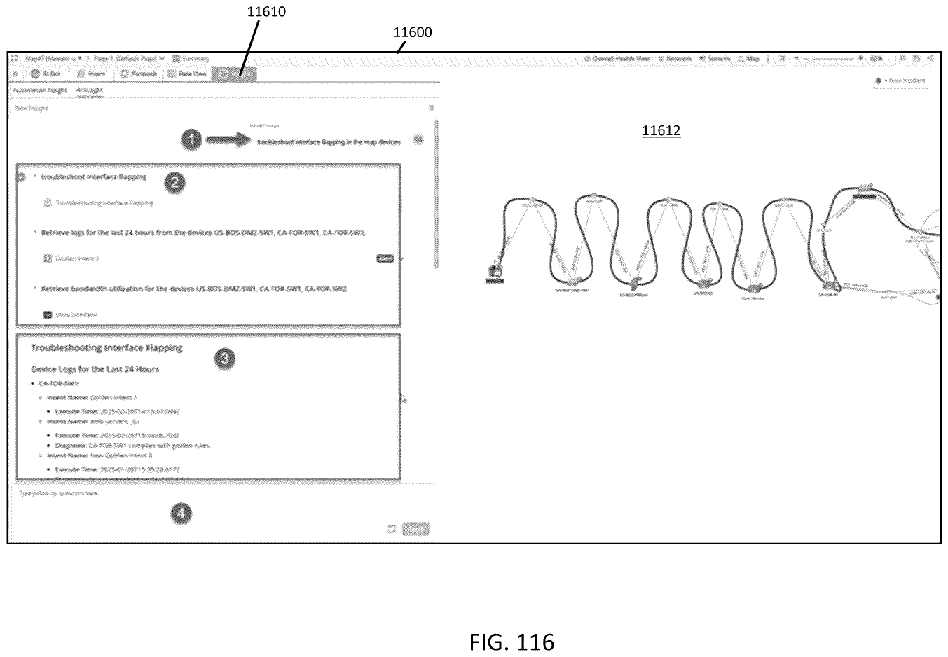

Turning to FIG. 116, embodiments of the current disclosure may provide a GUI 11600 having an AI Insight tab 11610 and a correlated network map 11612 for the user to end the query. In such embodiments, the data, such as the devices and/or interfaces on the map 11612, may be used as the context of the query. The AI Insight tab 11610 may also provide for the user to send/transmit a query.

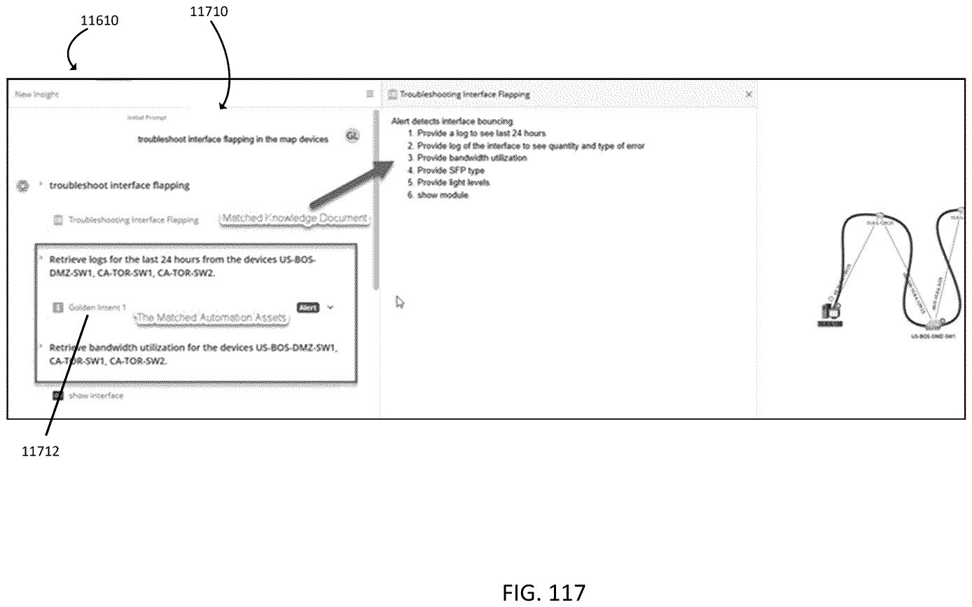

With reference to FIG. 117, in a non-limiting example scenario, a user may enter a query 11710 via the AI insight tab 11610, to engage the AI model 11500 (FIG. 115) for assistance in troubleshooting an issue, e.g., “Troubleshoot interface flapping in the map devices”. The AI model 11500 then creates a query plan based on the knowledge documents 11516 and/or insight library 11410. The AI model 11500 then checks the availability and/or relevancy of any knowledge document(s) 11516, and/or whether the insight library 11410 has any associated automations. The AI model 11500 finds a matched knowledge document 11516 (e.g., “Troubleshooting interface flapping”), which describes the following non-limiting process to troubleshoot interface flapping:
1) Alert detects interface bouncing;
2) Provide a log to see the last 24 hours;
3) Provide the log of the interface to see the quantity and type of error;
4) Provide bandwidth utilization;
5) Provide SFP type;
6) Provide light levels; and
7) Show module.

Based on this knowledge document and the insight library 11410, the AI model 11500 creates a set of automation assets associated with the query 11710. Continuing with this non-limiting example, the AI model 11500 retrieves the results of Golden Intent 1 11712 and the CLI command show interface.

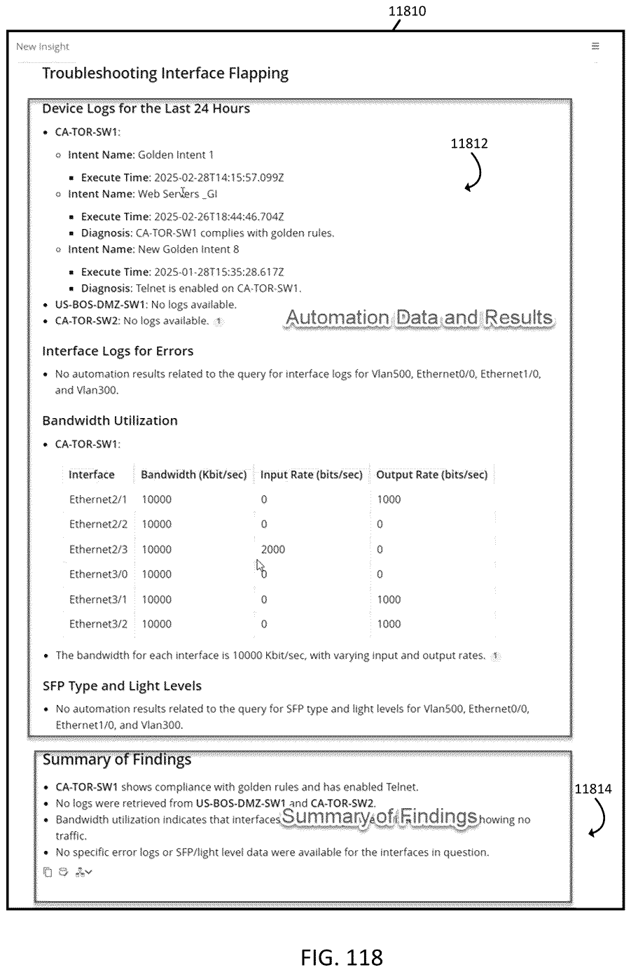

As will be appreciated, embodiments of the AI model 11500 may have the intelligence to create a query. As shown in FIG. 118, the AI model 11500 may reason, based on the data and results of automations, provide the best answer 11810, including the data 11812 and summary 11814 of findings.

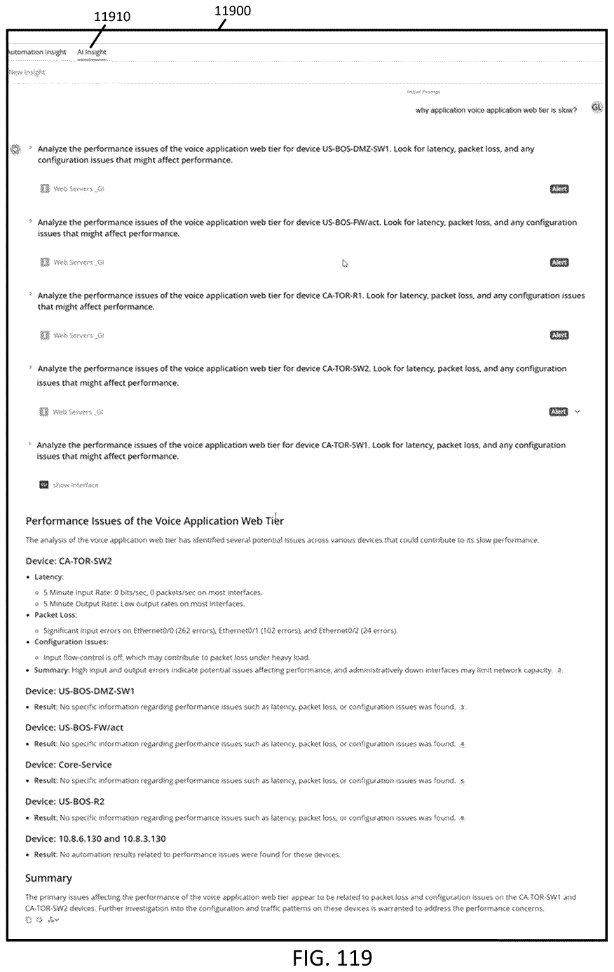

Turning to FIG. 119, as will be further appreciated, embodiments of the current disclosure may provide for an interface 11900 where users can ask follow-up question of the AI model 11500 and/or click a New Insight 11910 option to start a new question. For example, FIG. 119 shows another non-limiting scenario of a user interacting (e.g., asking) the AI insights module 11500 to help troubleshoot a slow application, where the AI insights module 11500 does not find any knowledge documents 11516 and answers the query based on the insight library 11410.

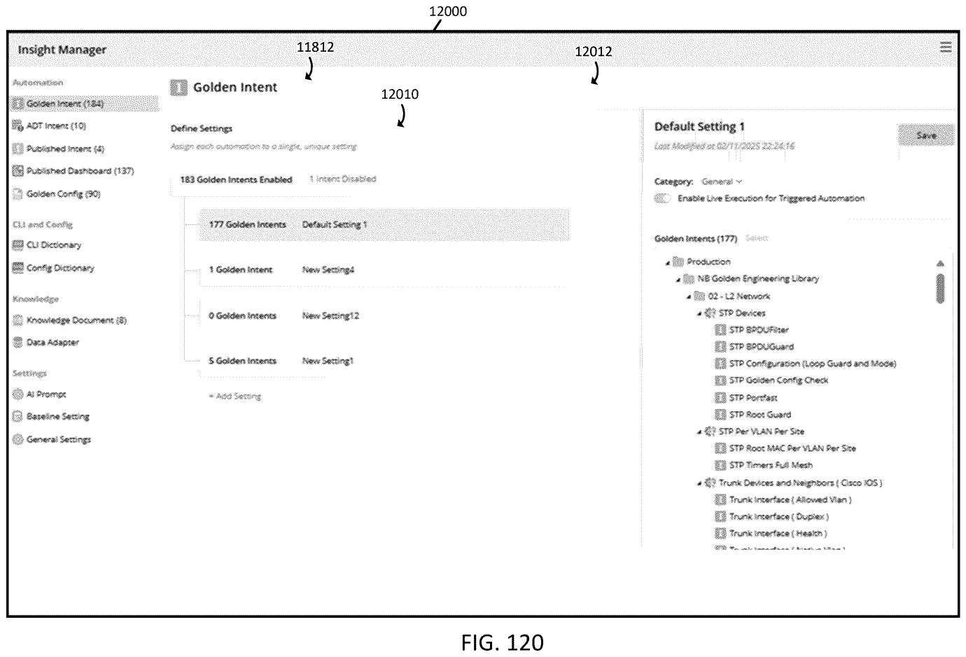

FIG. 120 depicts an interface 12000, in accordance with embodiments of the current disclosure, that provides for management of the insight library's 11410 resources. For example, a user may be able to manage what automations 12010 and data are added to the Insight library via an insight manager module/circuit 12012. Accordingly, in embodiments, users may add the objects listed in Table 2 to the insight library 11410 via the insight manager module/circuit 12012.

TABLE 2

| Type | Settings |
|---|---|
| Golden Intent | By default, all golden intents from Production will be enabled and share the |
| | default settings. |
| ADT Intent | All ADT intents are disabled by default. Users can manually add the ADT |
| | intent columns. |
| Published | By default, all intents in published dashboards will be enabled and share the |
| Dashboard | default settings. |
| | Users can disable some intents (common intents and ADT's intent columns) as |
| | needed. |
| Published Intent | By default, all published intents will be enabled and share the default settings. |
| Golden Config | By default, all golden configs will be enabled and share the default settings. |
| CLI Dictionary | The CLI commands that are organized by the device type. |
| Config Dictionary | The configuration parsers that are organized by the device type. |

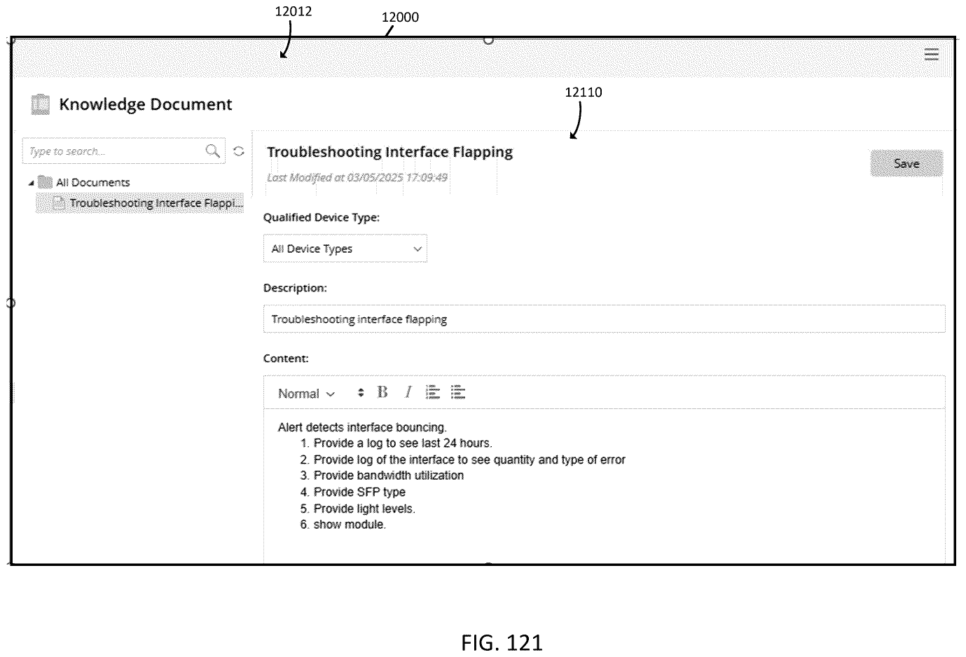

Referring now to FIG. 121, embodiments of the insight manager module/circuit 12012 may also provide for a user to write a knowledge document via a word processing interface 12110, where the AI model 11500 may leverage the knowledge for inference(s). In such embodiments, the AI model 11500 may find a matching document based on the user's query and use its content to determine the response and search for relevant automations.

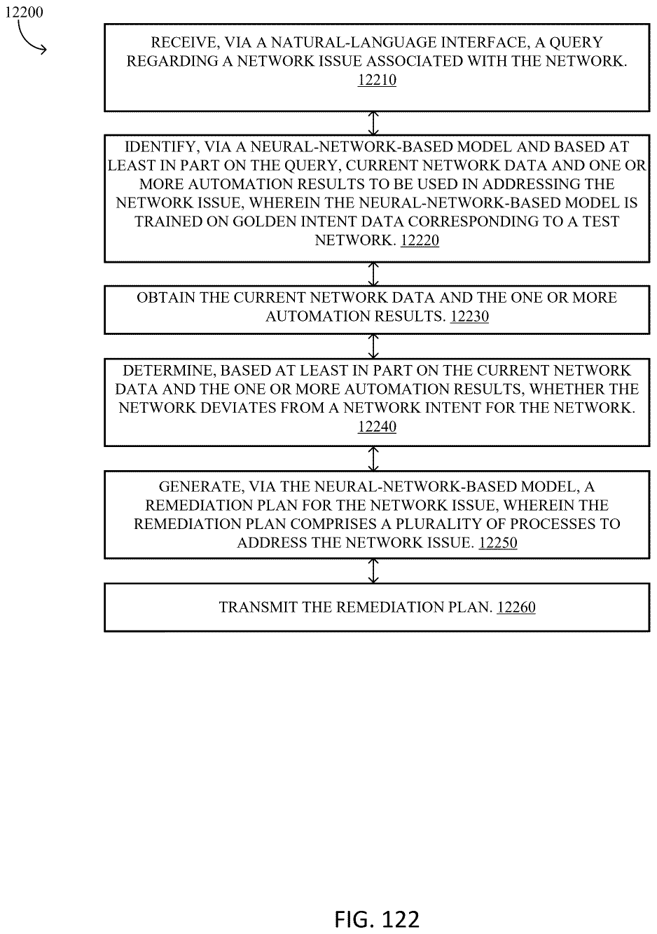

Accordingly, illustrated in FIG. 122 is another method 12200 for managing a network, in accordance with embodiments of the current disclosure. The method 12200 (and/or one or more of its components) may be performed by the apparatus 11200 (FIG. 112), apparatus 12500 (FIG. 125), orchestration circuit 312, apparatus 200, the application 214, and/or any other computing device disclosed herein. The method 12200 includes: receiving, via a natural-language interface, a query regarding a network issue associated with the network 12210; identifying, via a neural-network-based model and based at least in part on the query, current network data and one or more automation results to be used in addressing the network issue, wherein the neural-network-based model is trained on golden intent data corresponding to a test network 12220; and obtaining the current network data and the one or more automation results 12230. The method 12200 further includes: determining, based at least in part on the current network data and the one or more automation results, whether the network deviates from a network intent for the network 12240; generating, via the neural-network-based model, a remediation plan for the network issue, wherein the remediation plan includes a plurality of processes to address the network issue 12250; and transmitting the remediation plan 12260.

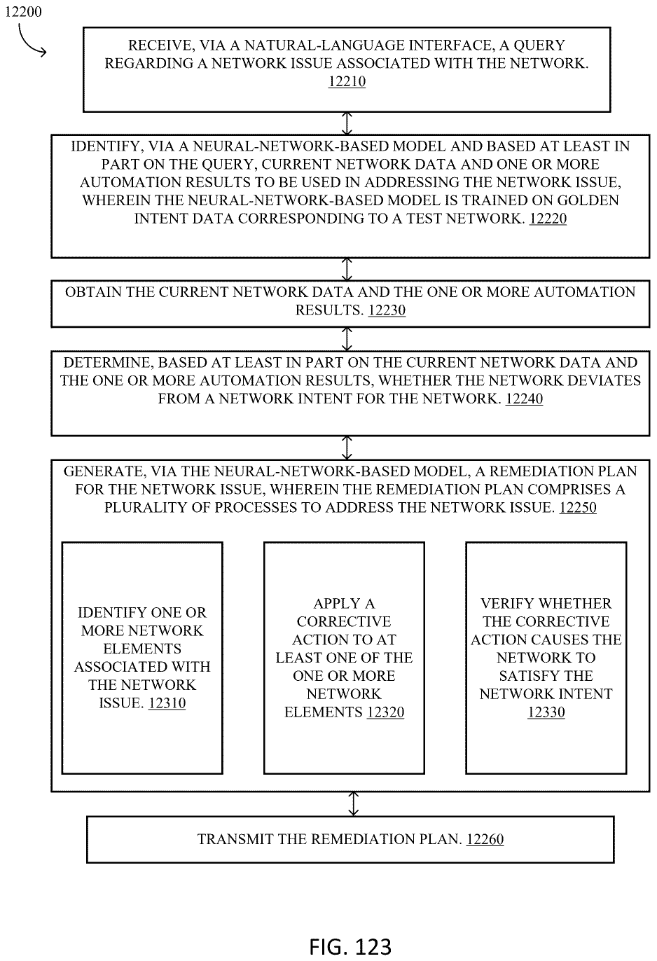

Referring to FIG. 123, in certain aspects, the one or more automation results includes: a golden intent result; a golden configuration verification result; a command-line interface output; and/or a parser output. The plurality of processes may include one or more of: identifying one or more network elements associated with the network issue 12310; applying a corrective action to at least one of the one or more network elements 12320; and/or verifying whether the corrective action causes the network to satisfy the network intent 12330.

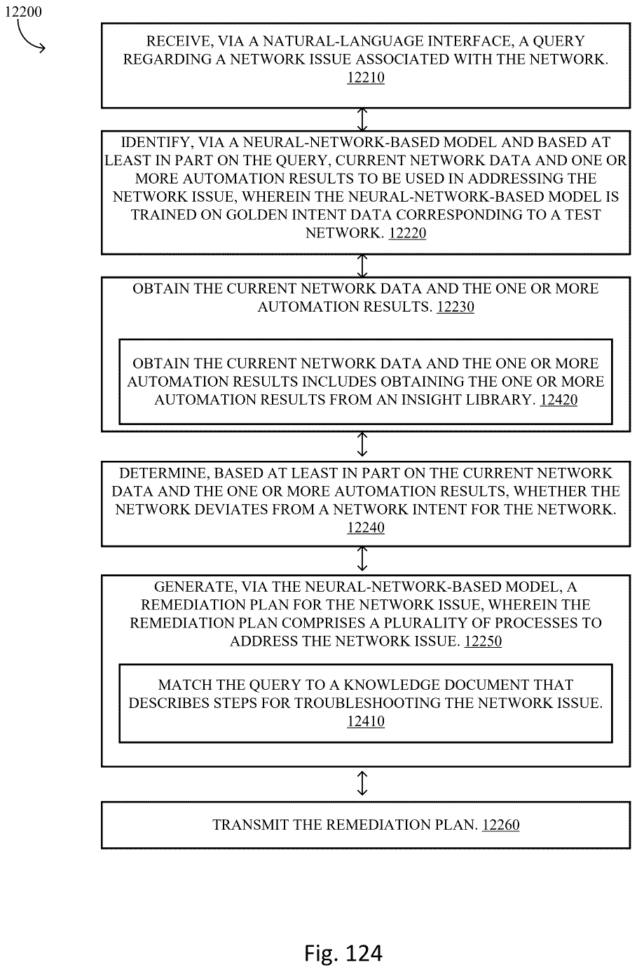

As shown in FIG. 124, in certain aspects, generating the remediation plan includes matching the query to a knowledge document that describes steps for troubleshooting the network issue 12410. Further, obtaining the current network data and the one or more automation results may include obtaining the one or more automation results from an insight library 12420. In certain aspects, the insight library includes an insight library storing machine-generated insights that correlate network issues with corresponding automation results used in addressing the network issue. The neural-network-based model may be based at least in part on a large language model, and/or based at least in part on retrieval-augmented generation.

Turning to FIG. 125, an apparatus 12500 for managing a network is shown, in accordance with embodiments of the current disclosure. The apparatus 12500 includes: a query processing circuit 12510; a resource procurement circuit 12520; a drift detection circuit 12560; a remediation circuit 12570; and a plan provisioning circuit 12580. The query processing circuit 12510 is structured to receive, via a natural-language interface 12540, a query 12541 regarding a network issue associated with the network. The resource procurement circuit 12520 is structured to: identify, via a neural-network-based model and based at least in part on the query, current network data 12590 and one or more automation results 125100 to be used in addressing the network issue. The neural-network-based model is trained on golden intent data corresponding to a test network. The resource procurement circuit 12520 is further structured to obtain the current network data 12590 and the one or more automation results 125100. The drift detection circuit 12560 is structured to determine, based at least in part on the current network data and the one or more automation results, whether the network deviates from a network intent for the network. The remediation circuit 12570 is structured to generate, via the neural-network-based model, a remediation plan 125110 for the network issue, wherein the remediation plan includes a plurality of processes to address the network issue; and the plan provisioning circuit is structured to transmit the remediation plan 125110.

In embodiments, the one or more automation results include: a golden intent result; a golden configuration verification result; a command-line interface output; and/or a parser output. In certain aspects, the plurality of processes is structured to at least one of: identify one or more network elements associated with the network issue; apply a corrective action to at least one of the one or more network elements; and/or verify whether the corrective action causes the network to satisfy the network intent. The remediation circuit 12570 may be structured to match the query to a knowledge document that describes steps for troubleshooting the network issue, and/or the resource procurement circuit 12520 may be structured to obtain the one or more automation results from an insight library 125120. In certain aspects, the insight library 125120 stores machine-generated insights that correlate network issues with corresponding automation results used in addressing the network issue. The neural-network-based model may be based at least in part on a large language model, and/or based at least in part on retrieval-augmented generation.

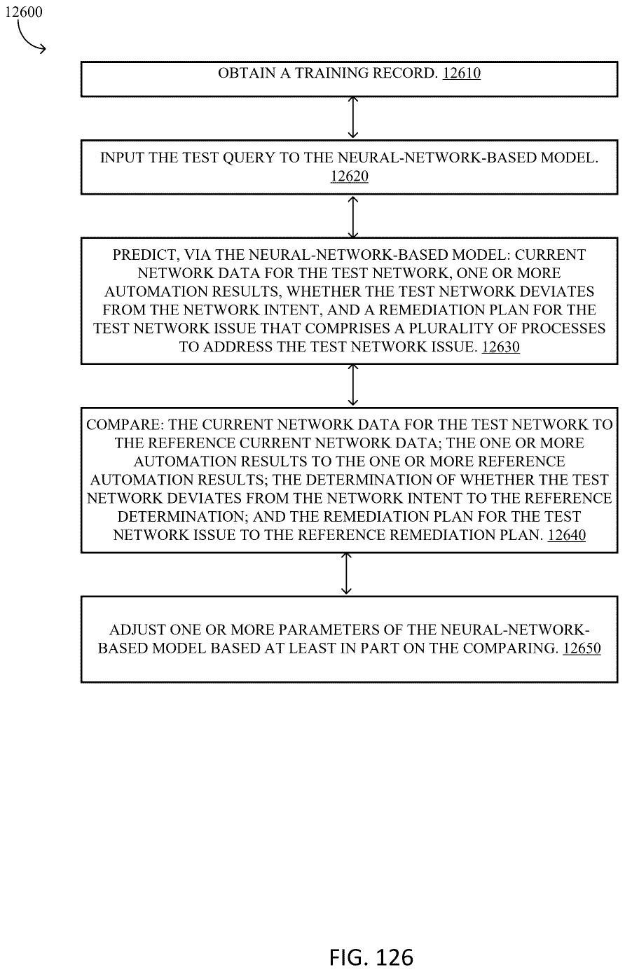

Illustrated in FIG. 126 is a method 12600 for training a neural-network-based model to assist in managing a network, in accordance with embodiments of the current disclosure. The method 12600 includes: obtaining a training record 12610 that includes: a test query regarding a test network issue associated with a test network, reference current network data for the test network, one or more reference automation results; a reference determination of whether the test network deviates from a network intent, and a reference remediation plan for the test network issue. The method 12600 further includes: inputting the test query to the neural-network-based model 12620; and predicting, via the neural-network-based model: current network data for the test network, one or more automation results, whether the test network deviates from the network intent, and a remediation plan for the test network issue that includes a plurality of processes to address the test network issue 12630. The method 12600 further includes comparing: the current network data for the test network to the reference current network data; the one or more automation results to the one or more reference automation results; the determination of whether the test network deviates from the network intent to the reference determination; and the remediation plan for the test network issue to the reference remediation plan 12640. The method 12600 further includes adjusting one or more parameters of the neural-network-based model based at least in part on the comparing 12650. In certain aspects, the one or more reference automation results include: a golden intent result; a golden configuration verification result; a command-line interface output; or a parser output.

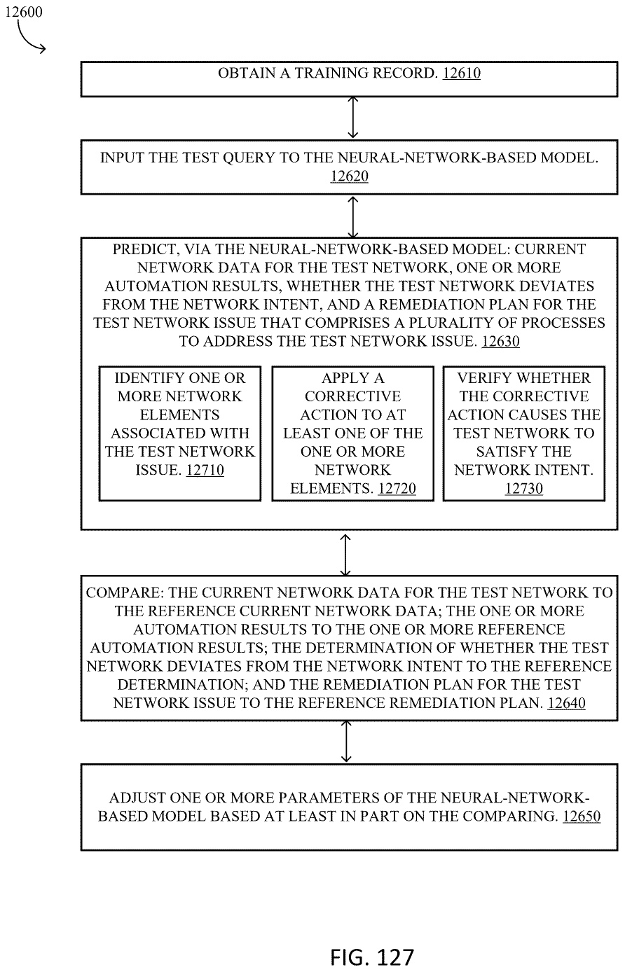

As shown in FIG. 127, the plurality of processes may be structured to at least one of: identify one or more network elements associated with the test network issue 12710; apply a corrective action to at least one of the one or more network elements 12720; and/or verify whether the corrective action causes the test network to satisfy the network intent 12730. In certain aspects, the neural-network-based model is based at least in part on a large language model, and/or based at least in part on retrieval-augmented generation. In embodiments, the test query is based at least in part on a natural-language interface.

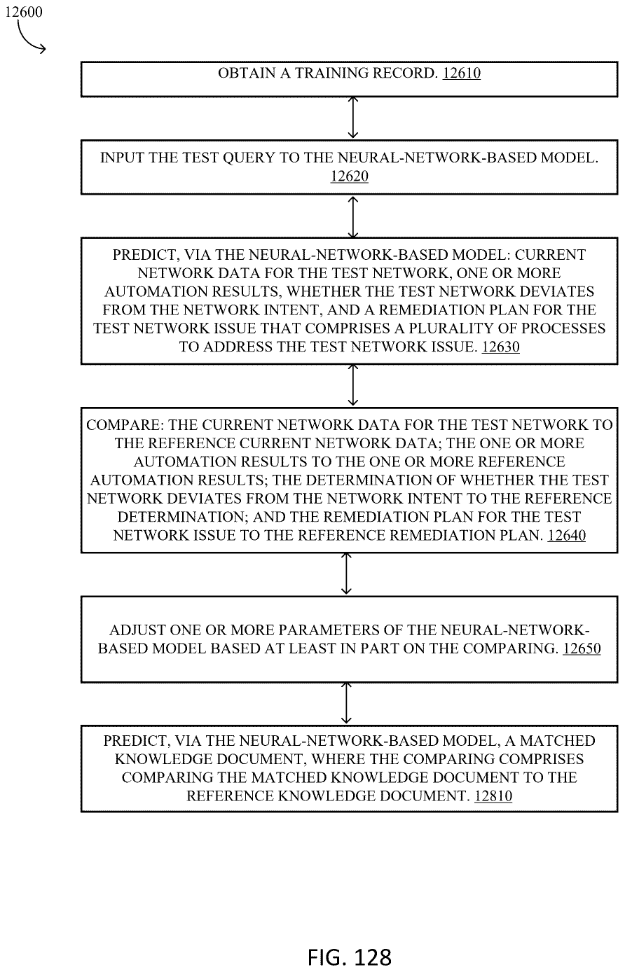

As shown in FIG. 128, the training record further includes a reference knowledge document, and the method further includes: predicting, via the neural-network-based model, a matched knowledge document, where the comparing includes comparing the matched knowledge document to the reference knowledge document 12810.

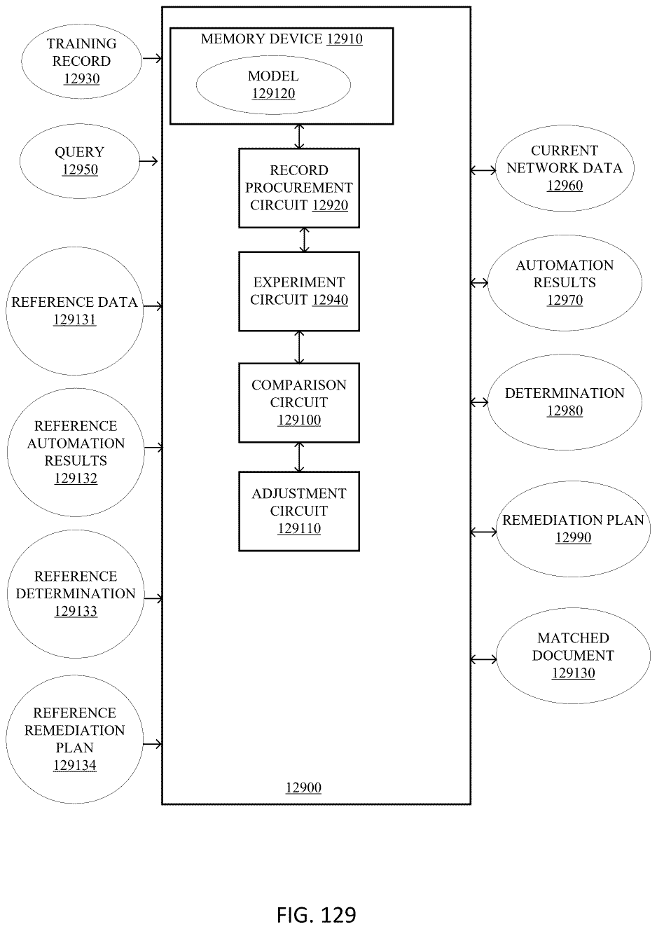

FIG. 129 depicts, an apparatus 12900 for training a neural-network-based model 129120 to assist in managing a network. The apparatus 12900 includes: a memory device 12910 storing the neural-network-based model 129120; and a record procurement circuit 12920 structured to obtain a training record 12930. The training record 12930 may include: a test query 12950 regarding a test network issue associated with a test network, reference current network data 129131 for the test network, one or more reference automation results 129132, a reference determination 129133 of whether the test network deviates from a network intent; and/or a reference remediation plan 129134 for the test network issue. The experiment circuit 12940 is structured to: input the test query 12950 to the neural-network-based model 129120; and predict, via the neural-network-based model 129120: current network data 12960 for the test network; one or more automation results 12970; a determination 12980 of whether the test network deviates from the network intent; and a remediation plan 12990 for the test network issue that includes a plurality of processes to address the test network issue. The comparison circuit 129100 is structured to compare: the current network data 12960 for the test network to the reference current network data 129131; the one or more automation results 12970 to the one or more reference automation results 129132; the determination 12980 of whether the test network deviates from the network intent to the reference determination 129133; and the remediation plan 12990 for the test network issue to the reference remediation plan 129134. The adjustment circuit 129110 is structured to adjust one or more parameters (e.g., weights, learning algorithms, etc.) of the neural-network-based model 129120 based at least in part on the comparison.

In certain aspects, the one or more reference automation results include: a golden intent result; a golden configuration verification result; a command-line interface output; or a parser output. In certain aspects, the plurality of processes is structured to at least one of: identify one or more network elements associated with the test network issue; apply a corrective action to at least one of the one or more network elements; or verify whether the corrective action causes the test network to satisfy the network intent. The neural-network-based model may be based at least in part on a large language model, and/or based at least in part on retrieval-augmented generation. In embodiments, the test query is based at least in part on a natural-language interface. The training record 12930 may further includes a reference knowledge document, wherein the experiment circuit is further structured to predict, via the neural-network-based model, a matched knowledge document 129130, and the comparison circuit may be further structured to compare the matched knowledge document to the reference knowledge document.

As described herein, machine learning models (e.g., the artificial intelligence model 922 (FIG. 9)) may be trained using supervised learning or unsupervised learning. In supervised learning, a model is generated using a set of labeled examples, where each example has corresponding target label(s). In unsupervised learning, the model is generated using unlabeled examples. The collection of examples constructs a dataset, usually referred to as a training dataset. During training, a model is generated using this training data to learn the relationship between examples in the dataset. The training process may include various phases such as: data collection, preprocessing, feature extraction, model training, model evaluation, and model fine-tuning. The data collection phase may include collecting a representative dataset, typically from multiple users, that covers the range of possible scenarios and positions. The preprocessing phase may include cleaning and preparing the examples in the dataset and may include filtering, normalization, and segmentation. The feature extraction phase may include extracting relevant features from examples to capture relevant information for the task. The model training phase may include training a machine learning model on the preprocessed and feature-extracted data. Models may include support vector machines (SVMs), artificial neural networks (ANNs), decision trees, and the like for supervised learning, or autoencoders, Hopfield, restricted Boltzmann machine (RBM), deep belief, Generative Adversarial Networks (GAN), or other networks, or clustering for unsupervised learning. The model evaluation phase may include evaluating the performance of the trained model on a separate validation dataset to ensure that it generalizes well to new and unseen examples. The model fine-tuning may include refining a model by adjusting its parameters, changing the features used, or using a different machine-learning algorithm, based on the results of the evaluation. The process may be iterated until the performance of the model on the validation dataset is satisfactory and the trained model can then be used to make predictions.

In embodiments, trained models may be periodically fine-tuned for specific user groups, applications, and/or tasks. Fine-tuning of an existing model may improve the performance of the model for an application while avoiding completely retraining the model for the application.

In embodiments, fine-tuning a machine learning model may involve adjusting its hyperparameters or architecture to improve its performance for a particular user group or application. The process of fine-tuning may be performed after initial training and evaluation of the model, and it can involve one or more hyperparameter tuning and architectural methods.

Hyperparameter tuning includes adjusting the values of the model's hyperparameters, such as learning rate, regularization strength, or the number of hidden units. This can be done using methods such as grid search, random search, or Bayesian optimization. Architecture modification may include modifying the structure of the model, such as adding or removing layers, changing the activation functions, or altering the connections between neurons, to improve its performance.

Online training of machine learning models includes a process of updating the model as new examples become available, allowing it to adapt to changes in the data distribution over time. In online training, the model is trained incrementally as new data becomes available, allowing it to adapt to changes in the data distribution over time. Online training can also be useful for user groups that have changing usage habits of the stimulation device, allowing the models to be updated in almost real-time.

In embodiments, online training may include adaptive filtering. In adaptive filtering, a machine learning model is trained online to learn the underlying structure of the new examples and remove noise or artifacts from the examples.

The methods (e.g., 10400, 12200, etc.), apparatuses (e.g., 200, 11200. 12500, etc.), and/or systems (e.g., 100) described herein may be deployed in part or in whole through a machine (e.g., apparatus 200) having a computer, computing device, processor, circuit, and/or server that executes computer-readable instructions (e.g., application 214), program codes, instructions, and/or includes hardware configured to functionally execute one or more operations of the methods (e.g., 10400, 12200, etc.), apparatuses (e.g., 200, 11200, 12500, etc.), and/or systems (e.g., 100) disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer-readable medium, whereupon the computer performs operations of systems or methods described herein upon executing the instructions. In certain embodiments, such instructions themselves include a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general-purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device including a part of a first computer, computing device, processor, circuit, and/or server, and some aspects of the hardware device including a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer to peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof; and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

As will be appreciated, advantages and improvements of the embodiments of the current disclosure as demonstrated by the following non-limiting use cases.

For example, in a non-limiting use case scenario, a network operator may be responsible for maintaining configuration consistency across a large and operationally diverse population of network devices distributed among different sites, roles, and services. In such environments, device configurations may change over time due to software updates, service modifications, manual intervention, staged rollouts, or troubleshooting activity. As a result, configuration drift may accumulate gradually and may be difficult to detect through manual review alone. Conventional approaches that compare devices without sufficient context may also produce unreliable results because devices that appear similar at a high level may yet be expected to differ in certain settings, while devices that are expected to remain aligned may diverge in ways that are not readily visible from raw configuration text. These conditions may increase troubleshooting complexity, may delay identification of non-compliant or unstable devices, and may consume substantial engineering resources.

For these reasons, a network management platform may implement a method 10400, shown for example in FIG. 104, to identify groups of devices that are meaningfully comparable, derive an appropriate baseline for each group, and evaluate individual devices against that baseline in a more systematic manner. In some embodiments, the method 10400 may begin with definition of an assessment feature 10410 that characterizes a set of devices to be evaluated together. A graphical user interface 8000 may present one or more assessment features 8010, a group selection option 8016, and an input region 8018 through which a network engineer may specify search criteria, protocol-related characteristics, device properties, or other configuration-related parameters. By defining the assessment feature 10410 with sufficient specificity, the platform may focus analysis on devices that are likely to be meaningfully comparable, which may reduce noise in subsequent comparisons and may improve the technical relevance of detected drift.

Using the assessment feature 10410, the platform may identify a reference cluster 10420 formed from a plurality of member devices having one or more shared characteristics. In some embodiments, the reference cluster 10420 may correspond to a reference cluster 8214 that includes a set of devices 8216 having a common protocol configuration, server setting, device role, location, or other operational attribute. Results 8110 generated from the selected assessment feature 8010 may be presented to facilitate review of candidate devices for the reference cluster 8214. Organizing devices into the reference cluster 10420 in this manner may address a technical difficulty present in large-scale configuration analysis, namely that a single universal baseline may be poorly suited to heterogeneous device populations. Instead, the disclosed grouping process may allow related devices to be evaluated against a common baseline that is more closely tailored to their actual operating context.

Within a given reference cluster 8214, the platform may designate a representative device 10430 to serve as a basis for deriving an expected configuration state for the cluster. In some embodiments, the representative device 10430 may correspond to a reference device 8218 selected from among the devices 8216 because that device reflects configuration characteristics of the group as a group. Selection of an appropriate representative device 10430 may reduce the likelihood that an outlier configuration will be used as a baseline and may improve the accuracy of subsequent drift detection. In some implementations, the representative device 10430 may be selected based on similarity metrics among devices in the cluster, while in other implementations selection may be governed by administrative preferences or other rules. FIG. 105 illustrates examples in which the representative device 10430 is selected as a device having greater similarity to other devices in the cluster at 10520, and FIG. 106 illustrates examples in which one or more rules 10610 or a user input 10620 may be used to dynamically or statically select the representative device 10430.

A golden configuration 10440 may then be established using the representative device 10430. In some embodiments, a graphical user interface 9100 may be used to create or maintain a golden configuration 9114 associated with a representative device 9112. The golden configuration 9114 may serve as a benchmark against which other devices in the reference cluster 8214 are evaluated. Deriving the golden configuration 10440 from the representative device 10430 may reduce manual effort associated with individually defining expected configurations for multiple devices and may provide a technically coherent reference point for cluster-wide analysis. Where a suitable baseline already exists, the platform may refine that baseline using information from the representative device 10430, and where no baseline exists, the platform may generate a new golden configuration 10720 for the cluster, as illustrated in FIG. 107. This flexibility may allow the disclosed process to accommodate legitimate network evolution while preserving continuity in assessment workflows.

Once the golden configuration 10440 has been established, the platform may compare a target configuration 10450 associated with another member device to the golden configuration 10440. In some embodiments, the target configuration 10450 may correspond to a target configuration 9118 presented through the graphical user interface 9100. The comparison may quantify a degree of deviation between the target configuration 10450 and the golden configuration 10440, and the platform may determine a drift value 10460 representative of the amount of change. The drift value 10460 may then be transmitted at 10470, for example as part of an alert 9412, a success message 9414, or another output generated through a graphical user interface 9400. Quantification of drift in this manner may help solve the problem of relying on subjective review of raw configuration files by providing a more structured measure of deviation that can be used to identify, rank, and address problematic devices.

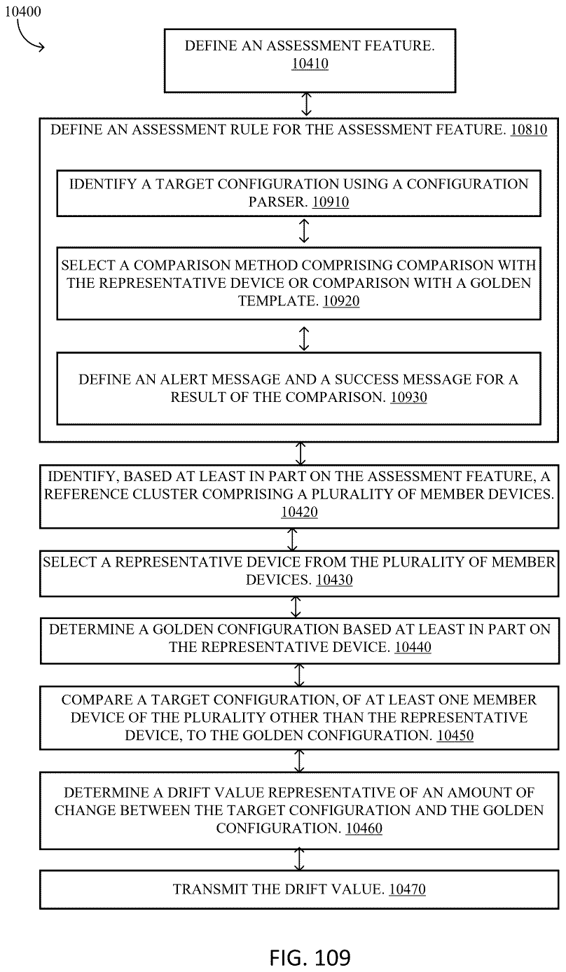

In some embodiments, the platform may further support definition of an assessment rule 10810, as illustrated in FIGS. 108 and 109, to govern how configuration information is extracted and compared. A configuration parser 10910 may be used to identify relevant portions of device configuration data, and a comparison method 10920 may be selected to compare a target configuration with either the representative device or a golden template. The graphical user interface 9100 may, for example, permit selection of a configuration parser 9120, identification of candidate variables 9122, designation of a target configuration 9124, and selection of a comparison method 9128. Alert and success messaging behavior may also be defined for the comparing operation at 10930. These capabilities may improve repeatability of configuration analysis, may reduce operator subjectivity in determining whether a difference is meaningful, and may facilitate more consistent enforcement of operational policies across different portions of the network.

In some embodiments, once a deviation has been identified, the platform may support alignment of the target configuration with the golden configuration to reduce the drift value, as represented at 11010 in FIG. 110. For example, the platform may initiate or support a corrective workflow to bring the target configuration 9118 into closer correspondence with the golden configuration 9114. Additional devices may also be assessed, such as by comparing a second target configuration to the golden configuration at 11020 and determining a second drift value at 11030. Alignment of device configurations in this manner may improve configuration uniformity across the network and may reduce the likelihood that unmanaged divergence will contribute to troubleshooting complexity, inconsistent policy enforcement, or degraded service behavior.

FIG. 111 illustrates examples in which the assessment feature 10410 is derived from one or more eigen variables 11110 generated by a parser. The eigen variables 11110 may correspond to, for example, a supported network protocol, a device attribute, an interface-level attribute, a neighbor relationship attribute, or another configuration parameter. Derivation of the assessment feature 10410 from parsed network information may reduce manual feature construction and may permit the platform to scale across large and heterogeneous device populations while maintaining analytical consistency. In this way, the method 10400 may address the underlying problem of configuration drift in complex networks by enabling more reliable formation of device groups, more accurate establishment of cluster-specific baselines, and more systematic detection and correction of deviations from expected configuration states.

Accordingly, embodiments of the current disclosure provide for a method for managing a network. The method includes: defining an assessment feature; identifying, based at least in part on the assessment feature, a reference cluster that includes a plurality of member devices; selecting a representative device from the plurality of member devices; and determining a golden configuration based at least in part on the representative device. The method further includes comparing a target configuration, of at least one member device of the plurality other than the representative device, to the golden configuration; determining a drift value representative of an amount of change between the target configuration and the golden configuration; and transmit the drift value.

In certain aspects, identifying the reference cluster includes grouping the plurality of member devices based at least in part on the assessment feature. In certain aspects, selecting the representative device includes selecting, from the plurality of member devices, a member device having a highest similarity to other member devices of the reference cluster. In certain aspects, selecting the representative device includes dynamically selecting the representative device based at least in part on one or more rules. In certain aspects, selecting the representative device includes statically selecting the representative device via a user input. In certain aspects, determining the golden configuration based at least in part on the representative device includes adjusting an existing golden configuration. In certain aspects, determining the golden configuration based at least in part on the representative device includes generating the golden configuration. In certain aspects, the method further includes: defining an assessment rule for the assessment feature. The assessment rule may include identifying a target configuration using a configuration parser; selecting a comparison method that includes comparison with the representative device or comparison with a golden template; and defining an alert message and a success message for a result of the comparison. In certain aspects, the method further includes aligning the target configuration with the golden configuration to decrease the drift value. In certain aspects, the method further includes: comparing a second target configuration, of a device other than the plurality of member devices of the reference cluster, to the golden configuration; and determining a second drift value representative of an amount of change between the second target configuration and the golden configuration. In certain aspects, defining the assessment feature includes generating the assessment feature based at least in part on one or more eigen variables. In certain aspects, the one or more eigen variables were generated by a parser. In certain aspects, the one or more eigen variables includes at least one of: a supported network protocol; a device attribute; an interface-level attribute; a neighbor relationship attribute; or a configuration parameter. In certain aspects, the supported network protocol is at least one of: Border Gateway Protocol; Open Shortest Path First; Network Time Protocol; Domain Name System; Internet Message Access Protocol; Internet Protocol version 4; or Internet Protocol version 6. In certain aspects, the device attribute includes at least one of: a host name; a device type; or a location. In certain aspects, the interface-level attribute includes at least one of: a local interface name; a neighbor interface name; or an interface internet protocol address. In certain aspects, the neighbor relationship attribute includes at least one of: a neighbor device name; a neighbor device internet protocol address; a layer 2 neighbor; or a layer 3 neighbor. In certain aspects, the configuration parameter includes at least one of: a routing protocol setting; a network time protocol server address; or a simple network management protocol community string.

Additional embodiments of the current disclosure provide for an apparatus for managing a network. The apparatus includes: an assessment feature management circuit, a clustering circuit, a representative device circuit, a golden engineering circuit, a drift circuit, and a drift provisioning circuit. The assessment feature management circuit is structured to define an assessment feature; the clustering circuit is structured to identify, based at least in part on the assessment feature, a reference cluster that includes a plurality of member devices; and the representative device circuit is structured to select a representative device from the plurality of member devices. The golden engineering circuit is structured to determine a golden configuration based at least in part on the representative device; and the drift circuit structured to: compare a target configuration, of at least one member device of the plurality other than the representative device, to the golden configuration; and determine a drift value representative of an amount of change between the target configuration and the golden configuration. The drift provisioning circuit is structured to transmit the drift value.

In certain aspects, the clustering circuit is structured to group the plurality of member devices based at least in part on the assessment feature. In certain aspects, the representative device circuit is structured to select, from the plurality of member devices, a member device having a highest similarity to other member devices of the reference cluster. In certain aspects, the representative device circuit is structured to dynamically select the representative device based at least in part on one or more rules. In certain aspects, the representative device circuit is structured to statically select the representative device via a user input. In certain aspects, the golden engineering circuit is structured to adjust an existing golden configuration. In certain aspects, the golden engineering circuit is structured to generate the golden configuration. In certain aspects, the apparatus further includes an assessment rule circuit structured to define an assessment rule for the assessment feature by: selecting a configuration parser; selecting, from the configuration parser, a variable as the target configuration for comparison with a golden configuration template; and defining match pattern rules for comparing the target configuration against the golden configuration template. In certain aspects, the drift circuit is further structured to align the target configuration with the golden configuration to decrease the drift value. In certain aspects, the drift circuit is further structured to: compare a second target configuration, of a device other than the plurality of member devices of the reference cluster, to the golden configuration; and determine a second drift value representative of an amount of change between the second target configuration and the golden configuration. In certain aspects, the assessment feature management circuit is structured to generate the assessment feature based at least in part on one or more eigen variables. In certain aspects, the one or more eigen variables are generated by a parser. In certain aspects, the one or more eigen variables include at least one of: a supported network protocol; a device attribute; an interface-level attribute; a neighbor relationship attribute; or a configuration parameter. In certain aspects, the supported network protocol includes at least one of: Border Gateway Protocol; Open Shortest Path First; Network Time Protocol; Domain Name System; Internet Message Access Protocol; Internet Protocol version 4; or Internet Protocol version 6. In certain aspects, the device attribute includes at least one of: a host name; a device type; or a location. In certain aspects, the interface-level attribute includes at least one of: a local interface name; a neighbor interface name; or an interface internet protocol address. In certain aspects, the neighbor relationship attribute includes at least one of: a neighbor device name; a neighbor device internet protocol address; a layer 2 neighbor; or a layer 3 neighbor. In certain aspects, the configuration parameter includes at least one of: a routing protocol setting; a network time protocol server address; or a simple network management protocol community string.

Further embodiments of the current disclosure provide for a non-transitory computer-readable medium storing instructions that, when loaded into at least one processor, causes the at least one processor to: define an assessment feature; identify, based at least in part on the assessment feature, a reference cluster that includes a plurality of member devices; select a representative device from the plurality of member devices; and determine a golden configuration based at least in part on the representative device. The stored computer-readable instructions further cause the at least one processor to: compare a target configuration, of at least one member device of the plurality other than the representative device, to the golden configuration; determine a drift value representative of an amount of change between the target configuration and the golden configuration; and transmit the drift value.

In certain aspects, the stored instructions further cause the at least one processor to group the plurality of member devices based at least in part on the assessment feature. In certain aspects, the stored instructions further cause the at least one processor to: select, from the plurality of member devices, a member device having a highest similarity to other member devices of the reference cluster. In certain aspects, the stored instructions further cause the at least one processor to dynamically select the representative device based at least in part on one or more rules. In certain aspects, the stored instructions further cause the at least one processor to statically select the representative device via a user input. In certain aspects, the stored instructions further cause the at least one processor to adjust an existing golden configuration. In certain aspects, the stored instructions further cause the at least one processor to generate the golden configuration. In certain aspects, the stored instructions further cause the at least one processor to: define an assessment rule for the assessment feature, the assessment rule including: identify a target configuration using a configuration parser; select a comparison method that includes comparison with the representative device or comparison with a golden template; and define an alert message and a success message for a result of the comparison. In certain aspects, the stored instructions further cause the at least one processor to align the target configuration with the golden configuration to decrease the drift value. In certain aspects, the stored instructions further cause the at least one processor to: compare a second target configuration, of a device other than the plurality of member devices of the reference cluster, to the golden configuration; and determine a second drift value representative of an amount of change between the second target configuration and the golden configuration. In certain aspects, the stored instructions further cause the at least one processor to generate the assessment feature based at least in part on one or more eigen variables. In certain aspects, the one or more eigen variables were generated by a parser. In certain aspects, the one or more eigen variables include at least one of: a supported network protocol; a device attribute; an interface-level attribute; a neighbor relationship attribute; or a configuration parameter. In certain aspects, the supported network protocol is at least one of: Border Gateway Protocol; Open Shortest Path First; Network Time Protocol; Domain Name System; Internet Message Access Protocol; Internet Protocol version 4; or Internet Protocol version 6. In certain aspects, the device attribute has at least one of: a host name; a device type; or a location. In certain aspects, the interface-level attribute includes at least one of: a local interface name; a neighbor interface name; or an interface internet protocol address. In certain aspects, the neighbor relationship attribute includes at least one of: a neighbor device name; a neighbor device internet protocol address; a layer 2 neighbor; or a layer 3 neighbor. In certain aspects, the configuration parameter includes at least one of: a routing protocol setting; a network time protocol server address; or a simple network management protocol community string.

Still yet further embodiments of the current disclosure provide for a method for managing a network. The method includes: receiving, via a natural-language interface, a query regarding a network issue associated with the network; identifying, via a neural-network-based model and based at least in part on the query, current network data and one or more automation results to be used in addressing the network issue, wherein the neural-network-based model is trained on golden intent data corresponding to a test network; and obtaining the current network data and the one or more automation results. The method further includes: determining, based at least in part on the current network data and the one or more automation results, whether the network deviates from a network intent for the network; generating, via the neural-network-based model, a remediation plan for the network issue, wherein the remediation plan includes a plurality of processes to address the network issue; and transmitting the remediation plan.

In certain aspects, the one or more automation results includes: a golden intent result; a golden configuration verification result; a command-line interface output; or a parser output. In certain aspects, the plurality of processes includes one or more of: identifying one or more network elements associated with the network issue; applying a corrective action to at least one of the one or more network elements; or verifying whether the corrective action causes the network to satisfy the network intent. In certain aspects, generating the remediation plan includes matching the query to a knowledge document that describes steps for troubleshooting the network issue. In certain aspects, obtaining the current network data and the one or more automation results includes obtaining the one or more automation results from an insight library. In certain aspects, the insight library includes an insight library storing machine-generated insights that correlate network issues with corresponding automation results used in addressing the network issue. In certain aspects, the neural-network-based model is based at least in part on a large language model. In certain aspects, the neural-network-based model is based at least in part on retrieval-augmented generation.

Still yet further embodiments of the current disclosure provide for an apparatus for managing a network. The apparatus includes: a query processing circuit; a resource procurement circuit; a query processing circuit structured to receive, via a natural-language interface, a query regarding a network issue associated with the network; a drift detection circuit; a remediation circuit; and a plan provisioning circuit. The resource procurement circuit is structured to: identify, via a neural-network-based model and based at least in part on the query, current network data and one or more automation results to be used in addressing the network issue. The neural-network-based model is trained on golden intent data corresponding to a test network. The resource procurement circuit is further structured to obtain the current network data and the one or more automation results. The drift detection circuit is structured to determine, based at least in part on the current network data and the one or more automation results, whether the network deviates from a network intent for the network. The remediation circuit is structured to generate, via the neural-network-based model, a remediation plan for the network issue, wherein the remediation plan has a plurality of processes to address the network issue; and the plan provisioning circuit is structured to transmit the remediation plan.

In certain aspects, the one or more automation results include: a golden intent result; a golden configuration verification result; a command-line interface output; or a parser output. In certain aspects, the plurality of processes is structured to at least one of: identify one or more network elements associated with the network issue; apply a corrective action to at least one of the one or more network elements; or verify whether the corrective action causes the network to satisfy the network intent. In certain aspects, the remediation circuit is structured to match the query to a knowledge document that describes steps for troubleshooting the network issue. In certain aspects, the resource procurement circuit is structured to obtain the one or more automation results from an insight library. In certain aspects, the insight library stores machine-generated insights that correlate network issues with corresponding automation results used in addressing the network issue. In certain aspects, the neural-network-based model is based at least in part on a large language model. In certain aspects, the neural-network-based model is based at least in part on retrieval-augmented generation.

Still yet further embodiments of the current disclosure provide for a non-transitory computer-readable medium storing instructions that, when loaded into at least one processor, cause the at least one processor to: receive, via a natural-language interface, a query regarding a network issue associated with the network; and identify, via a neural-network-based model and based at least in part on the query, current network data and one or more automation results to be used in addressing the network issue, wherein the neural-network-based model is trained on golden intent data corresponding to a test network. The stored computer-readable instructions further cause the at least one processor to: obtain the current network data and the one or more automation results; determine, based at least in part on the current network data and the one or more automation results, whether the network deviates from a network intent for the network; generate, via the neural-network-based model, a remediation plan for the network issue, wherein the remediation plan has a plurality of processes to address the network issue; and transmit the remediation plan.

In certain aspects, the one or more automation results include: a golden intent result; a golden configuration verification result; a command-line interface output; or a parser output. In certain aspects, the plurality of processes are structured to at least one of: identify one or more network elements associated with the network issue; apply a corrective action to at least one of the one or more network elements; or verify whether the corrective action causes the network to satisfy the network intent. In certain aspects, the stored instructions further cause the at least one processor to match the query to a knowledge document that describes steps for troubleshooting the network issue. In certain aspects, the stored instructions further cause the at least one processor to obtain the one or more automation results from an insight library. In certain aspects, the insight library stores machine-generated insights that correlate network issues with corresponding automation results used in addressing the network issue. In certain aspects, the neural-network-based model is based at least in part on a large language model. In certain aspects, neural-network-based model is based at least in part on retrieval-augmented generation.

Still yet further embodiments of the current disclosure provide for a method for training a neural-network-based model to assist in managing a network. The method includes: obtaining a training record that includes: a test query regarding a test network issue associated with a test network, reference current network data for the test network, one or more reference automation results; a reference determination of whether the test network deviates from a network intent, and a reference remediation plan for the test network issue. The method further includes: inputting the test query to the neural-network-based model; and predicting, via the neural-network-based model: current network data for the test network, one or more automation results, whether the test network deviates from the network intent, and a remediation plan for the test network issue that includes a plurality of processes to address the test network issue. The method further includes comparing: the current network data for the test network to the reference current network data; the one or more automation results to the one or more reference automation results; the determination of whether the test network deviates from the network intent to the reference determination; and the remediation plan for the test network issue to the reference remediation plan. The method further includes adjusting one or more parameters of the neural-network-based model based at least in part on the comparing.

In certain aspects, the one or more reference automation results include: a golden intent result; a golden configuration verification result; a command-line interface output; or a parser output. In certain aspects, the plurality of processes is structured to at least one of: identify one or more network elements associated with the test network issue; apply a corrective action to at least one of the one or more network elements; or verify whether the corrective action causes the test network to satisfy the network intent. In certain aspects, the neural-network-based model is based at least in part on a large language model. In certain aspects, the neural-network-based model is based at least in part on retrieval-augmented generation. In certain aspects, the test query is based at least in part on a natural-language interface. In certain aspects, the training record further includes a reference knowledge document, and the method further includes: predicting, via the neural-network-based model, a matched knowledge document, where the comparing includes comparing the matched knowledge document to the reference knowledge document.

Yet still further embodiments of the current disclosure provide for an apparatus for training a neural-network-based model to assist in managing a network. The apparatus includes: a memory device storing the neural-network-based model; and a record procurement circuit structured to obtain a training record that includes: a test query regarding a test network issue associated with a test network, reference current network data for the test network, one or more reference automation results, a reference determination of whether the test network deviates from a network intent; and a reference remediation plan for the test network issue. The experiment circuit is structured to: input the test query to the neural-network-based model; and predict, via the neural-network-based model: current network data for the test network; one or more automation results; a determination of whether the test network deviates from the network intent; and a remediation plan for the test network issue that includes a plurality of processes to address the test network issue. The comparison circuit is structured to compare: the current network data for the test network to the reference current network data; the one or more automation results to the one or more reference automation results; the determination of whether the test network deviates from the network intent to the reference determination; and the remediation plan for the test network issue to the reference remediation plan. The adjustment circuit is structured to adjust one or more parameters of the neural-network-based model based at least in part on the comparison.

In certain aspects, the one or more reference automation results include: a golden intent result; a golden configuration verification result; a command-line interface output; or a parser output. In certain aspects, the plurality of processes is structured to at least one of: identify one or more network elements associated with the test network issue; apply a corrective action to at least one of the one or more network elements; or verify whether the corrective action causes the test network to satisfy the network intent. In certain aspects, the neural-network-based model is based at least in part on a large language model. In certain aspects, the neural-network-based model is based at least in part on retrieval-augmented generation. In certain aspects, the test query is based at least in part on a natural-language interface. In certain aspects, the training record further includes a reference knowledge document; the experiment circuit is further structured to predict, via the neural-network-based model, a matched knowledge document; and the comparison circuit is further structured to compare the matched knowledge document to the reference knowledge document.

Still yet further embodiments of the current disclosure provide for a non-transitory computer-readable medium storing instructions that, when loaded into at least one processor, cause the at least one processor to: obtain a training record that includes: a test query regarding a test network issue associated with a test network; reference current network data for the test network; one or more reference automation results; a reference determination of whether the test network deviates from a network intent; and a reference remediation plan for the test network issue. The stored instructions further cause the at least one processor to: input the test query to a neural-network-based model; predict, via the neural-network-based model: current network data for the test network, one or more automation results, a determination of whether the test network deviates from the network intent, and a remediation plan for the test network issue that has a plurality of processes to address the test network issue. The stored instructions further cause the at least one processor to: compare: the current network data for the test network to the reference current network data; the one or more automation results to the one or more reference automation results; the determination of whether the test network deviates from the network intent to the reference determination; and the remediation plan for the test network issue to the reference remediation plan. The stored instructions further cause the at least one processor to adjust one or more parameters of the neural-network-based model based at least in part on the comparison.

In certain aspects, the one or more reference automation results include: a golden intent result; a golden configuration verification result; a command-line interface output; or a parser output. In certain aspects, the plurality of processes is structured to at least one of: identify one or more network elements associated with the test network issue; apply a corrective action to at least one of the one or more network elements; or verify whether the corrective action causes the test network to satisfy the network intent. In certain aspects, the neural-network-based model is based at least in part on a large language model. In certain aspects, the neural-network-based model is based at least in part on retrieval-augmented generation. In certain aspects, the test query is based at least in part on a natural-language interface. In certain aspects, the training record further includes a reference knowledge document; and the stored computer-readable instructions further cause the at least one processor to: predict, via the neural-network-based model, a matched knowledge document; and compare the matched knowledge document to the reference knowledge document.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

1. A method for managing a network, the method comprising:
defining an assessment feature;
identifying, based at least in part on the assessment feature, a reference cluster comprising a plurality of member devices;
selecting a representative device from the plurality of member devices;
determining a golden configuration based at least in part on the representative device;
comparing a target configuration, of at least one member device of the plurality other than the representative device, to the golden configuration;
determining a drift value representative of an amount of change between the target configuration and the golden configuration; and
transmitting the drift value.

2. The method of claim 1, wherein identifying the reference cluster comprises:
grouping the plurality of member devices based at least in part on the assessment feature.

3. The method of claim 1, wherein selecting the representative device comprises:
selecting, from the plurality of member devices, a member device having a highest similarity to other member devices of the reference cluster.

4. The method of claim 1, wherein selecting the representative device comprises:
dynamically selecting the representative device based at least in part on one or more rules.

5. The method of claim 1, wherein selecting the representative device comprises:
statically selecting the representative device via a user input.

6. The method of claim 1, wherein determining the golden configuration based at least in part on the representative device comprises:
adjusting an existing golden configuration.

7. The method of claim 1, wherein determining the golden configuration based at least in part on the representative device comprises:
generating the golden configuration.

8. The method of claim 1, further comprising:
defining an assessment rule for the assessment feature, the assessment rule comprising:
identifying a target configuration using a configuration parser;
selecting a comparison method comprising comparison with the representative device or comparison with a golden template; and
defining an alert message and a success message for a result of the comparison.

9. The method of claim 1 further comprising aligning the target configuration with the golden configuration to decrease the drift value.

10. The method of claim 1 further comprising:
comparing a second target configuration, of a device other than the plurality of member devices of the reference cluster, to the golden configuration; and
determining a second drift value representative of an amount of change between the second target configuration and the golden configuration.

11. The method of claim 1, wherein defining the assessment feature comprises:
generating the assessment feature based at least in part on one or more eigen variables.

12. The method of claim 11, wherein the one or more eigen variables were generated by a parser.

13. The method of claim 11, wherein the one or more eigen variables comprise at least one of:
a supported network protocol;
a device attribute;
an interface-level attribute;
a neighbor relationship attribute; or
a configuration parameter.

14-18. (canceled)

19. An apparatus for managing a network comprising:
an assessment feature management circuit structured to define an assessment feature;
a clustering circuit structured to identify, based at least in part on the assessment feature, a reference cluster comprising a plurality of member devices;
a representative device circuit structured to select a representative device from the plurality of member devices;
a golden engineering circuit structured to determine a golden configuration based at least in part on the representative device;
a drift circuit structured to:
compare a target configuration, of at least one member device of the plurality other than the representative device, to the golden configuration; and
determine a drift value representative of an amount of change between the target configuration and the golden configuration; and
a drift provisioning circuit structured to transmit the drift value.

20. The apparatus of claim 19, wherein the clustering circuit is structured to:
group the plurality of member devices based at least in part on the assessment feature.

21. The apparatus of claim 19, wherein the representative device circuit is structured to:
select, from the plurality of member devices, a member device having a highest similarity to other member devices of the reference cluster.

22. The apparatus of claim 19, wherein the representative device circuit is structured to:
dynamically select the representative device based at least in part on one or more rules.

23-36. (canceled)

37. A non-transitory computer-readable medium storing instructions that, when loaded into at least one processor, causes the at least one processor to:
define an assessment feature;
identify, based at least in part on the assessment feature, a reference cluster comprising a plurality of member devices;
select a representative device from the plurality of member devices;
determine a golden configuration based at least in part on the representative device;
compare a target configuration, of at least one member device of the plurality other than the representative device, to the golden configuration;
determine a drift value representative of an amount of change between the target configuration and the golden configuration; and
transmit the drift value.

38. The non-transitory computer-readable medium of claim 37, wherein the stored instructions further cause the at least one processor to:
group the plurality of member devices based at least in part on the assessment feature.

39. The non-transitory computer-readable medium of claim 37, wherein the stored instructions further cause the at least one processor to:
select, from the plurality of member devices, a member device having a highest similarity to other member devices of the reference cluster.

40-99. (canceled)
